(19) United States
(12) Patent Application Publication
(10) Pub. No.: US 2023/0229675 A1
(43) Pub. Date: Jul. 20, 2023

(54) METHODS AND SYSTEMS THAT CONTINUOUSLY OPTIMIZE SAMPLING RATES FOR METRIC DATA IN DISTRIBUTED COMPUTER SYSTEMS BY PRESERVING METRIC-DATA-SEQUENCE INFORMATION CONTENT

(71) Applicant: VMware, Inc., Palo Alto, CA (US)

(72) Inventors: Ashot Hautyunyan, Yerevan (AM); Arnak Poghosyan, Yerevan (AM); Tigran Bunarjyan, Yerevan (AM); Naira Movses Grigoryan, Yerevan (AM)

(73) Assignee: VMware, Inc., Palo Alto, CA (US)

(21) Appl. No.: 17/577,318

(22) Filed: Jan. 17, 2022

(51) Int. Cl. G06F 16/28

(52) U.S. Cl. CPC G06F 16/285

(57) ABSTRACT

The current document is directed to methods and systems that collect metric data within computing facilities, including large data centers and cloud-computing facilities. In a described implementation, two or more metric-data sets are combined to generate a multidimensional metric-data set. The multidimensional metric-data set is compressed for efficient storage by clustering the multidimensional data points within the multidimensional metric-data set to produce a covering subset of multidimensional data points and by then representing the multidimensional-data-point members of each cluster by a cluster identifier rather than by a set of floating-point values, integer values, or other types of data representations. The covering set is constructed to ensure that the compression does not result in greater than a specified level of distortion of the original data.

### TECHNICAL FIELD

The current document is directed to computer-system monitoring and management and, in particular, to methods and systems that collect, generate, and store multidimensional metric data used for monitoring, management, and administration of computer systems and that continuously optimize sampling rates for metric data.

### BACKGROUND

Early computer systems were generally large, single-processor systems that sequentially executed jobs encoded on huge decks of Hollerith cards. Over time, the parallel evolution of computer hardware and software produced main-frame computers and minicomputers with multi-tasking operating systems, increasingly capable personal computers, workstations, and servers, and, in the current environment, multi-processor mobile computing devices, personal computers, and servers interconnected through global networking and communications systems with one another and with massive virtual data centers and virtualized cloud-computing facilities. This rapid evolution of computer systems has been accompanied with greatly expanded needs for computer-system monitoring, management, and administration. Currently, these needs have begun to be addressed by highly capable automated data-collection, data analysis, monitoring, management, and administration tools and facilities. Many different types of automated monitoring, management, and administration facilities have emerged, providing many different products with overlapping functionalities, but each also providing unique functionalities and capabilities. Owners, managers, and users of large-scale computer systems continue to seek methods, systems, and technologies to provide secure, efficient, and cost-effective data-collection and data analysis tools and subsystems to support monitoring, management, and administration of computing facilities, including cloud-computing facilities and other large-scale computer systems.

### SUMMARY

The current document is directed to methods and systems that collect, generate, and store multidimensional metric data used for monitoring, management, and administration of computer systems and that continuously optimize sampling rates for metric data. Multiple different metric-data streams are collected for each of multiple different distributed-computer-system objects, sampled, and hierarchically organized into a number of different 1-dimensional and multidimensional sampled metric-data streams. The sampling rates for the different 1-dimensional and multidimensional metric-data streams may be correspondingly hierarchically optimized in order to avoid oversampling the metric data while preserving sufficient information contained in the metric data for downstream data analysis, as determined by comparing the information content of high-frequency-sampled metric-data sequences to the information content of metric-data sequences sampled at a current sampling rate.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates a distributed data center or cloud-computing facility that includes a metric-data collection-and-storage subsystem.

FIG. 12 illustrates the many different types of metric data that may be generated by virtual machines and other physical and virtual components of a data center, distributed computing facility, or cloud-computing facility.

FIG. 13 illustrates metric-data collection within a distributed computing system.

FIG. 14 illustrates generation of a multidimensional metric-data set from multiple individual metric-data sets.

FIG. 15 illustrates a view of a temporarily aligned set of metric-data sets as a multidimensional data set.

FIGS. 16A-H illustrate clustering of multidimensional data points. As mentioned above, clustering of multidimensional data points provides for cluster-based data compression for efficient storage of multidimensional metric data sets.

FIG. 17 summarizes clustering a multidimensional metric-data set to generate a covering subset.

FIGS. 18A-H provide control-flow diagrams that illustrate generation of a covering set for a multidimensional metric-data set.

FIGS. 19A-D illustrate the use of a covering set for a multidimensional metric-data set to compress a multidimensional metric-data set for storage within a distributed computing system.

FIGS. 20A-F illustrates one implementation of a metric-data collection-and-storage subsystem within a distributed computing system that collects, compresses, and stores a multidimensional metric-data set for subsequent analysis and use in monitoring, managing, and administrating the distributed computing system.

FIG. 21 illustrates the fundamental components of a feed-forward neural network.

FIG. 22 illustrates a small, example feed-forward neural network.

FIG. 23 provides a concise pseudocode illustration of the implementation of a simple feed-forward neural network.

FIG. 24 illustrates back propagation of errors through the neural network during training.

FIGS. 25A-B show the details of the weight-adjustment calculations carried out during back propagation.

FIGS. 26A-B illustrate various aspects of recurrent neural networks.

FIGS. 27A-C illustrate a convolutional neural network.

FIGS. 28A-B illustrate neural-network training as an example of machine-learning-based-subsystem training.

FIG. 29 illustrates several examples of fully predictable metric-data sequences or streams.

FIG. 30 illustrates the effect of different sampling rates on the information content of a sampled metric-data sequence.

FIGS. 31A-B illustrate sampling-rate information loss for fully predictable metric-data sequences.

FIGS. 32A-B illustrate the sampling-rate optimization components included in one implementation of a metric-data collection, storage, and analysis system.

FIG. 33 provides an example implementation of a direct compression component, such as direct compression component 3212 in FIG. 32A.

FIGS. 34A-D provide control-flow diagrams that illustrate implementation of direct-compression logic.

FIGS. 35A-C illustrate components of a generalized implementation of a sampling/aggregation component, such as sampling/aggregation components 3214, 3216, and 3224 shown in FIG. 32A.

FIGS. 36A-G provide control-flow diagrams that illustrate implementation of the generalized sampling/aggregation component discussed above with reference to FIGS. 35A-C.

FIGS. 37A-E illustrate numerous statistical and data-analysis methods and processes that are used in various different sampling-rate evaluation routines that are subsequently discussed, below, with reference to FIGS. 38A-43.

FIGS. 38A-B illustrate a first type of metric-data sampling-rate evaluation method that can be encompassed in a sampling-rate-evaluation routine.

FIG. 39 illustrates a second type of metric-data sampling-rate evaluation method that can be encompassed in a sampling-rate-evaluation routine.

FIG. 40 illustrates a third type of metric-data sampling-rate evaluation method that can be encompassed in a sampling-rate-evaluation routine.

FIG. 41 illustrates a fourth type of metric-data sampling-rate evaluation method that can be encompassed in a rate-evaluation routine.

FIG. 42 illustrates a fifth type of metric-data sampling-rate evaluation method that can be encompassed in a rate-evaluation routine.

FIG. 43 illustrates a sixth type of metric-data sampling-rate evaluation method that can be encompassed in a rate-evaluation routine.

### DETAILED DESCRIPTION

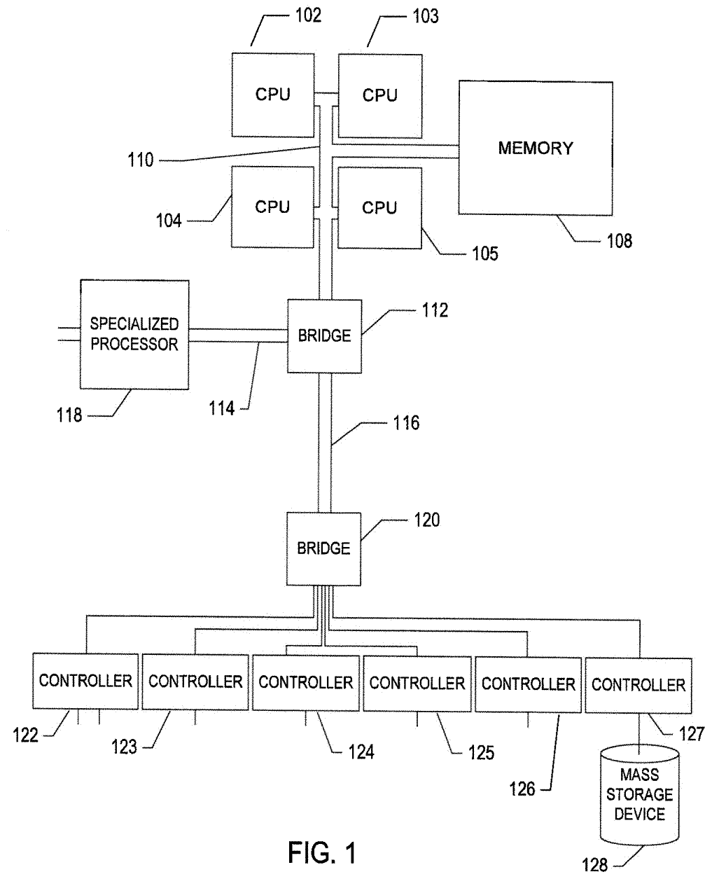

The current document is directed to methods and systems that continuously optimize sampling rates for metric data. In a first subsection, below, a detailed description of computer hardware, complex computational systems, and virtualization is provided with reference to FIGS. 1-10. In a second subsection, a system that collects, stores, and analyzes metric data within a distributed computer system is discussed. In a third subsection, an overview of neural networks is provided. In a final subsection, the currently disclosed methods and systems that continuously optimize sampling rates for metric data are discussed, in detail.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPI's”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

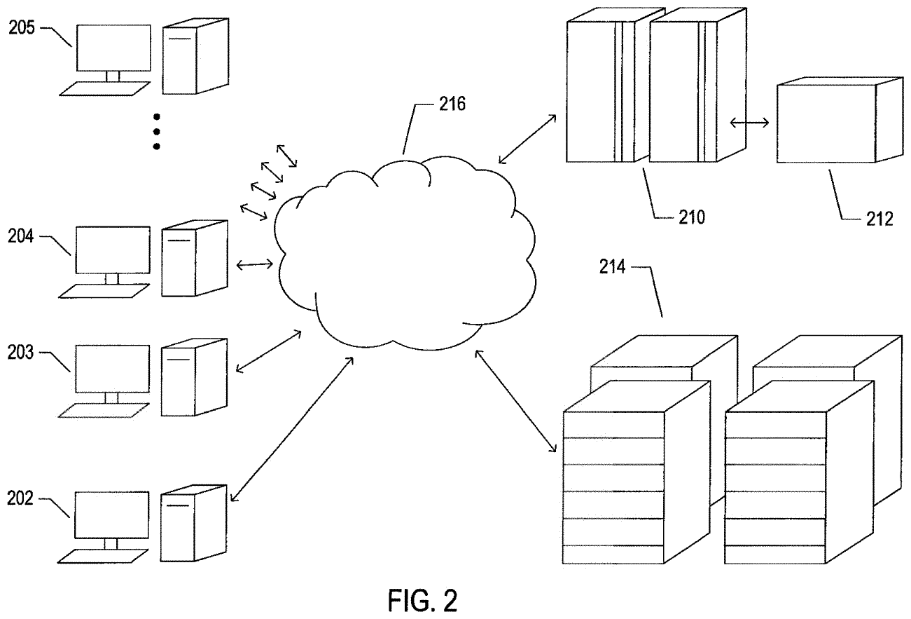

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

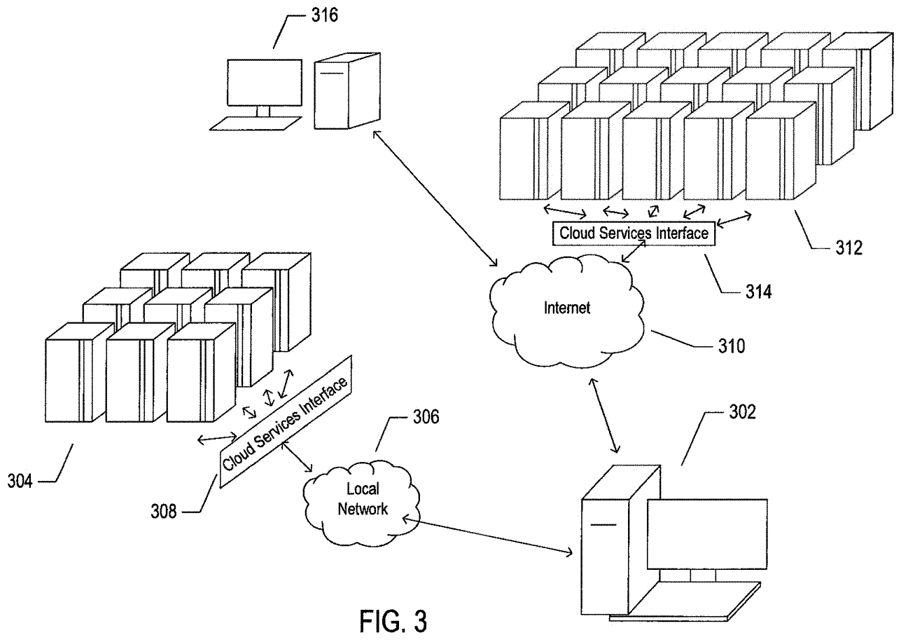

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private to cloud-computing facilities used by a single organization.

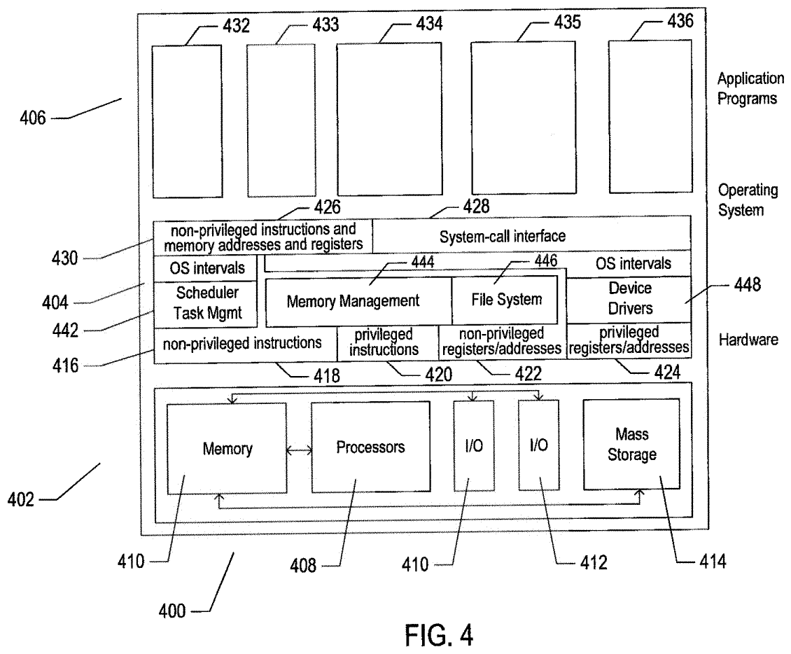

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

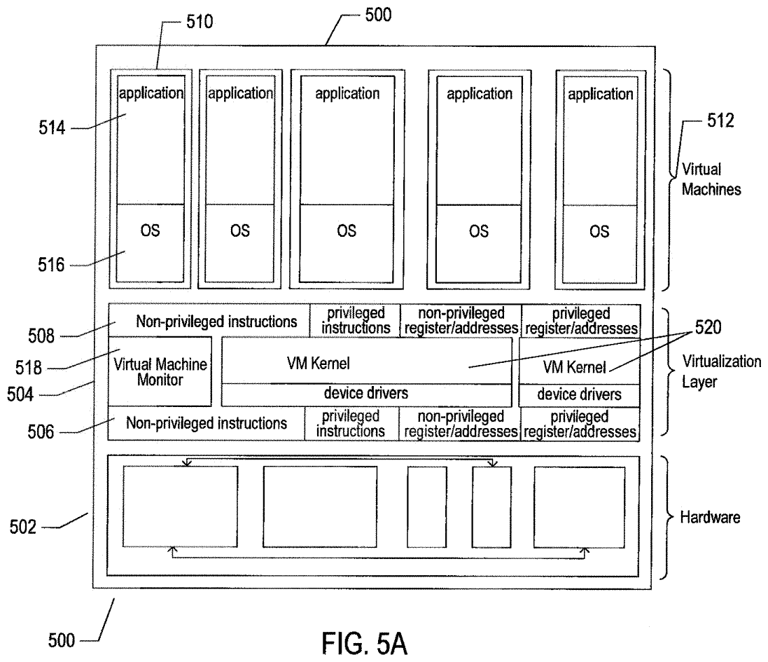

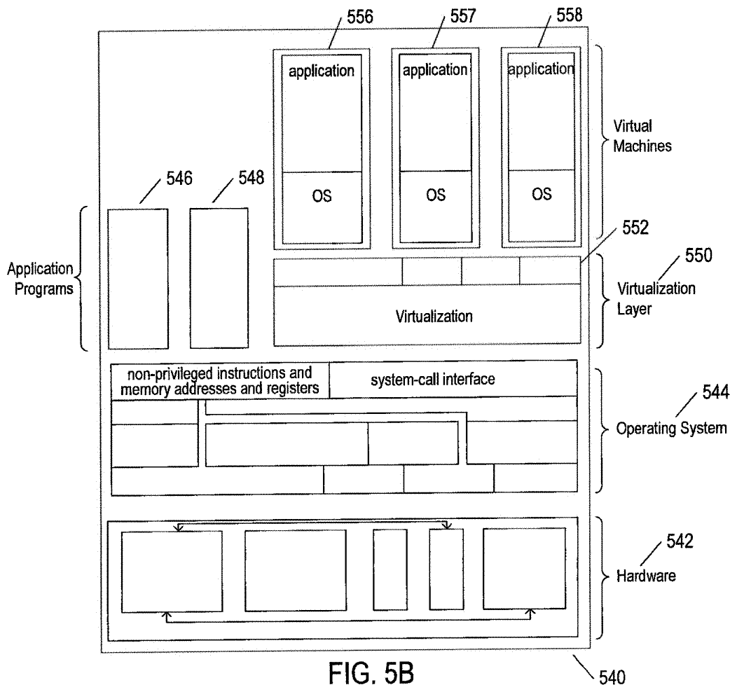

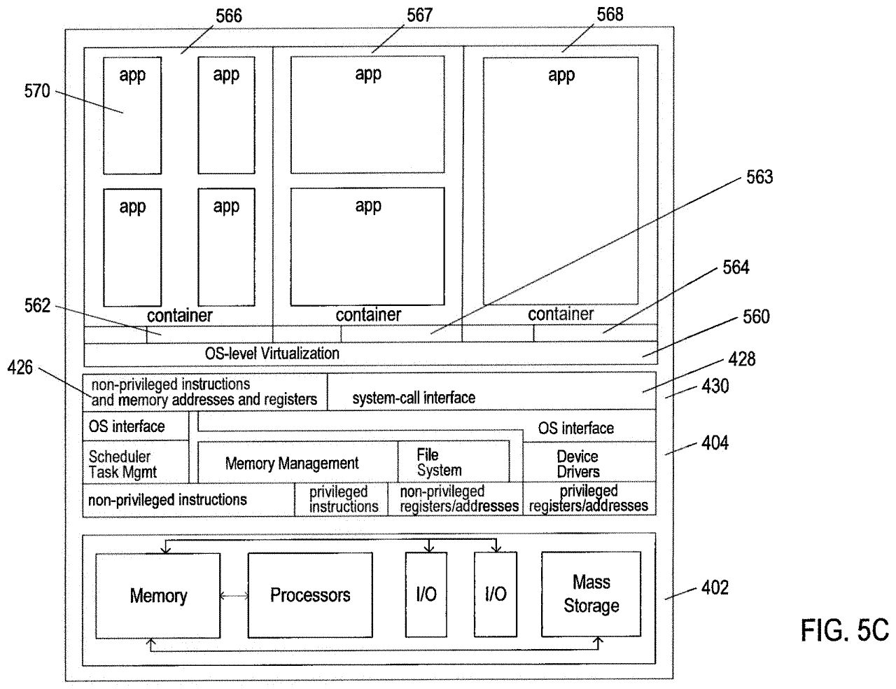

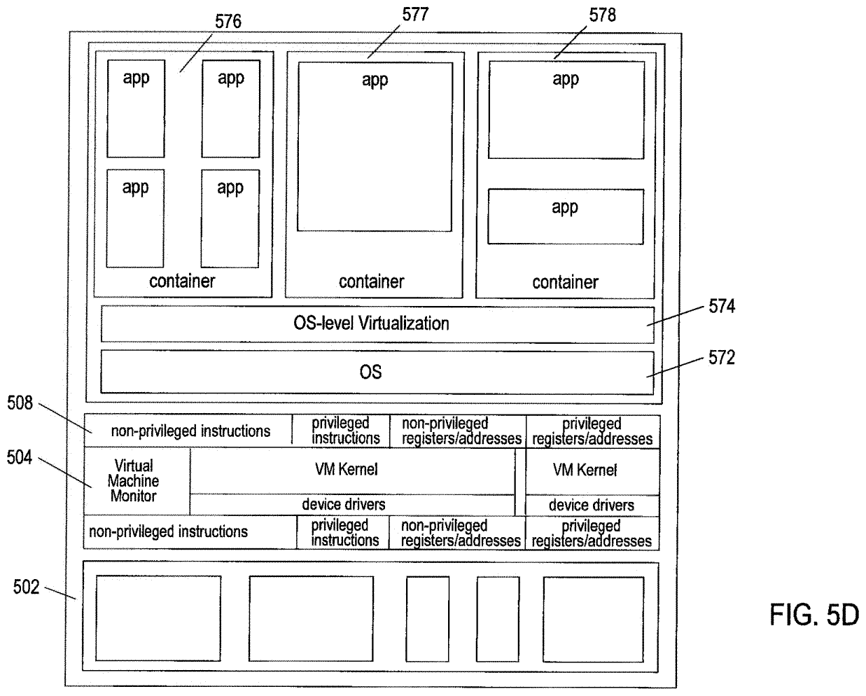

For all of these reasons, a higher level of abstraction, referred to as the “virtual machine.” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”), The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

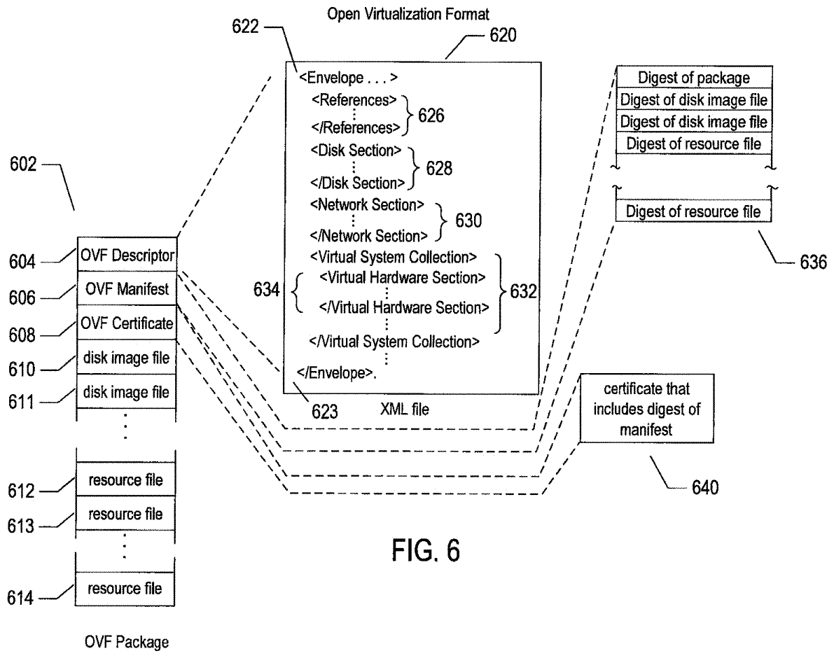

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

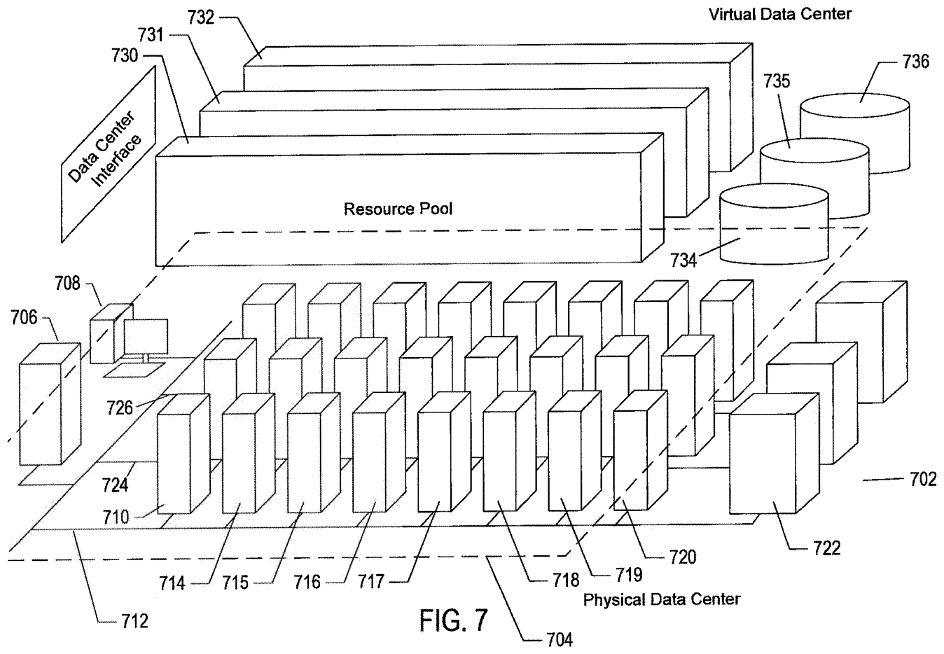

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

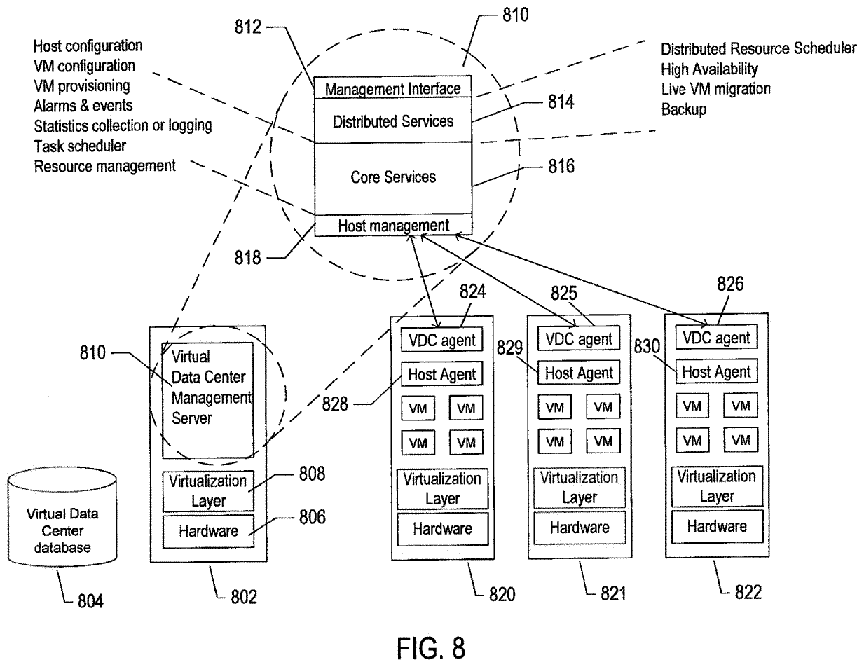

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808, and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

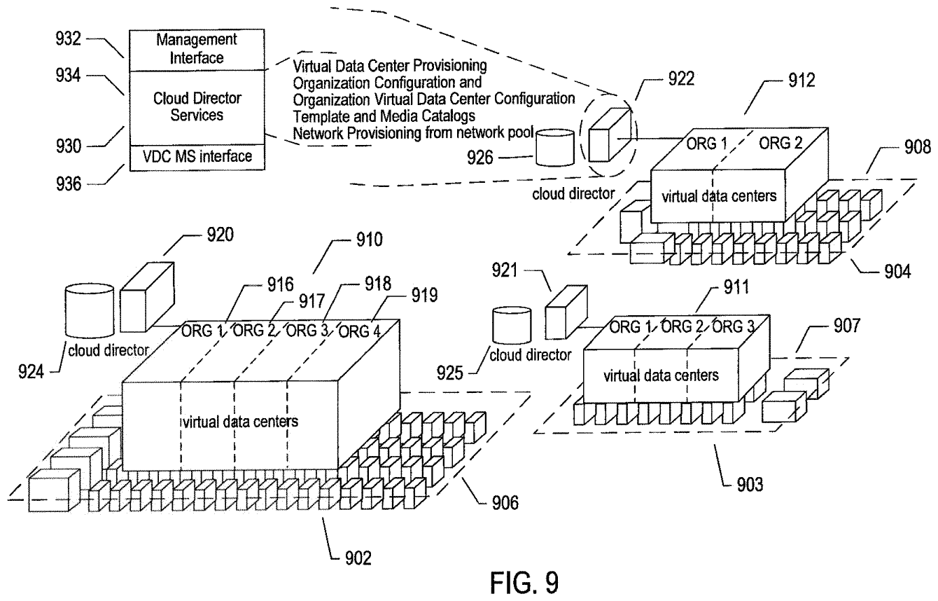

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

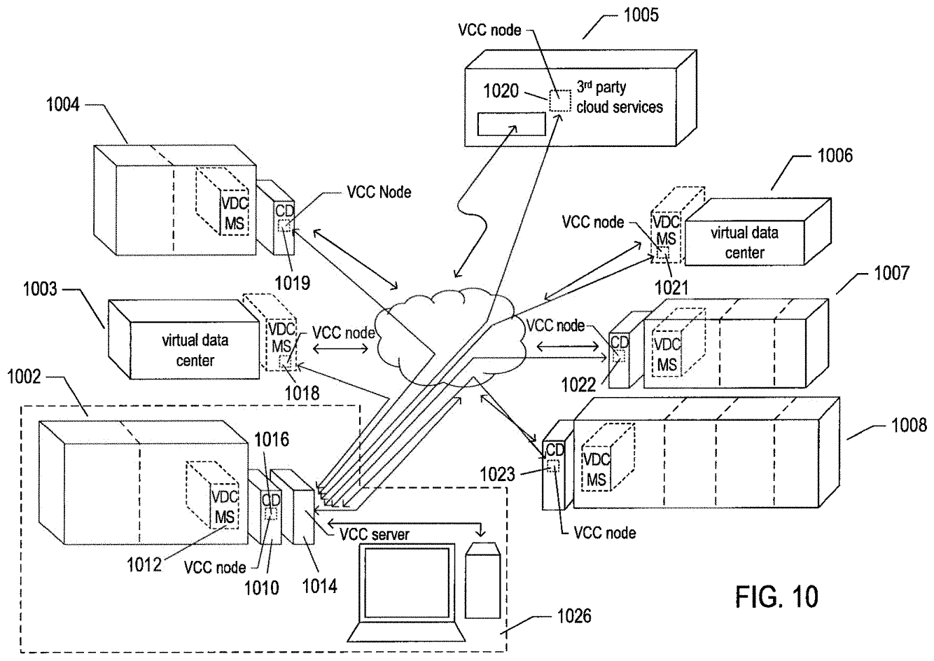

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Currently Disclosed Methods and Systems

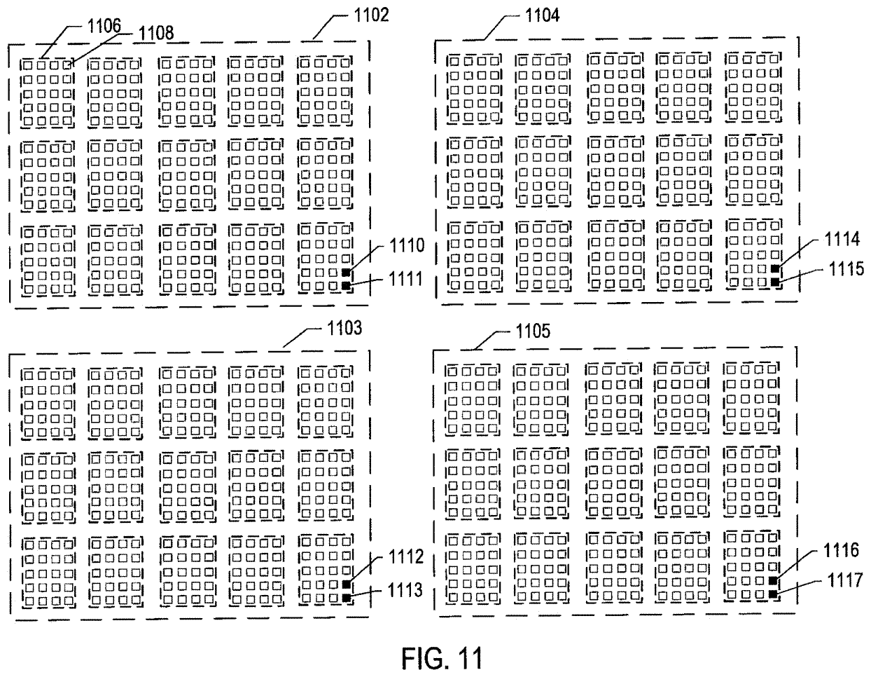

FIG. 11 illustrates a distributed data center or cloud-computing facility that includes a metric-data collection-and-storage subsystem. The distributed data center includes four local data centers 1102-1105, each of which includes multiple computer systems, such as computer system 1106 in local data center 1102, with each computer system running multiple virtual machines, such as virtual machine 1108 within computer system 1106 of local data center 1102. Of course, in many cases, the computer systems and data centers are virtualized, as are networking facilities, data-storage facilities, and other physical components of the data center, as discussed above with reference to FIGS. 7-10. In general, local data centers may often contain hundreds or thousands of servers that each run multiple virtual machines. Several virtual machines, such as virtual machines 1110-1111 in a local data center 1102, may provide execution environments that support execution of applications dedicated to collecting and storing metric data regularly generated by other virtual machines and additional virtual and physical components of the data center. Metric-data collection may be, in certain cases, carried out by event-logging subsystems. In other cases, metric-data collection may be carried out by metric-data collection subsystems separate from event-logging subsystems. The other local data centers 1103-1105 may similarly include one or more virtual machines that run metric-data-collection and storage applications 1112-1117.

The metric-data-collection and storage applications may cooperate as a distributed metric-data-collection-and-storage facility within a distributed monitoring, management, and administration component of the distributed computing facility. Other virtual machines within the distributed computing facility may provide execution environments for a variety of different data-analysis, management, and administration applications that use the collected metrics data to monitor, characterize, and diagnose problems within the distributed computing facility. While abstract and limited in scale, FIG. 11 provides an indication of the enormous amount metric data that may be generated and stored within a distributed computing facility, given that each virtual machine and other physical and virtual components of the distributed computing facility may generate hundreds or thousands of different metric data points at relatively short, regular intervals of time.

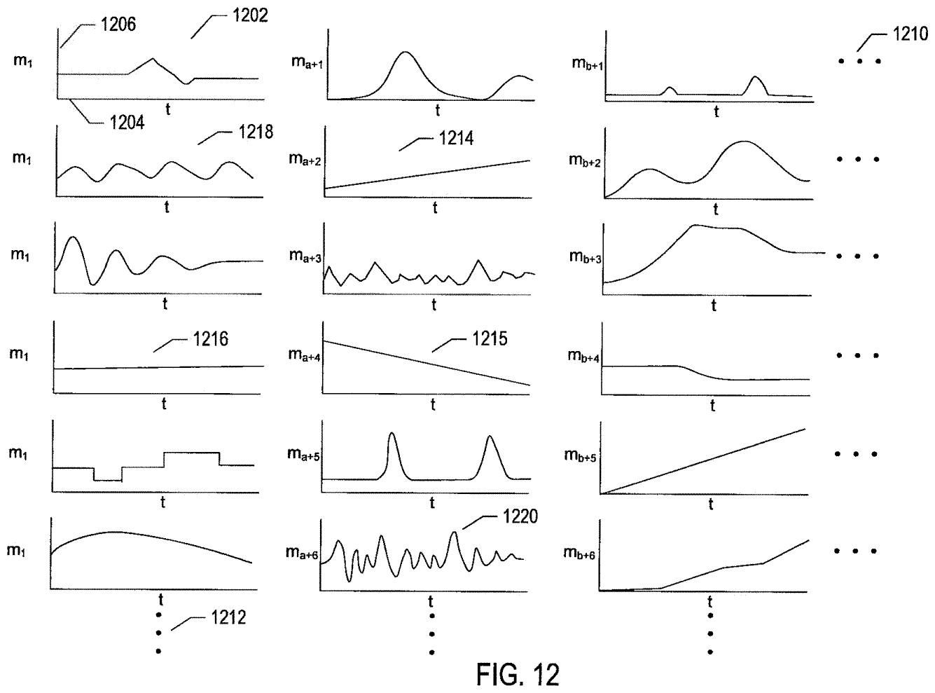

FIG. 12 illustrates the many different types of metric data that may be generated by virtual machines and other physical and virtual components of a data center, distributed computing facility, or cloud-computing facility. In FIG. 12, each metric is represented as 2-dimensional plot, such as plot 1202, with a horizontal axis 1204 representing time, a vertical axis 1206 representing a range of metric values, and a continuous curve representing a sequence of metric-data points, each metric-data point representable as a timestamp/metric-data-value pair, collected at regular intervals. Although the plots show continuous curves, metric data is generally discrete, produced at regular intervals within a computing facility by a virtual or physical computing-facility component. A given type of component may produce different metric data than another type of component. For purposes of the present discussion, it is assumed that the metric data is a sequence of timestamp/floating-point-value pairs. Of course, data values for particular types of metrics may be represented as integers rather than floating-point values or may employ other types of representations. As indicated by the many ellipses in FIG. 12, such as ellipses 1210 and 1212, the set of metric-data types collected within a distributed computing facility may include a very large number of different metric types. The metric-data-type representations shown in FIG. 12 can be considered to be a small, upper, left-hand corner of a large matrix of metric types that may include many hundreds or thousands of different metric types. As shown in FIG. 12, certain metric types have linear or near-linear representations 1214-1216, other metric types may be represented by periodic or oscillating curves 1218, and others may have more complex forms 1220.

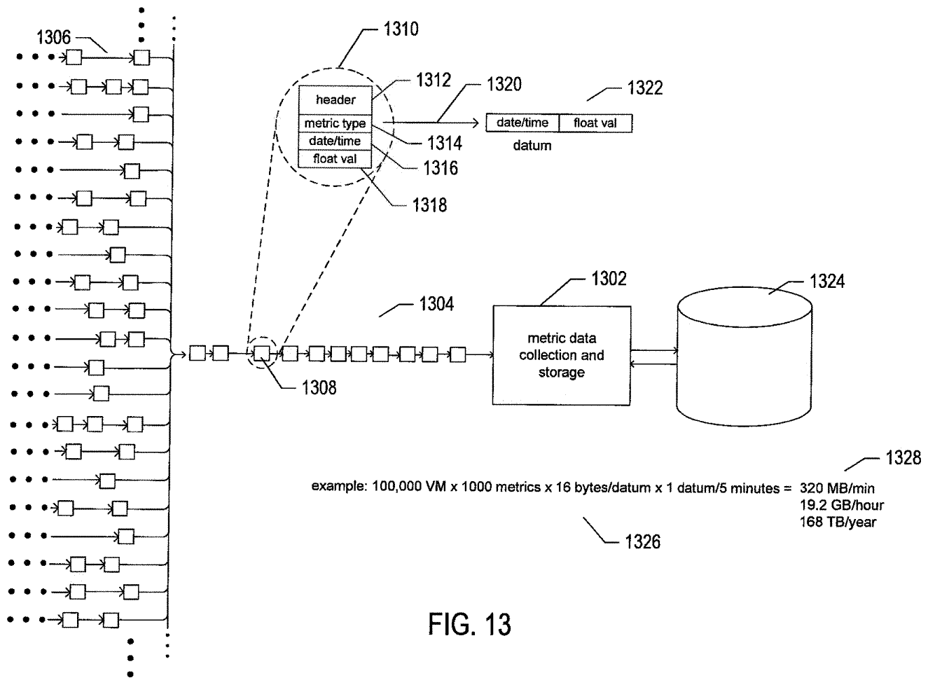

FIG. 13 illustrates metric-data collection within a distributed computing system. As discussed above with reference to FIG. 11, a distributed computing system may include numerous virtual machines that provide execution environments for dedicated applications that collect and store metric data on behalf of various data-analysis, monitoring, management, and administration subsystems. In FIG. 13, rectangle 1302 represents a metric-data-collection application. The metric-data-collection application receives a continuous stream of messages 1304 from a very large number of metric-data sources, each represented by a separate message stream, such as message stream 1306, in the left-hand portion of FIG. 13. Each metric-data message, such as metric-data message 1308 shown in greater detail in inset 1310, generally includes a header 1312, an indication of the metric-data type 1314, a timestamp, or date/time indication 1316, and a floating-point value 1318 representing the value of the metric at the point in time represented by the timestamp 1316. In general, the metric-data collection-and-storage subsystem 1302 processes the received messages, as indicated by arrow 1320, to extract a timestamp/metric-data-value pair 1322 that is stored in a mass-storage device or data-storage appliance 1324 in a container associated with the metric-data type and metric-data source. Alternatively, the timestamp/metric-data-value pair may be stored along with additional information indicating the type of data and data source in a common metric-data container or may be stored more concisely in multiple containers, each associated with a particular data source or a particular type of metric data, such as, for example, storing timestamp/metric-data-value pairs associated with indications of a metric-data type in a container associated with a particular metric-data source.

As indicated by expression 1326 in FIG. 13, assuming a distributed cloud-computing facility running 100,000 virtual machines, each generating 1000 different types of metric-data values every 5 minutes, and assuming that each timestamp/metric-data-value pair comprises two 64-bit values, or 16 bytes, the distributed cloud-computing facility may generate 320 MB of metric data per minute 1328, equivalent to 19.2 GB of metric data per hour or 168 TB of metric data per year. When additional metric-data-type identifiers and data-source identifiers are stored along with the timestamp/metric-data-value pair, the volume of stored metric data collected per period of time may increase by a factor of 2 or more. Thus, physical storage of metric data collected within a distributed computer system may represent an extremely burdensome data-storage overhead. Of course, that data-storage overhead also translates into a very high computational-bandwidth overhead, since the stored metric data is generally retrieved from the data-storage appliance or appliances and processed by data-analysis, monitoring, management, and administration subsystems. The volume of metric data generated and stored within a distributed computing facility thus represents a significant problem with respect to physical data-storage overheads and computational-bandwidth overheads for distributed computing systems, and this problem tends to increase over time as distributed computing facilities include ever greater numbers of physical and virtual components and as additional types of metric data are collected and processed by increasingly sophisticated monitoring, management, and administration subsystems.

A second problem related to metric-data collection and processing within distributed computing systems is that, currently, most systems separately collect and store each different type of metric data and separately process each different type of metric data. As one example, monitoring subsystems may often monitor the temporal behavior of particular types of metric data to identify anomalies, such as a spike or significant pattern shift that may correspond to some type of significant state change for the physical-or-virtual-component source of the metric data. The anomalies or outlying data points discovered by this process may then be processed, at a higher level, within a monitoring subsystem in order to attempt to map the anomalies and changes to particular types of events with different priority levels. A disk failure, for example, might be reflected in anomalies detected in various different metrics generated within the distributed computing facility, including operational-status metrics generated by a data-storage subsystem as well as operational-status metrics generated by virtual-memory subsystems or guest operating systems within affected virtual machines. However, current data analysis may often overlook anomalies and changes reflected in combinations of metric data for which the individual metric data do not individually exhibit significant pattern changes or significant numbers of outlying data values. In other words, current data-analysis and monitoring subsystems may fail to detect departures from normal behavior that might not be reflected in anomalies detected in individual types of metric data, but that would only emerge were multiple types of metric data analyzed concurrently. However, because of the enormous volumes of metric data collected within distributed computing systems, attempts to detect such anomalies by considering various different combinations of collected types of metric data would quickly lead to an exponential increase in the computational-bandwidth overheads associated with metric-data analysis and with monitoring of the operational status of the distributed computing system.

The currently disclosed methods and systems have been developed to address the two problems discussed above, in the preceding paragraph, as well as additional problems associated with the collection, storage, and analysis of metric data within distributed computing systems. The currently disclosed methods and systems generate multidimensional metric-data sets in which each multidimensional data point includes component values for each of multiple single-dimensional metric-data sets. The multidimensional metric-data sets are compressed for efficient storage using multidimensional metric-data-point clustering, as explained below. Multidimensional metric-data sets are efficiently analyzed to identify anomalous and significant multidimensional metric data points that are difficult to identify using single-dimensional metric data sets, and cluster compression of multidimensional metric-data sets can provide efficient storage for the data that would otherwise be stored as multiple single-dimensional metric-data sets.

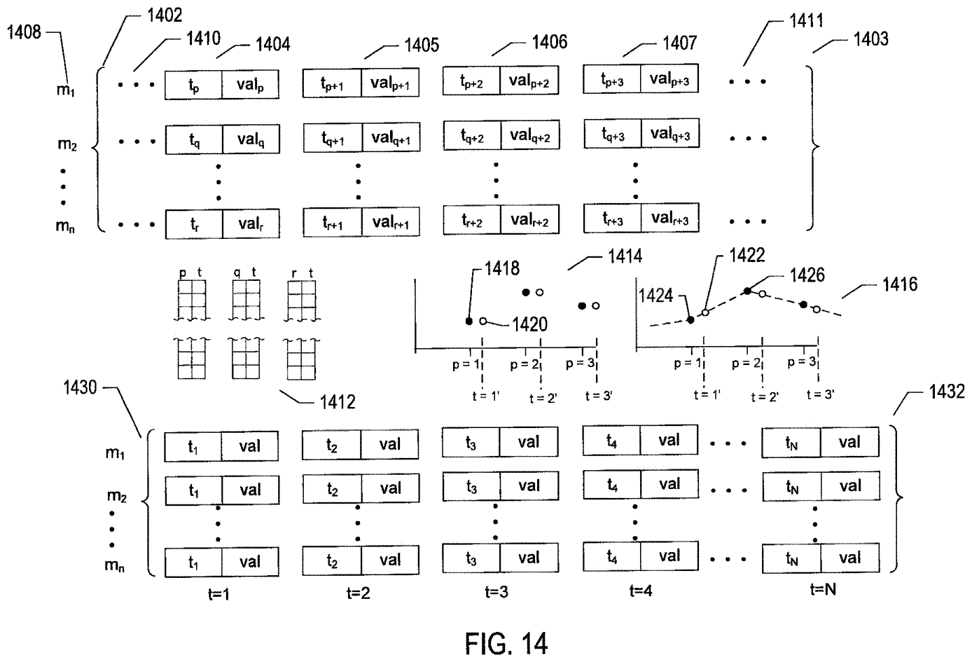

FIG. 14 illustrates generation of a multidimensional metric-data set from multiple individual metric-data sets. At the top of FIG. 14, a set of metric-data sets m₁, m₂, . . . , mₙ is shown within brackets 1402-1403. Each metric-data set consists of a time series of timestamp/metric-data-value pairs, such as the timestamp/metric-data-value pairs 1404-1407 that together compose a portion of the m₁ metric-data set 1408. Ellipses 1410-1411 indicate that the time series continues in both directions in time. The horizontal position of each timestamp/metric-data-value pair reflects the time indicated by the timestamp in the timestamp/metric-data-value pair. In this example, the timestamp/metric-data-value pairs are generated at a regular time interval, but as indicated by the misalignment in time between the timestamp/metric-data-value pairs of adjacent metrics, the times at which values are generated for a given metric-data set made the different from the times for which values are generated for another metric-data set.

As indicated by the set of tables 1412 and by plots 1414 and 1416, a number of different approaches can be taken in order to temporally align timestamp/metric-data-value pairs of multiple separate metric-data sets. As indicated by tables 1412, a correspondence or map can be generated to map each of the timestamps for each metric-data set to a common time t. This mapping can be accomplished, as one example, by selecting time points in the metric-data set closest to common time points and assigning the timestamps in each timestamp/metric-data-value pair to reflect the closest common-time timepoint, as shown in plot 1414. In this plot, the shaded disks, such as shaded disk 1418, represent the original timestamp/metric-data-value pairs in the metric-data set and the unshaded disks, such as shaded disk 1420, represent timestamp/metric-data-value pairs shifted to the common time interval. Alternatively, as shown in plot 1416, linear interpolation can be used in order to adjust the values of the metric-data set as the timestamps are shifted to a common time interval. For example, the timestamp/metric-data-value pair represented by the unshaded disc 1422 represents an interpolation based on the original metric-data-set timestamp/metric-data-value pairs represented by shaded disks 1424 and 1426. There are a variety of additional methods that can be used to shift the timestamp/metric-data-value pairs of a metric-data set to a different time interval, including various types of nonlinear interpolation. The result of the minor time adjustments of the metric-data sets is, as shown in the lower portion of FIG. 14, an equivalent set of metric-data sets in which the timestamp/metric-data-value pairs within the different metric-data sets are aligned with respect to a common time interval, as indicated by the vertical alignment of the timestamp/metric-data-value pairs for all of the n metric-data sets into vertical columns. In certain systems, time shifting may not be necessary when metric-data sets that are to b, combined to form a multidimensional metric-data set share a common reporting interval, as in the case in which virtual machines report the values of multiple metric-data sets together at a regular time interval, such as every 5 minutes. In other systems, the types of data analysis carried out on multidimensional metric data may be insensitive to small discrepancies in time intervals between metric-data sets, as a result of which interpolation of time-shifted values is unnecessary. However, when this is not the case, or when metric data from two different metric-data sources with different reporting intervals are combined to form a multidimensional metric-data set, any of various types of time shifting may be applied in order to produce multiple temporarily aligned metric-data sets, such as those shown between brackets 1430 and 1432 at the bottom of FIG. 14.

As discussed below, in certain implementations, null entries may be included in a sequence of multidimensional data points that together comprise a multidimensional metric-data set to represent missing multidimensional data points and incomplete multidimensional data points. For example, when a metric-data set includes data points generally collected at a regular interval, but the time difference between a particular pair of data points is twice that interval, absent any other contradictory evidence, it may be reasonable to infer that there is a missing data point between the two data points of the pair, and to therefore represent the missing data point by a null entry. Similarly, when one component of a multidimensional data point is missing, it may be reasonable to represent that multidimensional data point as a null entry in a sequence of multidimensional data points that together comprise a multidimensional metric-data set.

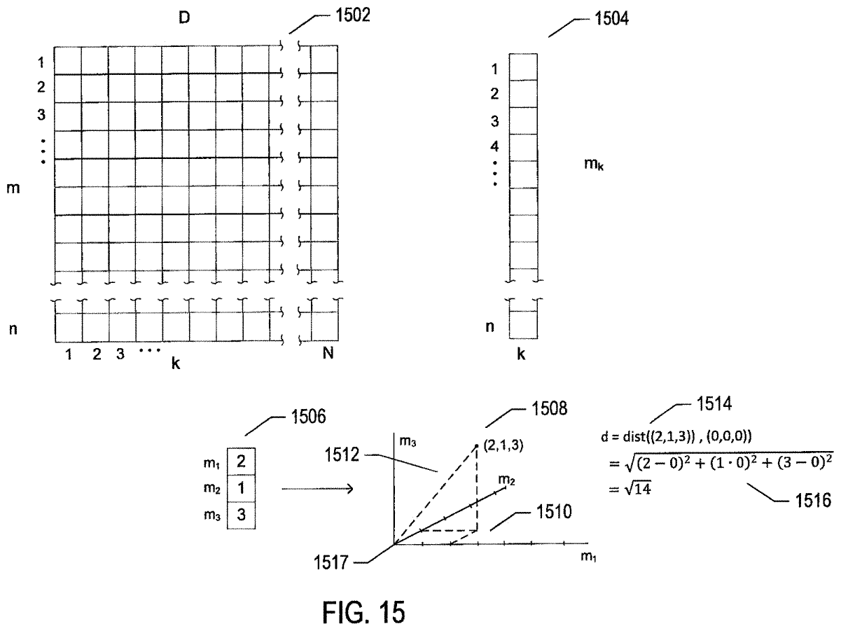

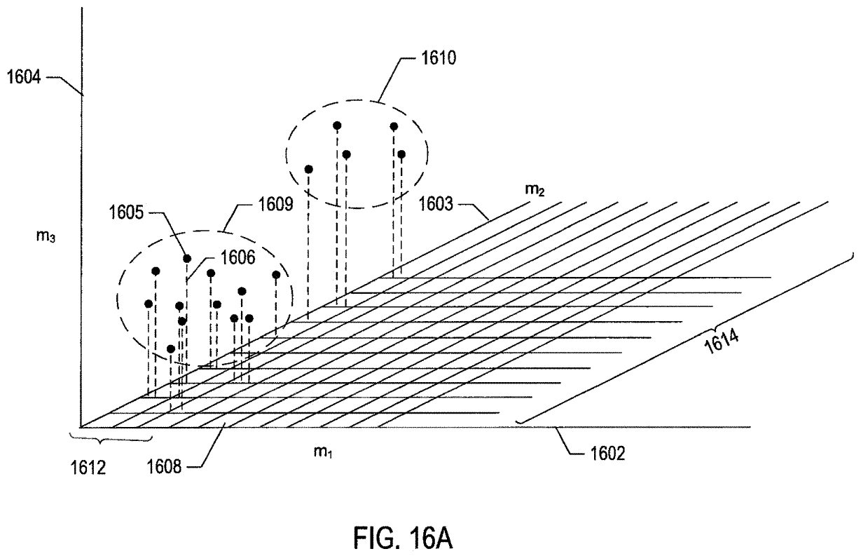

FIG. 15 illustrates a view of a temporarily aligned set of metric-data sets as a multidimensional data set. The 2-dimensional matrix D 1502 represents a set of temporarily aligned metric-data sets. Each row in the matrix contains metric values for a particular metric and each column in the matrix represents all of the metric values for the set of metric-data sets at a common time point. When viewed as a multidimensional metric-data set, each column of the matrix, such as the case column 1504, can be viewed as a single point in a multidimensional space. For example, when three metric-data sets m₁, m₃, and m₃ are combined to form a single multidimensional metric-data set, a particular column 1506 can be viewed as containing the coordinates of a point 1508 in a 3-dimensional space 1510. Alternatively, the column can be viewed as a vector 1512 in 3-dimensional space. The dimensionality of the space is equal to the number of metric-data sets combined together to form the multidimensional metric-data set. In this view, a distance d can be assigned 1514 to any two points in the multidimensional space by any of various different distance metrics. A common distance metric is the Euclidean distance metric, the computation for which, in 3 dimensions, is shown by expression 1516 for the point 1508 with coordinates (2, 1, 3) and the origin 1517 with coordinates (0, 0, 0). Other types of distance metrics can be used in alternative implementations.

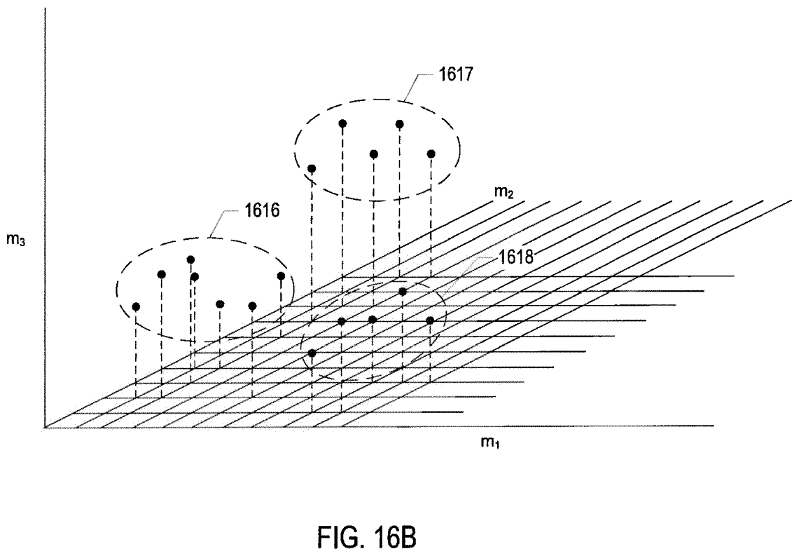

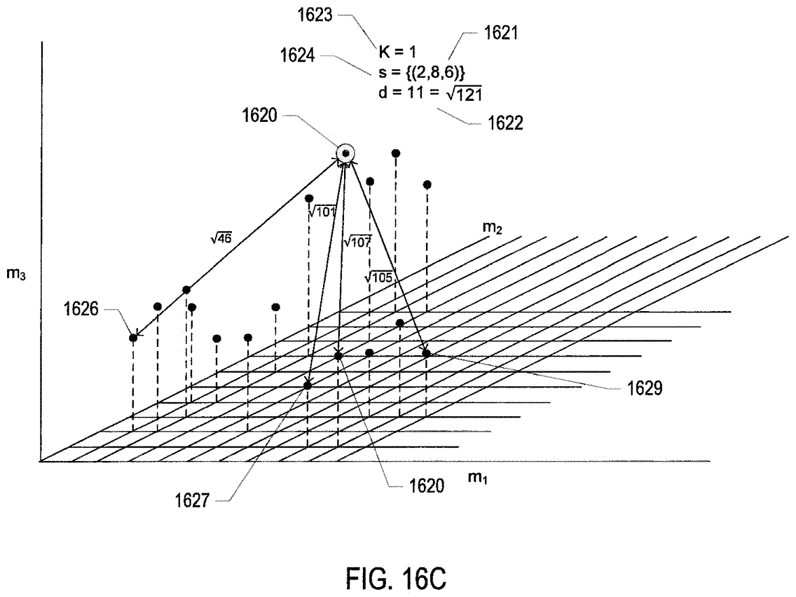

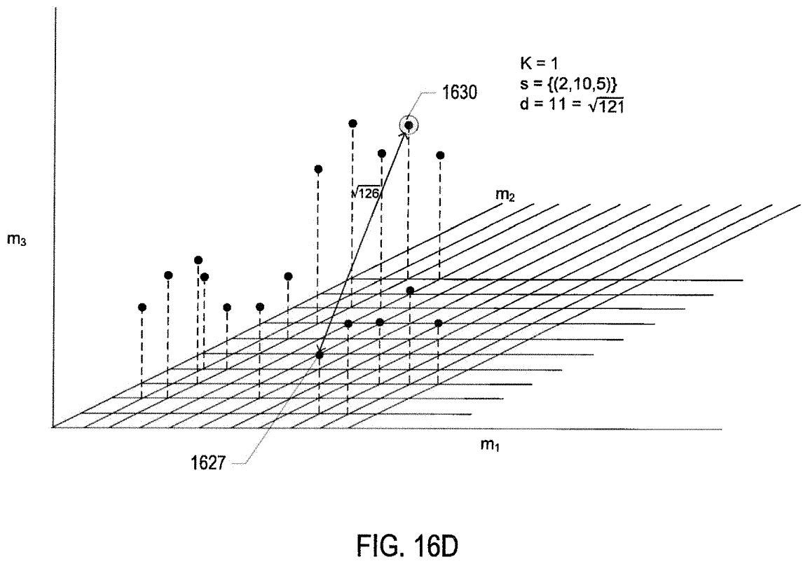

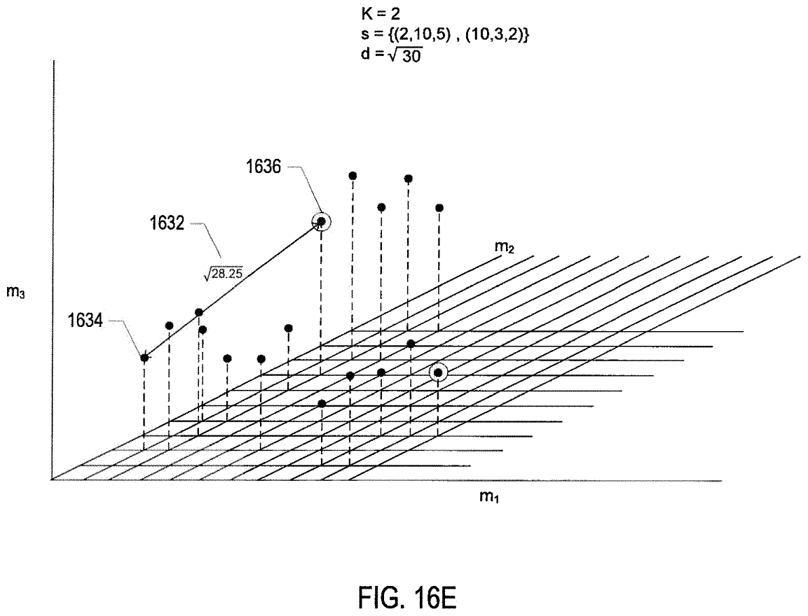

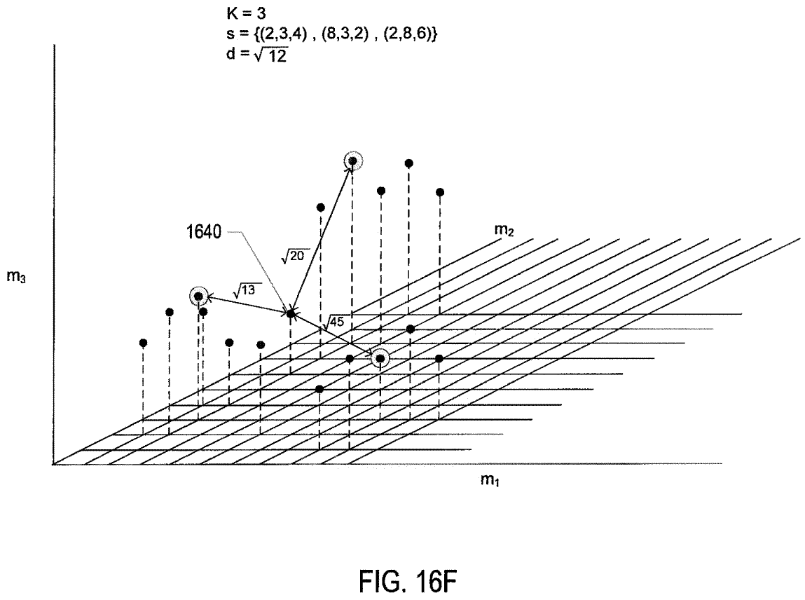

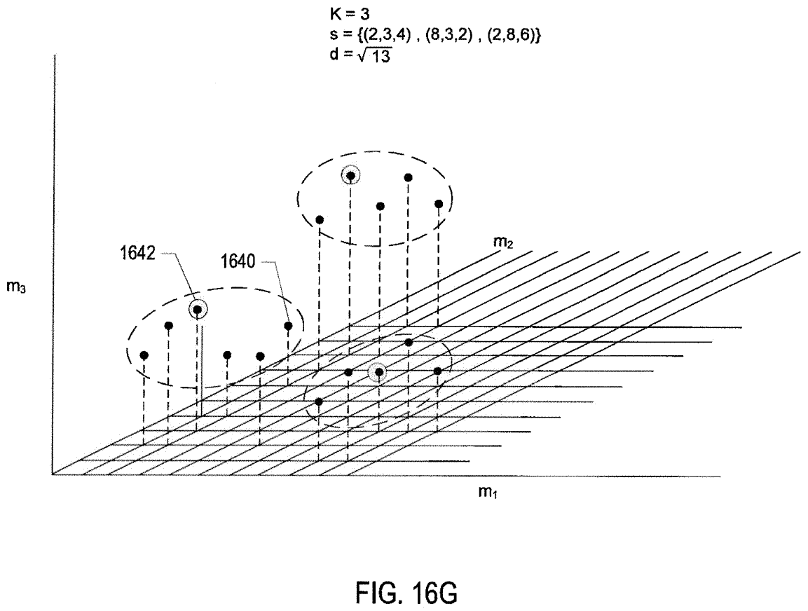

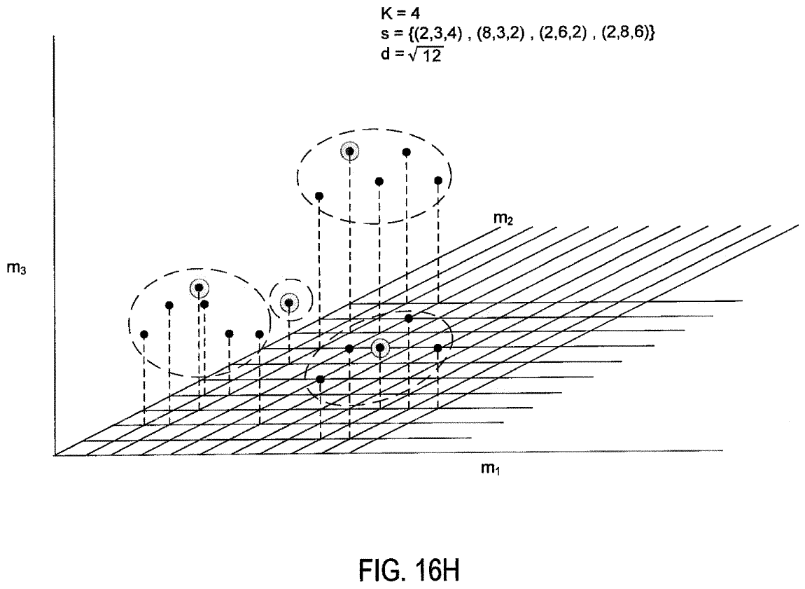

FIGS. 16A-H illustrate clustering of multidimensional data points. As mentioned above, clustering of multidimensional data points provides for cluster-based data compression for efficient storage of multidimensional metric data sets. FIG. 16A shows a plot of a 3-dimensional metric-data set. The 3 Cartesian axes 1602-1604 corresponds to 3 different metric-data sets which are combined, as discussed above with reference to FIGS. 14-15, to produce 3-dimensional vectors or data points, such as data point 1605, plotted within the 3-dimensional plot shown in FIG. 16A. Each multidimensional data point is represented by a shaded disk, with a vertical dashed line, such as vertical dashed line 1606, indicating where the multidimensional data point would be projected vertically downward onto the m₁/m₂ horizontal plane 1608. Based on cursory visual inspection, it appears that the multidimensional data points can be partitioned into a first cluster, surrounded by dashed curve 1609, and a second cluster, surrounded by dashed curve 1610. However, it is clear that the range of values of the m₁ component of the 3-dimensional data points are vectors is much narrower 1612 than the range of the m₂ components 1614, which compresses the 3-dimensional data points along a narrow strip adjacent to, and parallel to, the m₂ axis. As shown in FIG. 16B, renormalizing the m₁ component values by multiplying the original m₁ component values by 4 produces a set of 3-dimensional data points with approximately equal m₁ and m₂ component-value ranges. Moreover, cursory inspection of the normalized plot reveals an apparent clustering of the multidimensional data points into 3 distinct clusters 1616-1618. Thus, a normalization procedure may facilitate multidimensional-data-point clustering.

FIG. 16C, and subsequent FIGS. 16D-H, illustrate an approach to clustering the normalized multidimensional data points shown in FIG. 16B. In this clustering approach, one or more multidimensional data points are selected as cluster centers and a maximum distance is selected as a radius of a spherical volume around each center that defines the cluster volume. Multidimensional data points within a spherical volume about a cluster center are considered to belong to the cluster defined by the cluster center and cluster volume, or, equivalently, the corresponding cluster radius or diameter, while multidimensional data points outside of the spherical volume either belong to another cluster or are considered to be outliers that belong to no cluster. In one approach to clustering a multidimensional metric-data set, discussed below a covering vector subset or covering multidimensional-data-point subset of the multidimensional metric-data set is sought. Each multidimensional data point or vector in a covering subset represents a cluster center and every multidimensional data point in the multidimensional metric-data belongs to at least one cluster. In FIG. 16C, a single multidimensional data point 1620 with coordinates (2, 8, 6) 1621 has been selected as the center of a single cluster. The radius d defining the volume of space around the center is specified as 11, or \sqrt{121} (1622 in FIG. 16C). The value K 1623 is set to 1, indicating the number of clusters and the set S 1624 includes the single cluster center with coordinates (2, 8, 6) 1621. In FIG. 16C, a number of the distances between the cluster center 1620 and the most distant multidimensional data points from the cluster 1626-1629 has been computed and displayed next to line segments joining the distant multidimensional data points in the cluster center. As can be seen by these distances, all of the most distant multidimensional points from the cluster center are well within the specified radius d 1622. Thus, the parameter values K=1, S==={(2, 8, 6)}, d=11 specify a covering subset S of multidimensional data points for the multidimensional metric-data set plotted in FIG. 16C. However, as shown in FIG. 16I), when a different multidimensional data point 1630 is chosen as the cluster center, while maintaining the same parameters K=1 and d=11, the parameter values K=1, S={(2, 10, 5)}, d=11 do not specify a covering subset of multidimensional data points sine multidimensional data point 1627 is further from the cluster center 1630 that the distance d=11.

FIG. 16E illustrates a 2-multidimensional-data-point covering set with parameters values K=2, S={(2, 7, 4, 5), (10, 3, 2)}, d=11. As shown by computed distance 1632, the point 1634 most distant from the first cluster center 1636 is well within the radius d. FIG. 16F illustrates that the parameters K=3, S={(2, 3, 4), (8, 3, 2), (2,8,6)}, d=\sqrt{12} do not specify a covering subset of the multidimensional data point plotted in FIG. 16F, since data point 1640 lies at a distance of more than \sqrt{12} from all 3 cluster centers. However, as shown in FIG. 16G, by slightly changing the value of the radius parameter d, the parameters K=3, S={(2, 3, 4), (8, 3, 2), (2,8,6)}, d=\sqrt{13} do specify a covering subset of the multidimensional data point plotted in FIG. 16G. Multidimensional data point 1640, for example, lies at the farthest distance from any of the cluster centers but is within the specified radius from cluster center 1642. Finally, FIG. 16H shows that by changing the value of the parameter K rather than the parameter d, a different covering subset of multidimensional data points is found with parameter values K=4, S={(2, 3, 4), (8, 3, 2), (2,8,6)}, d=\sqrt{12}. Thus, by varying the selected cluster centers, the number of cluster centers, and the maximum distance from a cluster center for a cluster member, various different covering sets of multidimensional data points are obtained for the multidimensional data points of the multidimensional metric-data set originally plotted in FIG. 16B.

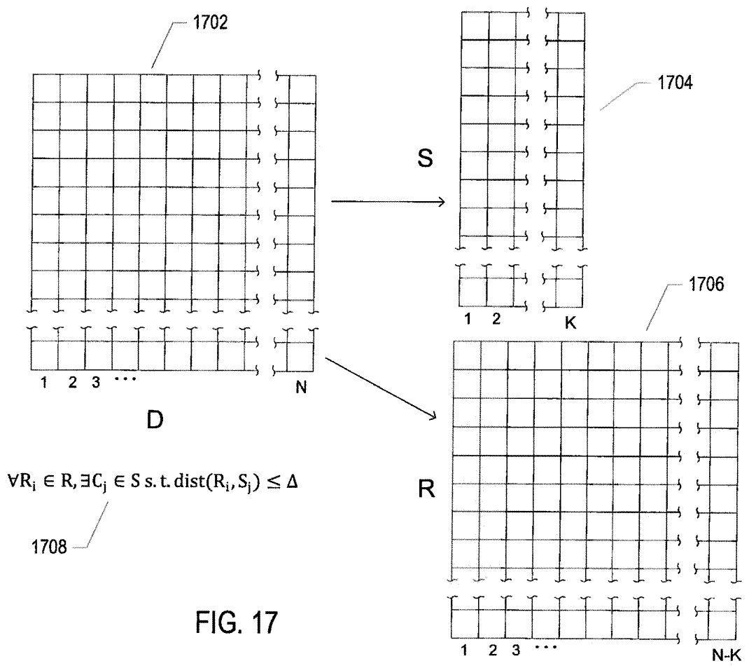

FIG. 17 summarizes clustering a multidimensional metric-data set to generate a covering subset. The multidimensional metric-data set 1702 is partitioned into a covering subset S 1704 and a remaining subset 1706 so that, as represented by expression 1708, each multidimensional data point in the remaining subset R 1706 is within the specified radius Δ of at least one vector or multidimensional data point in the covering set S 1704.

Next, clustering and cluster coverage are formally described. Consider a set of single-dimension metric data points with a common timestamp, M(t), with cardinality |n|:

M(t)={m₁(t),m₂(t), . . . ,mₙ(t)}

Then of single-dimension metric data points can be aggregated into a multi-dimensional metric data point:

m(t)≡(m₁(t),m₂(t), . . . ,mₙ(t))∈Rⁿ⁺¹

where m(t) is a multidimensional data point in an n+1-dimensional space, where one of the dimensions is time. In many cases, time can be excluded, resulting in a multi-dimensional data point mₖ in an n-dimensional space, where k is an index into a time-ordered series of N multi-dimensional data points:

M={mₖ}ₖ₌₁^{N},mₖ=(m_{1,k},m_{2,k}, . . . ,m_{n,k})∈Rⁿ

An optimal clustering can be obtained using a A-coverage metric. Each of L clusters is defined by a multi-dimensional data point in a subset C of M:

C={m_{1,l},m_{2,l}, . . . m_{n,l}},l=1, . . . ,L

For encoding purposes, the metric-data values of the data points in a cluster are all represented by a common value. The A-coverage metric provides an upper bound Δ for the distortion resulting from representing each data point in the set M by the metric-data value of a closest cluster-defining data point selected from the subset C. The upper bound Δ means that, for every multi-dimensional data point mₖ in M, there is a point mₗ, 1≤l≤L in C satisfying the following condition:

d(mₖ,mₗ)≤Δ,

where d( ) is a distance measure between two multi-dimensional data points. An outlier-A-coverage upper bound for a set M of multi-dimensional data points is defined as the A-coverage upper bound for the non-outlier multi-dimensional data points in the set M. The outlier multi-dimensional data points, a subset O of M with cardinality |O|, are exactly represented by their metric-data values rather than by a value common to the multi-dimensional data points in a cluster. An optimal clustering involves minimizing one or more parameters associated with clustering, including the parameters Δ, |C|=L, and |O|. For example, one type of optimal clustering involves minimizing |C| for a given upper bound Δ. Another type of optimal clustering involves minimizing |C|+x|O| for a given upper bound Δ, where x is a scalar weighting factor. Another type of optimal clustering involves minimizing the upper bound Δ for a given upper bound on |C|, and still another type of optimal clustering involves minimizing |C|+yNΔ, where y is a scalar weighting factor.

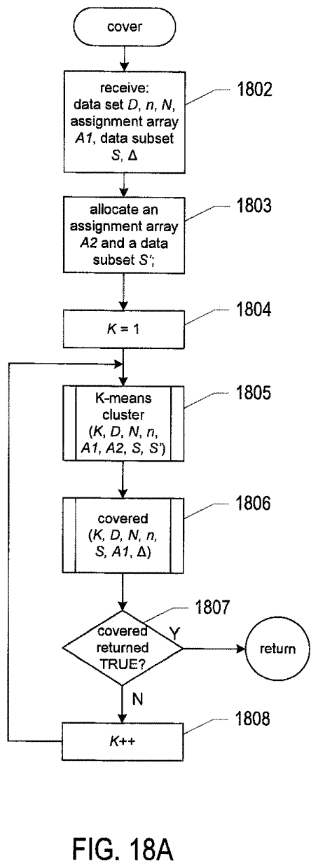

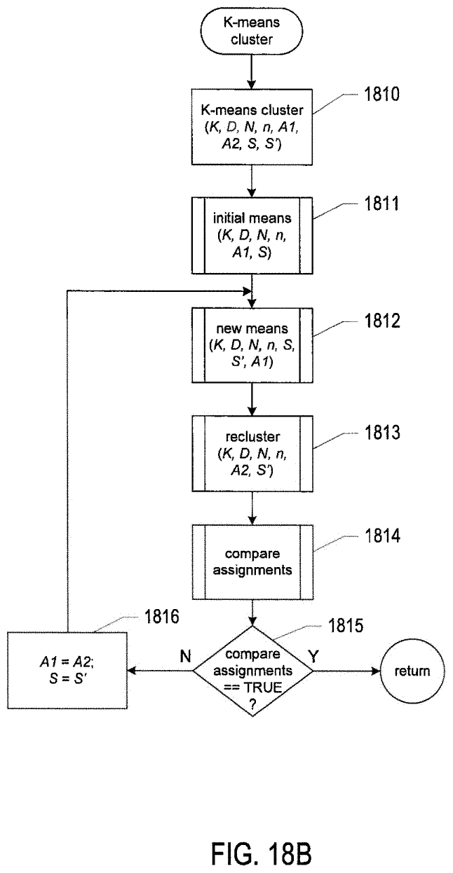

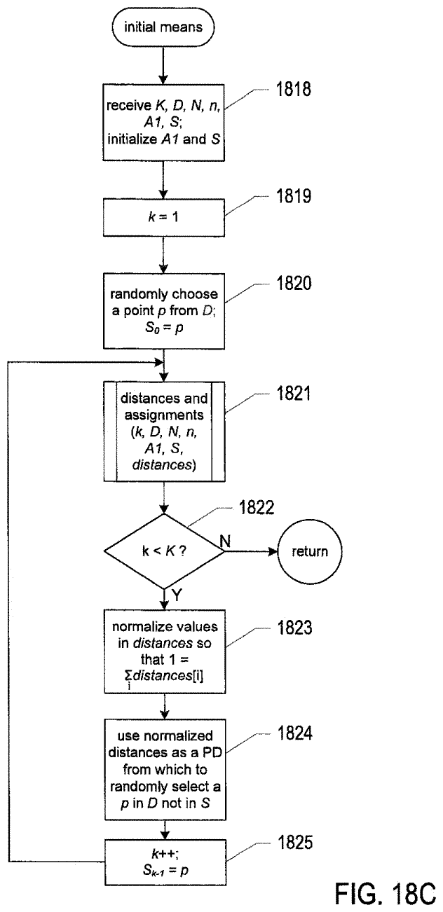

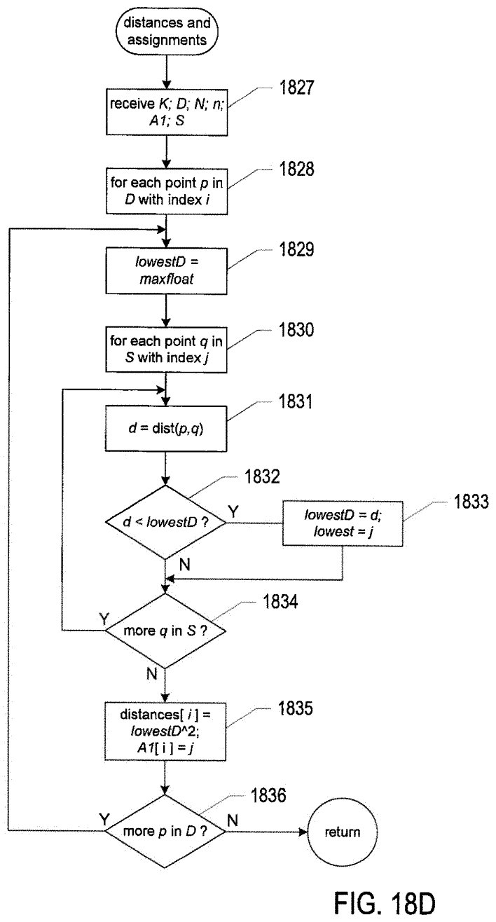

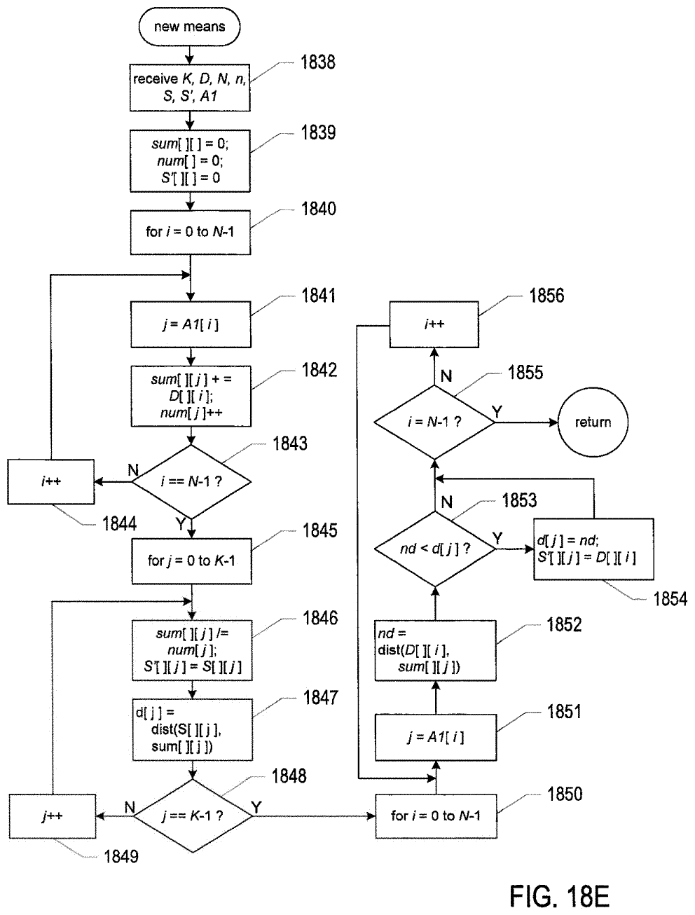

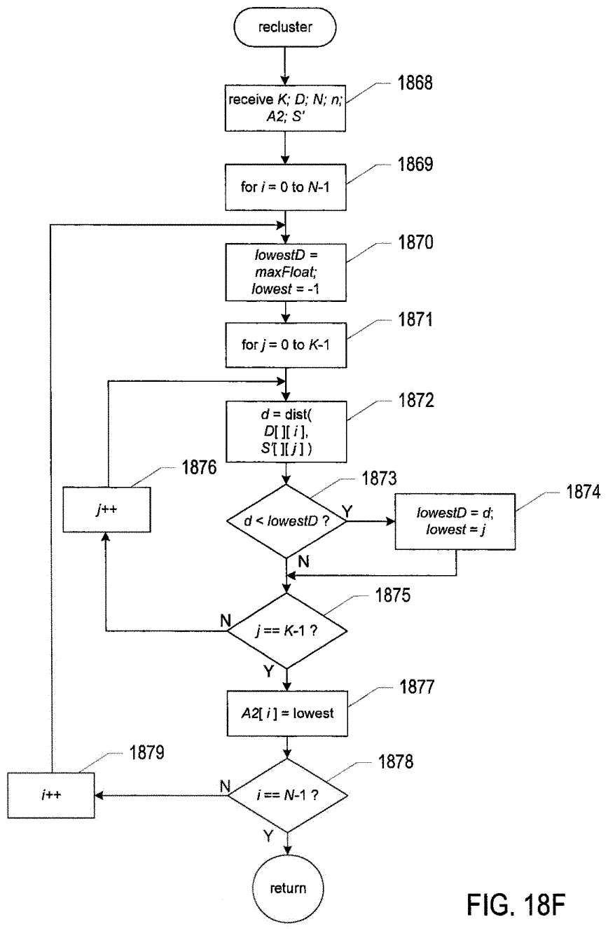

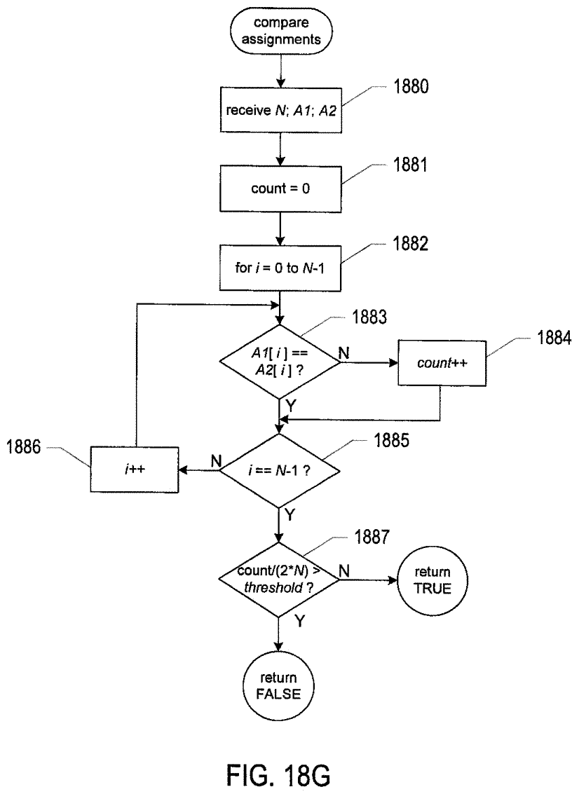

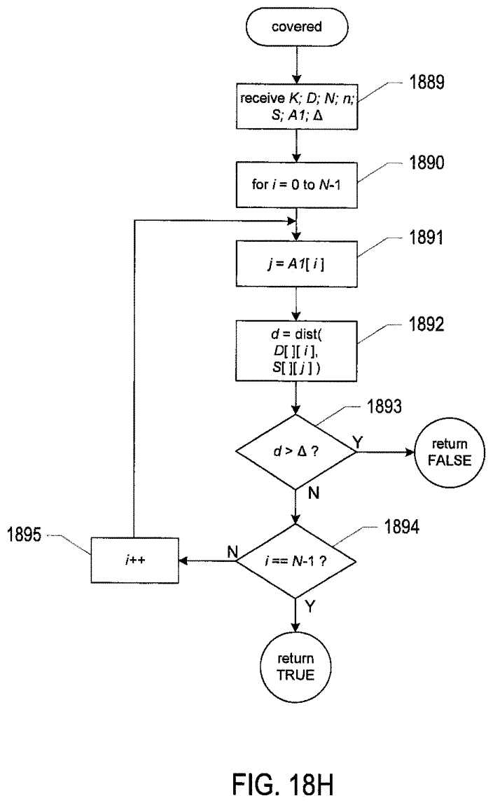

FIGS. 18A-H provide control-flow diagrams that illustrate generation of a covering set for a multidimensional metric-data set. FIG. 18A provides a control-flow diagram for a routine “cover,” which returns the covering set with a minimal number of clusters K. In step 1802, the routine “cover” receives a reference to a multidimensional metric-data set D, a number n of multidimensional data points in in the multidimensional metric-data set D, an assignment array A1 that stores integer identifiers of clusters with which the multidimensional data points are associated when a covering subset of multidimensional data points is determined, a data subset S that stores the multidimensional data points in a covering set determined by the routine “cover,” and the maximum distance Δ of a cluster member from the center of the cluster with which it is associated. In step 1803, the routine “cover” allocates a second assignment array A2 and a second data subset S. In the loop of steps 1804-1808, the routine “cover” iteratively attempts to generate a covering set with increasing numbers of cluster centers, beginning with a single cluster center, until a covering set has been generated. Thus, the number of cluster centers K is initialized to 1 in step 1804 and is incremented, in step 1808, in preparation for each next iteration of the loop. During each iteration of the loop, the routine “cover” first calls the routine “K-means cluster,” in step 1805, and then calls the routine teen “covered,” in step 1806, to determine whether or not the clustering of multidimensional data points with K centers generated by the routine “K-means cluster” represents a covering subset. When a covering subset has been generated, as determined in step 1807, the routine “cover” returns, with the covering subset contained in the data subset argument S and the assignment of multidimensional data points to clusters returned in the assignment array A1. Otherwise, a next iteration of the loop of steps 1804-1808 is carried out. The loop of steps 1804-1808 is guaranteed to terminate, since, eventually, a clustering in which all multidimensional data points in the multidimensional metric-data set are cluster centers will be generated, and that clustering represents a covering subset. Note that, in the control-flow diagrams discussed in the current document, it is assumed that arguments, such as the data subset S and the assignment array A1, that are used to return results to the calling routine, are assumed to be passed by reference, as are arrays and other large data structures.

FIG. 18B provides a control-flow diagram for the routine “K-means cluster,” called in step 1805 of FIG. 18A. In step 1810, the routine “K-means cluster” receives the arguments received by the routine “cover,” in step 1802 of FIG. 18A, as well as references to the additional assignment array A2 and data subset 5′ allocated in step 1803 of FIG. 18A. In step 1811, the routine “K-means cluster” calls a routine “initial means” to select an initial set of K cluster centers from the multidimensional metric-data set. In step 1812, the routine “K-means cluster” calls a routine “new means” to select new cluster centers for the clusters defined by the previous clustering. In step 1813, the routine “K-means cluster” calls a routine “recluster,” in step 1813, in order to carry out a new clustering with respect to the new cluster centers selected in step 1812. In step 1814, the routine “K-means cluster” calls a routine “compare assignments” to compare the previous cluster assignments and the assignments generated following reclustering in order to determine whether the assignments of multidimensional data points to clusters has changed. When the cluster assignments have changed, as determined in step 1815, then, in step 1816, the assignments stored in assignment array A2 are transferred to the array A1 and the data subset stored in data subset are transferred to data subset S in preparation of carrying out a next iteration of steps 1812-1815. The routine “K-means cluster” thus selects an initial set of cluster centers and then iteratively readjusts those centers and reclusters the multidimensional data points until the assignments of the multidimensional data points to clusters do not change.

FIG. 18C provides a control-flow diagram for the routine “initial means,” called in step 1811 of FIG. 18B. In step 1818, the routine “initial means” receives various of the arguments received by the routine “K-means cluster” in step 1810 of FIG. 18B. In step 1819, the local variable k is set to 1. In step 1820, the routine “initial means” randomly chooses a point p from the multidimensional metric-data set D and enters the selected data point p into the data subset S as the first entry in the data subset S. Then, in the loop of steps 1821-1825, the routine “initial means” iteratively selects K−1 additional multidimensional data points as cluster centers. In step 1821, the routine “initial means” calls the routine “distances and assignments” to determine cluster assignments for the multidimensional data points in the multidimensional metric-data set and squared distances from each multidimensional data point to its cluster center. When k is less than K, as determined in step 1822, the squared distances determined in step 1821 are normalized so that the sum of the squared distances for all the multidimensional data points is equal to 1. Then, in step 1824, normalized squared distances are used as a probability distribution in order to randomly select a next point p that is not already in S in accordance with the probabilities associated with the multidimensional data points in the probability distribution. Thus, multidimensional data points at greater distance from the cluster center have a significantly higher probability of being selected as new centers. In step 1825, local variable k is incremented and the randomly selected data point p is added to the subset S.

FIG. 18D provides a control-flow diagram for the routine “distances and assignments,” called in step 1821 of FIG. 18C, In step 1827, various arguments received in step 1818 of FIG. 18C are received by the routine “distances and assignments.” In the outer for-loop of steps 1828-1836, each multidimensional data point p in the multidimensional metric-data set D with index i is processed, where i is the column index when the multidimensional metric-data set is viewed as a 2-dimensional matrix, as discussed above with reference to FIG. 15. In step 1829, the local variable lowestD is set to a large floating-point value. In the inner for-loop of steps 1830-1834, the distance d between point p and each point q in the set S is computed, in step 1831, and when the computed distance is smaller than the value currently stored in the local variable lowestD, as determined in step 1832, lowestD is set to the computed distance and the local variable lowest is set to the index j of the point q in the data subset S. Thus, in the inner for-loop of steps 1830-1834, the smallest distance between the point p and a cluster center is computed. In step 1835, the element in the array distances corresponding to point p is set to the square of the distance lowestD and the element in the assignment array A1 corresponding to point p is set to the index of the center in subset S that is closest to point p. Thus, the routine “distances and assignments” generates values for elements of the array distances containing the squared distance from each multidimensional data point and the center of the cluster to which it belongs and generates values for the assignment array A1 that indicate the cluster assignments of the multidimensional data points.

FIG. 18E shows a control-flow diagram for the routine “new means,” called in step 1812 of FIG. 18B. In step 1838, arguments similar to the arguments received by previously discussed routines are received. In step 1839, a 2-dimensional array sum, a 1-dimensional array num, and the second data subset S′ are initialized to contain all-0 entries. In the for-loop of steps 1840-1844, each multidimensional data point i is considered. In step 1841, the index j of the cluster center for the multidimensional data point is obtained from the assignment array A1. In step 1842, the multidimensional data point is added to a sum of multidimensional data points associated with the cluster and the number of multidimensional data points added to that sum for the cluster center, stored in the array num, is incremented. The sum is carried out for each of the components of the multidimensional data points. Then, in the for-loop of steps 1845-1849, the sum of multidimensional data points for each cluster is divided by the number of multidimensional data points used to compute the sum, in step 1846, and the resulting new cluster center coordinates are stored in the 2-dimensional array sum. Also, the previous cluster center coordinates are copied from data subset S to data subset E in step 1846. The multidimensional data points in data subset S* are initial candidates for new cluster centers. In step 1847, the distance between the new cluster center, coordinates for which are computed in step 1846, and the previous cluster center with index j is computed and stored in the distance array d. Then, in the for-loop of steps 1850-1866, each multidimensional data point i is again considered. In step 1851, the index j of the cluster in which the multidimensional data point resides is obtained from the assignment array A1. In step 1852, the distance nd between the multidimensional data point a and the new cluster center coordinates is computed. When the computed distance is less than the distance to the current cluster-center candidate, as determined in step 1853, the currently considered multidimensional data point i is selected as a new cluster-center candidate, in step 1854. Thus, the routine “new means” computes the centroids for each of the current clusters, in the for-loops of steps 1840-1844 and 1845-1849, and then selects a member of the cluster closest to the centroid as the new center of the cluster, in the for-loop of steps 1850-1866.

FIG. 18F provides a control-flow diagram for the routine “recluster,” called in step 1813 of FIG. 18B. In step 1868, arguments received by previously discussed routines are received by the routine “recluster.” Then, in the for-loop of steps 1869-1879, each multidimensional data point is considered. In step 1870, the local variable lowestD is set to a large number and a local variable lowest is set to the value −1. In the inner for-loop of steps 1871-1876, each cluster center in the data subset S is considered. In step 1872, the distance between the currently considered multidimensional data point and the currently considered cluster center is computed. When the computed distance is lower than the value stored in the local variable lowestD, as determined in step 1873, the local variable lowestD is set to the computed distance and the local variable lowest is set to the index of the currently considered cluster center in step 1874. In step 1877, the element of the assignment array A2 corresponding to the currently considered multidimensional data point is set to the index of the cluster center for the cluster to which the multidimensional data point is now assigned.

FIG. 18G provides a control-flow diagram for the routine “compare assignments,” called in step 1814 of FIG. 18B. In step 1880, the routine “compare assignments” receives the arguments N, the number of multidimensional data points in the multidimensional metric-data set, and A1 and A2, references to the two assignment arrays. In step 1881, the local variable count is set to 0. In the for-loop of steps 1882-1886, the number of entries in the assignment arrays that do not match is counted. When the value stored in count divided by 2 times the number of multidimensional data points exceeds a threshold value, as determined in step 1887, the routine “compare assignments” returns the Boolean value FALSE. Otherwise, the routine “compare assignments” returns the Boolean value TRUE.

FIG. 18H provides a control-flow diagram for the routine “covered,” called in step 1806 of FIG. 18A. In step 1889, the routine “covered” receives various arguments received by previously discussed routines. Then, in the for-loop of steps 1890-1895, the routine “covered” loops are all of the multidimensional data points and computes the distance between each multidimensional data point and its corresponding cluster center. When that distance exceeds the maximum specified distance Δ, as determined in step 1893, the routine “covered” returns false. Otherwise, when all of the multidimensional data points are within the maximum specified distance of their corresponding cluster centers, the routine “covered” returns a true value.

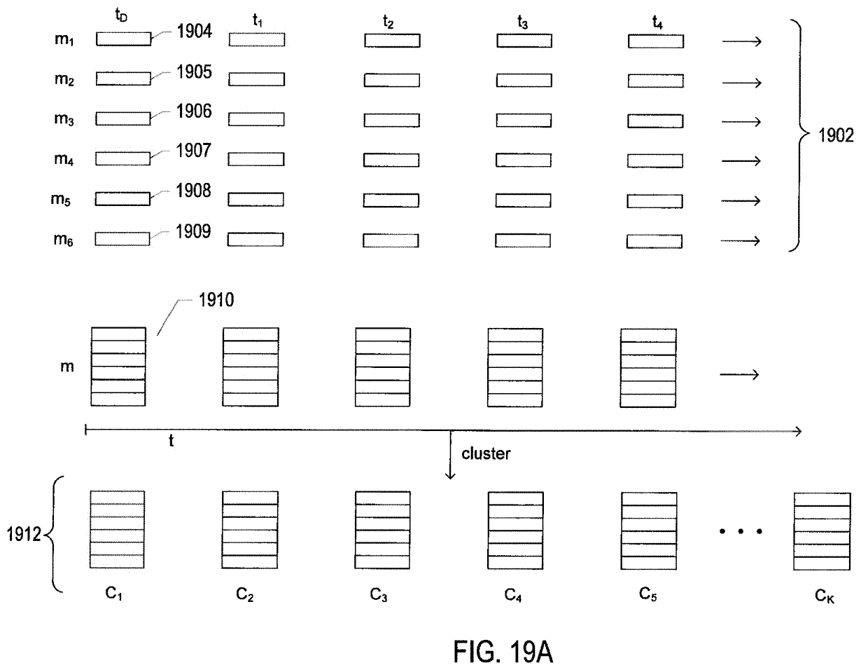

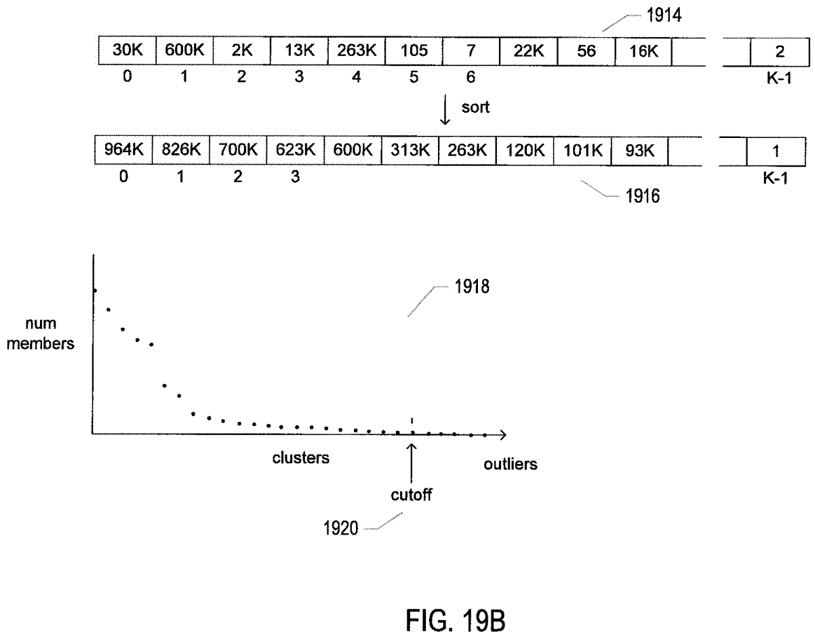

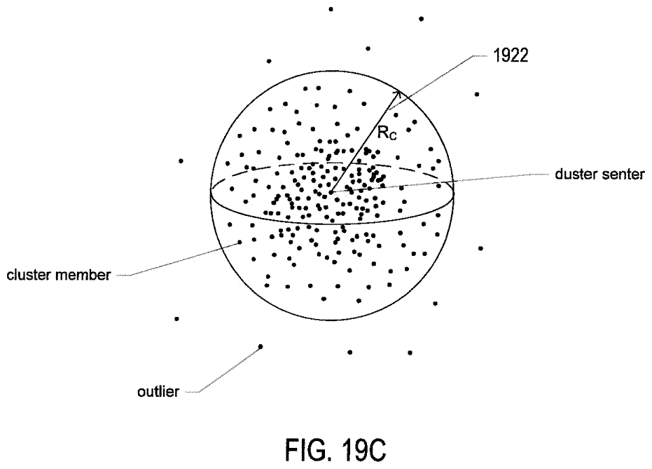

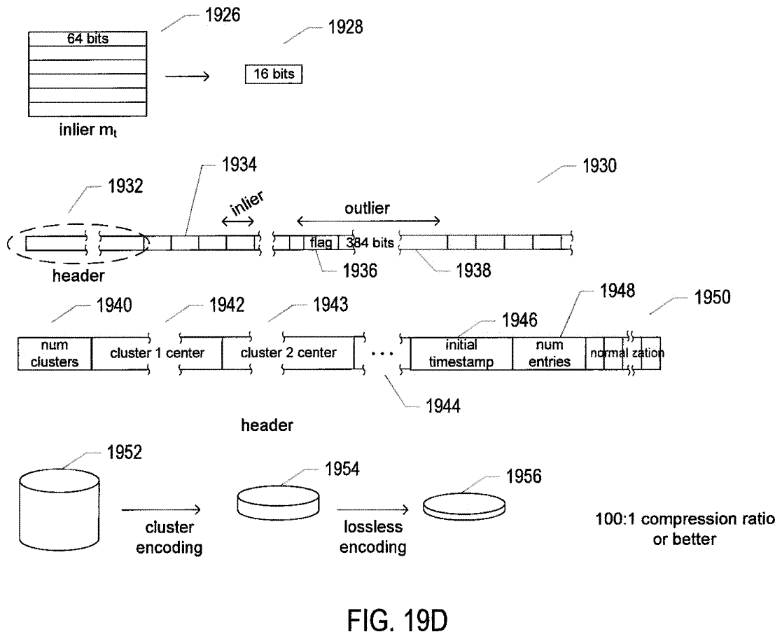

FIGS. 19A-D illustrate the use of a covering set for a multidimensional metric-data set to compress a multidimensional metric-data set for storage within a distributed computing system. As previously discussed with reference to FIGS. 14-15, a set of metric-data sets 1902 is selected for generation of a multidimensional metric-data set. The timestamp/metric-data-value pairs in the set of metric-data sets 1902 may be time shifted, as discussed above, in order to temporarily align the timestamp/metric-data-value pairs. Then, each temporarily aligned column of data values in the set of metric-data sets is considered to be a multidimensional data point in the multidimensional metric-data set. For example, values 1904-1909 together comprise the components of the multidimensional-metric-data-set point or vector 1910. As discussed above with reference to FIGS. 17-18, the multidimensional data points of the multidimensional metric-data set are clustered in order to obtain a set of cluster centers, or covering subset 1912. As shown in FIG. 19B, the number of members of each of the clusters corresponding to the cluster centers in the covering subset is computed and stored in an array 1914 indexed by cluster-center number. This array is then sorted to produce a sorted array 1916. The sorted numbers of cluster members are plotted in plot 1918. A cutoff value 1920 is determined for the number of members of a cluster, with multidimensional data points in any clusters with member numbers lower than the cutoff value considered to be outlier multidimensional data points. In other words, only the cutoff number of clusters are used for data compression. The cutoff number may be determined to coincide with a desired number of bits or bytes needed to encode cluster identifiers, which, in turn, partly determines the cluster-encoding compression ratio. Furthermore, as shown in FIG. 19C, a cluster-volume-specifying radius 1922 different from the parameter Δ may be selected to differentiate outlier multidimensional data points from inlier multidimensional data points. When an approach based on a cluster-volume-specifying radius is used, the values of the cluster-volume-specifying radius and the parameter, may be adjusted to allow a smaller number of clusters to form a covering set for a given multidimensional metric-data set. Consider again the example shown in FIGS. 16F-H. The three data points selected as centers in FIG. 16F do not form a covering set, because data point 1640 is not within a distance \sqrt{12} to any of the three centers. However, by adding a fourth center, data point 1640, as shown in FIG. 16H, a covering set is produced. Alternatively, as shown in FIG. 16G, a covering set is obtained by increasing the value of parameter Δ to \sqrt{13}. Another approach is to expand the cluster-volume radius of the center corresponding to data point 1642 to \sqrt{13}, while leaving the value of parameter Δ and the cluster-volume radii of the other centers at \sqrt{12}. In this approach, the three centers shown in FIG. 16F become a covering set, since data point 1642 is now within the cluster-volume radius of center data point 1642. Cluster-volume-specifying radii may be selected from a plot of the decrease in multidimensional-data-point density with increasing distance from the cluster center or may be based on a threshold percentage of final cluster members to initial cluster members. This approach is particularly useful during continuous compression metric data by metric-data-collection-and-storage applications. Each cluster may be associated with a cluster-specific cluster-volume-specifying radius that can be continuously tuned to adjust the ratio of outliers to inliers.

FIG. 19D illustrates one approach to compressing multidimensional metric data for storage by the metric-data-collection-and-storage applications. An inlier multidimensional data point 1926 generated from n metric-data-set values, initially represented by n 64-bit floating-point values, is more efficiently represented by, for example, a 16-bit integer 1928 that identifies the cluster to which the inlier multidimensional data point belongs. A 16-bit cluster identifier allows for 65,534 clusters as well as null-entry and outlier-flag identifiers, discussed below, for certain cluster-encoding methods. Because the cover set ensures that each member of a cluster is within a specified distance of the cluster center, the distortion produced by representing all the members of the cluster by the central data point of the cluster does not exceed, for each represented multidimensional data point, a distortion corresponding to the maximum specified distance Δ or the cluster-specific radius (1922 in FIG. 19C). Outlier multidimensional data points are represented exactly by n component float values. A file containing compressed multidimensional metric data 1930 includes, in one implementation, a header 1932 followed by integers, such as integer 1934, representing inlier multidimensional data points and representations of outlier multidimensional data points that each includes a flag integer 1936 followed by n 64-bit floating-point values 1938. In one implementation, the header 1932 includes an indication of the number of clusters 1940, the n floating-point-value representations of each cluster center 1942-1943, with the ellipses 1944 indicating additional cluster centers, a timestamp 1946 for the initial multidimensional data point in the encoded multidimensional metric-data set, an indication of the number of multidimensional data points in the multidimensional metric-data set 1948, and one or more normalization factors 1950 when the multidimensional data points are normalized. Thus, the clustering-based representation of inlier multidimensional data points is a lossy compression, referred to as “cluster encoding,” and provides compression ratios on the order of 20:1, depending on the percentage ofoutlier multidimensional data points and the number of clusters. As shown in the lower portion of FIG. 19D, the raw multidimensional metric-data set 1952 is first cluster encoded to produce a cluster-encoded data set 1954. The cluster-encoded data set is further compressed using lossless compression, such as Huffman encoding, run-length encoding, and other types of lossless encoding to produce a final fully compressed multidimensional metric-data set 1956. The overall compression ratio may be 100:1 or better, depending on the distribution of multidimensional metric data, the percentage of outliers, and the particular types of lossless compression employed. In alternative implementations, outlier multidimensional data points may be compressed by using 32-bit component representations rather than 64-bit representations.

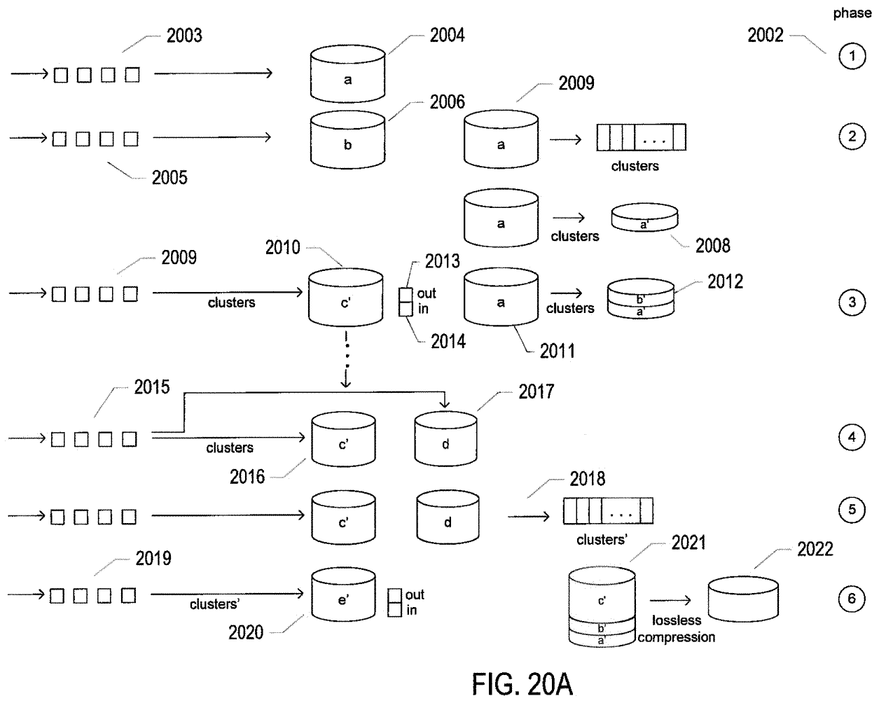

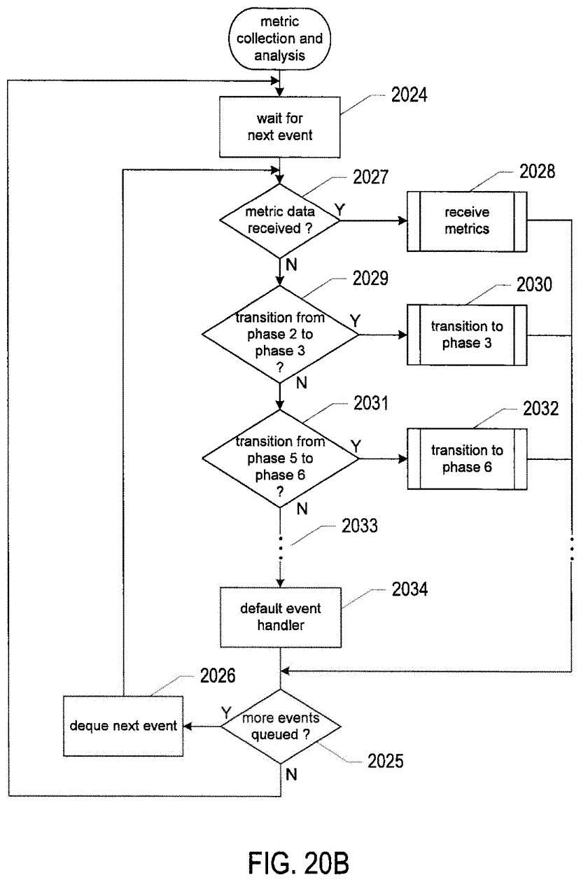

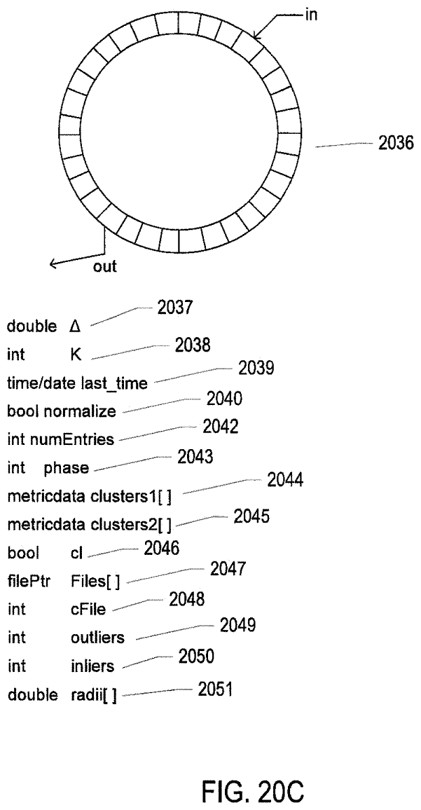

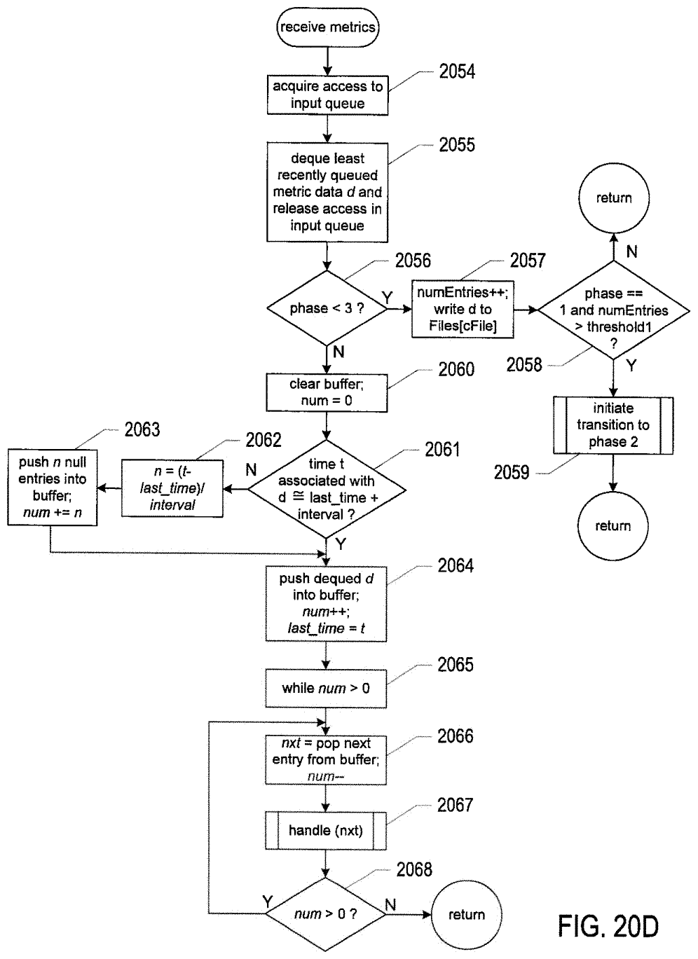

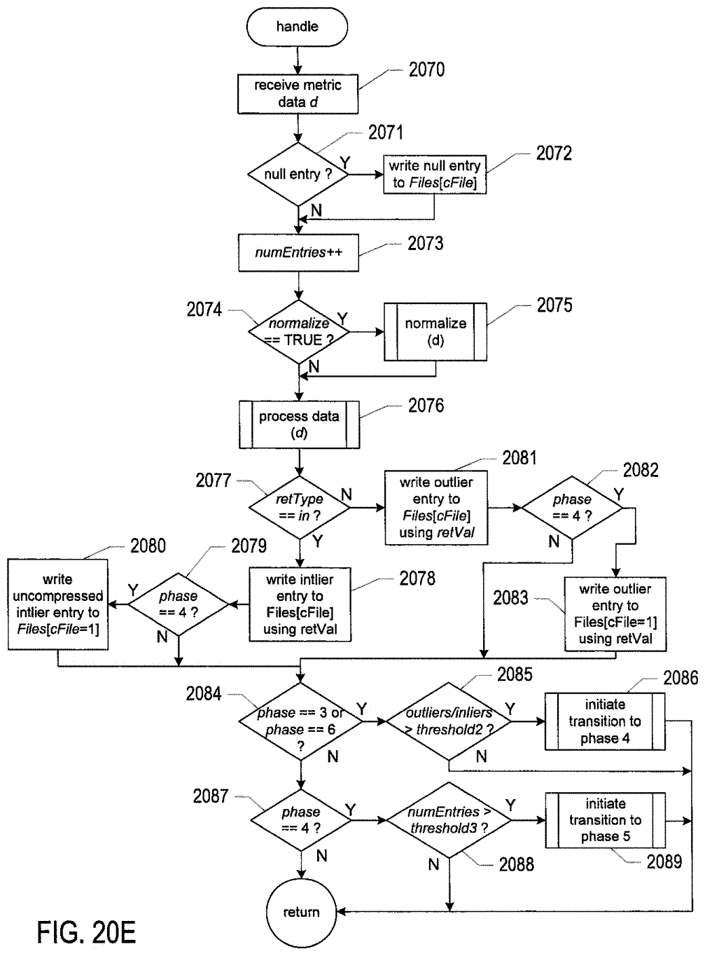

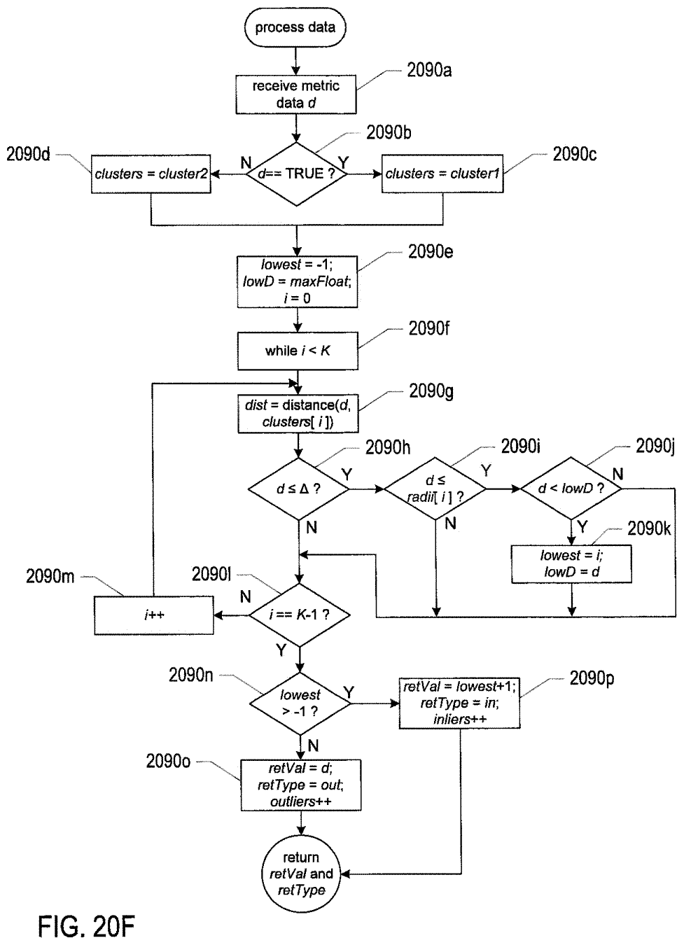

FIGS. 20A-F illustrates one implementation of a metric-data collection-and-storage subsystem within a distributed computing system that collects, compresses, and stores a multidimensional metric-data set for subsequent analysis and use in monitoring, managing, and administrating the distributed computing system. FIG. 20A illustrates, at a high-level, various phases of data collection, compression, and storage for a multidimensional metric-data set. In FIG. 20A, phases are indicated by circled integers at the right-hand edge of the figure, such as the circled integer “1” 2002 indicating the first phase of multidimensional metric-data set collection, compression, and storage. During the first phase, multidimensional data points 2003 are received and stored 2004 without compression. In a second phase, when a sufficient number of multidimensional data points have been collected to undertake generation of covering set, received multidimensional data points 2005 are stored in a second container 2006 while clustering and covering-set generation is carried out on the initially stored multidimensional data points 2007. Once a covering set has been generated, the initially stored multidimensional data points are compressed via clustering to form a cluster-compressed initial set of multidimensional data points 2008. In a third phase, once continuous clustering compression is possible, subsequently received multidimensional data points 2009 are continuously cluster compressed for initial storage 2010 while, concurrently, the remaining uncompressed multidimensional data points 2011 are cluster compressed 2012. During continuous cluster compression, the subsystem keeps track of the number of outlier multidimensional data points 2013 and the number of inlier multidimensional data points 2014. When the ratio of outlier multidimensional data points to inlier multidimensional data points increases above a threshold value, a fourth phase is entered in which subsequently received multidimensional data points 2015 continue to be cluster compressed and stored 2016 but are also stored without compression in a separate container 2017. This dual storage continues until a sufficient number of new multidimensional data points have been received to undertake reclustering, in a fifth phase 2018. Once reclustering is finished, subsequently received multidimensional data points 2019 are cluster compressed according to the new clustering 2020 while all of the multidimensional data points clustered according to the previous clustering 2021 are additionally compressed by a lossless compression method to generate a container 2022 containing fully compressed multidimensional data points. Phase 6 continues until the ratio of outliers to inliers rises above the threshold value, when the subsystem transitions again to phase four. The process produces a series of containers containing fully compressed multidimensional data points for a multidimensional metric-data set. Of course, the process can be concurrently carried out for multiple multidimensional metric-data sets by a data collection, compression, and storage subsystem.

FIG. 20B illustrates an event-handling loop within the metric-data collection-and-storage subsystem. The metric-data collection-and-storage subsystem continuously waits for a next event to occur, in step 2024 and, when a next event occurs, carries out a determination of the event type in order to handle the event. Once the event has been handled, and when there are more events queued for handling, as determined in step 2025, a next event is dequeued, in step 2026, and the event handling process continues. Otherwise, control flows to step 2024 where the metric-data collection-and-storage subsystem waits for a next event. When the currently considered event is a metric-data-received event, as determined in step 2027, a “receive metrics” handler is called, in step 2028, to handle reception of the metric data. When the next occurring event is a phase-2-to-phase-3 transition event, as determined in step 2029, then a “transition to phase 3” handler is called, in step 2030. When the currently considered event is a transition-from-phase-5-to-phase-6 event, as determined in step 2031, a “transition to phase 6” handler is called, in step 2032. Ellipses 2033 indicate that many different additional types of events are handled by the event loop illustrated in FIG. 20B. A default handler 2034 handles rare and unexpected events.

FIG. 20C illustrates various variables and data structures employed in the subsequently described implementation of the “receive metrics” handler called in step 2028 of FIG. 20B. Received metric data is initially stored in a circular buffer 2036 within the metric-data collection-and-storage subsystem, and a “metric data received” event is generated when new metric data is queued to the queue. In this implementation, any temporal aligning of metric-data sets and combining of metric-data sets is carried out at a lower level, prior to queuing of metric data to the input queue. The variable Δ2037 stores the maximum distance of a cluster member to a cluster center, discussed above. The variable K 2038 stores the number of clusters and cluster centers of a covering set. The variable last_time 2039 indicates the timestamp of the last received multidimensional metric data point. The variable normalized 2040 indicates whether or not normalization is being carried out on the multidimensional metric data points. The variable numEntries 2042 indicates the number of entries or multidimensional data points that have been received for compression and storage. The variable phase 2043 indicates the current phase of metric-data reception, compression, and storage, discussed above with reference to FIG. 20A. The arrays clusters1 and clusters2 2044-2045 contain the cluster centers for two different clusterings. The variable cl 2046 indicates which of the two arrays clusters1 and clusters2 is currently being used. The array Files 2047 contains file pointers for various containers currently being used to store uncompressed, cluster compressed, and fully compressed multidimensional metric data points. The integer cFile 2048 is an index into files array. The integers outliers 2049 and inliers 2050 store the number of outliers and inliers that have been received during streaming compression. The array radii 2051 stores the cluster-specific radius for each cluster.

FIG. 20D provides a control-flow diagram for the handler “receive metrics,” called in step 2028 of FIG. 20B. In step 2054, the handler “receive metrics” acquires access to the input queue (2036 in FIG. 20C). This may involve a semaphore operation or other such operation that provides exclusive access to the input queue pointers. In step 2055, the routine “receive metrics” dequeues the least recently queued metric data d from the input queue and releases access to the input queue to enable subsequently received metric data to be queued to the input queue. When the current phase is phase 1 or phase 2, as determined in step 2056, then, in step 2057, the number of entries is incremented and the received metric data d is written, without compression, to a current container (2004 in FIG. 20A). Then, when the current phase is phase 1 and the number of entries has increased above a threshold value, as determined in step 2058, a call is made, in step 2059, to an “initiate transition to phase 2” routine which undertakes a concurrent clustering and cluster compression of the initially stored metric data, as discussed above with reference to FIG. 20A. Otherwise, a local buffer is cleared and a local variable num is set to 0, in step 2060. When the timestamp associated with the received metric data d is not equal to the timestamp associated with the previously received metric data, as determined in step 2061, a number of null entries indicating missing metric data at the intervening intervals is pushed into the local buffer in steps 2062 and 2063. In step 2064, the currently received metric data d is pushed into the buffer, the local variable num is incremented, and the variable last_time is set to the time associated with the current metric data. Then, in the while-loop of steps 2065-2068, the local variable next is set to the next entry in the local buffer and the local variable num is decremented, in step 2066 following which the dequeued entry is handled by a call to the routine “handle,” in step 2067.

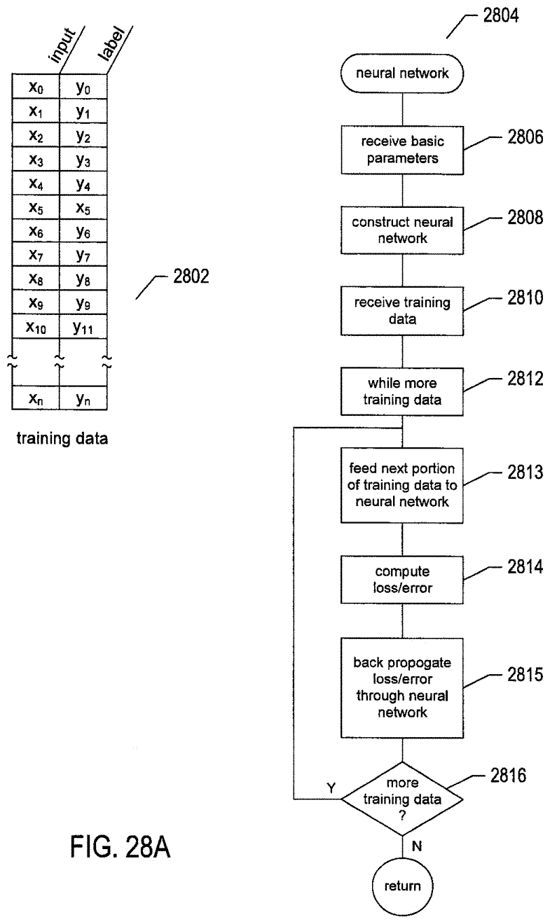

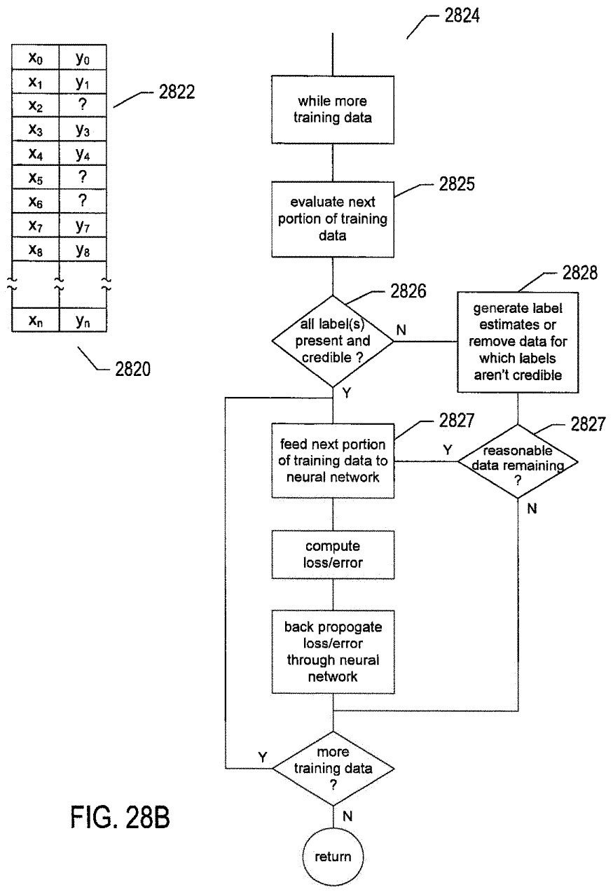

FIG. 20B provides a control-flow diagram for the routine “handle,” called in step 2067 of FIG. 20D. In step 2070, the routine “handle” received an entry from the local buffer popped in step 2066 of FIG. 20D. When the received entry is a null entry, as determined in step 2071, a null entry is written to the current container in step 2072. In step 2073, the variable numEntries is incremented. When normalization is being carried out, as determined in step 2074, a routine “normalize” is called, in step 2075, to normalize the data, as discussed above with reference to FIGS. 14-15. In step 2076, a routine “process data” is called in order to characterize the metric data d as an inlier or outlier and to compress the metric data in the case that it represents an inlier. When the metric data is an inlier, as determined in step 2077, then an inlier entry is written to the current container, in step 2078. When the current phase is phase 4, as determined in step 2079, an uncompressed inlier entry is written to a container receiving uncompressed data (2017 in FIG. 28) in step 2080. Otherwise, when the received metric data is an outlier, an outlier entry is written to the current container in step 2081 and, when the current phase is phase 4, as determined in step 2082, an outlier entry is additionally written to the additional container step 2083. When the current phase is either phase 3 or phase 6, as determined in step 2084, and when the ratio of outliers to inliers exceeds a threshold value, as determined in step 2085, a routine “initiate transition to phase 4” is called, in step 2086, to initiate storage of both compressed and uncompressed data, as discussed above with reference to FIG. 20A. Similarly, when the current phase is phase 4, as determined in step 2087, and when the number of entries is greater than a threshold value, as determined in step 2088, a routine “initiate transition to phase 5” is called, in step 2089, to initiate reclustering and lossless compression, as discussed above with reference to FIG. 20A. The routines “initiate transition to phase 4” and “initiate transition to phase 5” update various variables, including numEntries, outliers, inliers, Files, and cFile, as needed.

FIG. 20F provides a control-flow diagram for the routine “process data,” called in step 2076 of FIG. 20E. In step 2090a, the routine “process data” receives a multidimensional data point, or metric data d. In steps 2090b-d, the local reference variable clusters is set to reference the cluster-center array currently storing the cluster centers used for cluster compression. In step 2090e, a local variable lowest is set to −1, a local variable lowD is set to a large floating-point value, and the loop variable i is set to 0. In the while-loop of steps 2090f-m, the distance between the currently handled multidimensional data point and the center of each cluster center is determined so that the currently considered multidimensional data point can be assigned to the cluster corresponding to the closest cluster center to the currently considered multidimensional data point. When there is no cluster to which the currently considered multidimensional data point can be assigned, as determined in step 2090n, the return value is set to the uncompressed multidimensional data point, the return type is set to out, and the variable outliers is incremented, in step 2090p. Otherwise, in step 2090p, the return value is set to the integer identifier for the cluster to which the multidimensional data point belongs, the return type is set in, and the variable inliers is incremented.

### Neural Networks

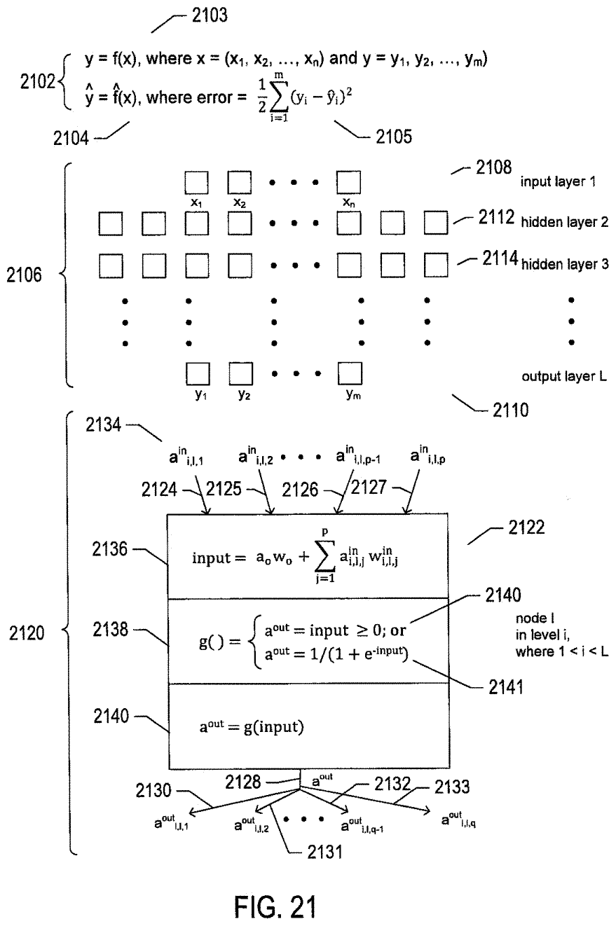

FIG. 21 illustrates the fundamental components of a feed-forward neural network. Equations 2102 mathematically represents ideal operation of a neural network as a function ƒ(x). The function receives an input vector x and outputs a corresponding output vector y 2103. For example, an input vector may be a digital image represented by a 2-dimensional array of pixel values in an electronic document or may be an ordered set of numeric or alphanumeric values. Similarly, the output vector may be, for example, an altered digital image, an ordered set of one or more numeric or alphanumeric values, an electronic document, one or more numeric values. The initial expression 2103 represents the ideal operation of the neural network. In other words, the output vectors y represent the ideal, or desired, output for corresponding input vector x. However, in actual operation, a physically implemented neural network \hat{ƒ}(x), as represented by expressions 2104, returns a physically generated output vector ŷ that may differ from the ideal or desired output vector y. As shown in the second expression 2105 within expressions 2104, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional sealing, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 2106 of FIG. 21, a feed-forward neural network generally consists of layers of nodes, including an input layer 2108, and output layer 2110, and one or more hidden layers 2112 and 2114. These layers can be numerically labeled 1, 2, 3, . . . , L, as shown in FIG. 21. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 21 (2120 in FIG. 21) illustrates a feed-forward neural-network node. The neural-network node 2122 receives inputs 2124-2127 from one or more next-higher-level nodes and generates an output 2128 that is distributed to one or more next-lower-level nodes 2130-2133. The inputs and outputs are referred to as “activations,” represented by superscripted-and-subscripted symbols “a” in FIG. 21, such as the activation symbol 2134. An input component 2136 within a node collects the input activations and generates a weighted sum of these input activations to which a weighted internal activation a_{D} is added. An activation component 2138 within the node is represented by a function go, referred to as an “activation function,” that is used in an output component 2140 of the node to generate the output activation of the node based on the input collected by the input component 2136. The neural-network node 2122 represents a generic hidden-layer node. Input-layer nodes lack the input component 2136 and each receive a single input value representing an element of an input vector. Output-component nodes output a single value representing an element of the output vector. The values of the weights used to generate the cumulative input by the input component 2136 are determined by training, as previously mentioned. In general, the input, outputs, and activation function are predetermined and constant, although, in certain types of neural networks, these may also be at least partly adjustable parameters. In FIG. 21, two different possible activation functions are indicated by expressions 2140 and 2141. The latter expression represents a sigmoidal relationship between input and output that is commonly used in neural networks and other types of machine-learning systems.

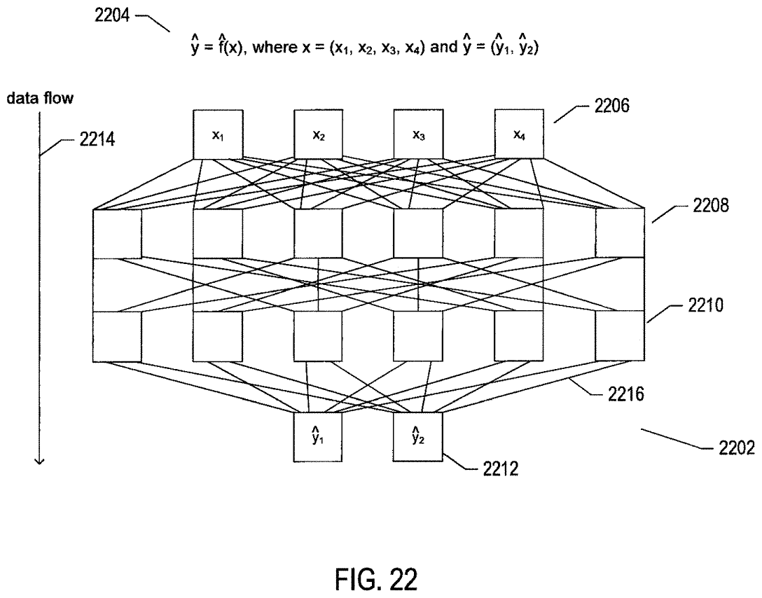

FIG. 22 illustrates a small, example feed-forward neural network. The example neural network 2202 is mathematically represented by expression 2204. It includes an input layer of four nodes 2206, a first hidden layer 2208 of six nodes, a second hidden layer 2210 of six nodes, and an output layer 2212 of two nodes. As indicated by directed arrow 2214, data input to the input-layer nodes 2206 flows downward through the neural network to produce the final values output by the output nodes in the output layer 2212. The line segments, such as line segment 2216, interconnecting the nodes in the neural network 2202 indicate communications paths along which activations are transmitted from higher-level nodes to lower-level nodes. In the example feed-forward neural network, the nodes of the input layer 2206 are fully connected to the nodes of the first hidden layer 2208, but the nodes of the first hidden layer 2208 are only sparsely connected with the nodes of the second hidden layer 2210. Various different types of neural networks may use different numbers of layers, different numbers of nodes in each of the layers, and different patterns of connections between the nodes of each layer to the nodes in preceding and succeeding layers.

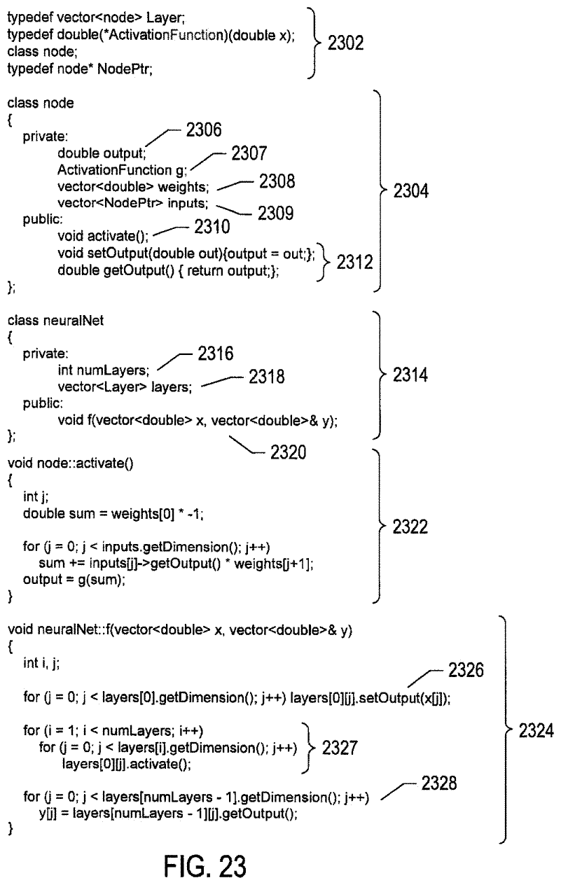

FIG. 23 provides a concise pseudocode illustration of the implementation of a simple feed-forward neural network. Three initial type definitions 2302 provide types for layers of nodes, pointers to activation functions, and pointers to nodes. The class node 2304 represents a neural-network node. Each node includes the following data members: (1) output 2306, the output activation value for the node; (2) g 2307, a pointer to the activation function for the node; (3) weights 2308, the weights associated with the inputs; and (4) inputs 2309, pointers to the higher-level nodes from which the node receives activations. Each node provides an activate member function 2310 that generates the activation for the node, which is stored in the data member output, and a pair of member functions 2312 for setting and getting the value stored in the data member output. The class neuralNet 2314 represents an entire neural network. The neural network includes data members that store the number of layers 2316 and a vector of node-vector layers 2318, each node-vector layer representing a layer of nodes within the neural network. The single member function ƒ 2320 of the class neuralNet generates an output vector y for an input vector x. An implementation of the member function activate for the node class is next provided 2322. This corresponds to the expression shown for the input component 2136 in FIG. 21. Finally, an implementation for the member function ƒ 2324 of the neuralNet class is provided. In a first for-loop 2326, an element of the input vector is input to each of the input-layer nodes. In a pair of nested for-loops 2327, the activate function for each hidden-layer and output-layer node in the neural network is called, starting from the highest hidden layer and proceeding layer-by-layer to the output layer. In a final for-loop 2328, the activation values of the output-layer nodes are collected into the output vector y.

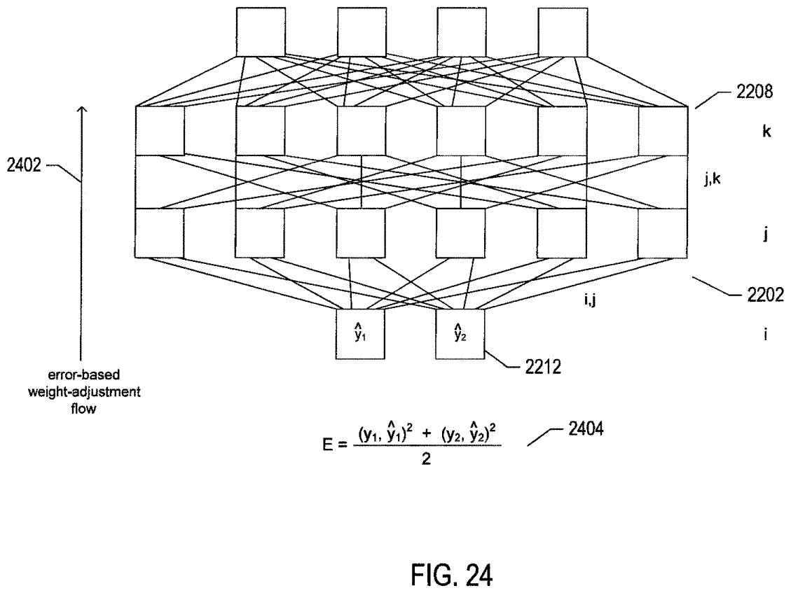

FIG. 24, using the same illustration conventions as used in FIG. 22, illustrates back propagation of errors through the neural network during training. As indicated by directed arrow 2402, the error-based weight adjustment flows upward from the output-layer nodes 2212 to the highest-level hidden-layer nodes 2208. For the example neural network 2202, the error, or loss, is computed according to expression 2404. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

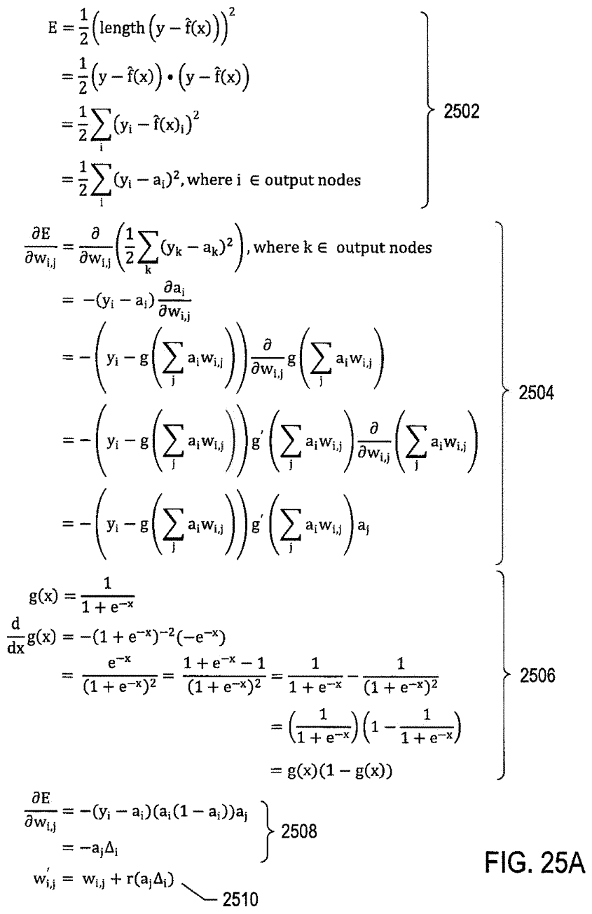

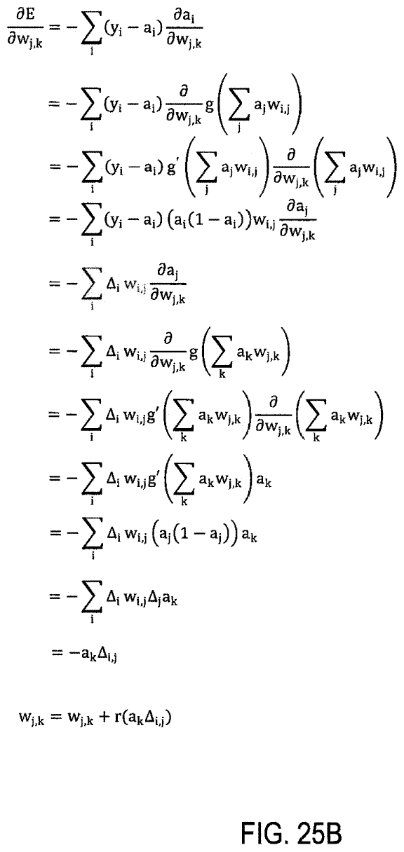

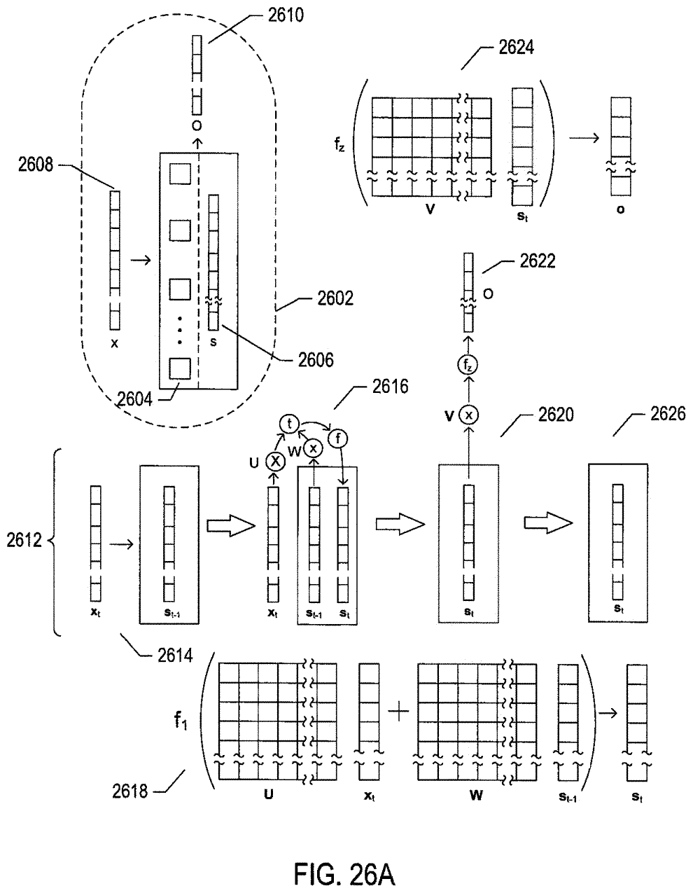

FIGS. 25A-B show the details of the weight-adjustment calculations carried out during back propagation. An expression for the total error, or loss, E with respect to an input-vector/label pair within a training dataset is obtained in a first set of expressions 2502, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 2504. In these expressions, the partial differential operator is propagated rightward through the expression for the total error E. An expression for the derivative of the activation function with respect to the input x produced by the input component of a node is obtained by the set of expressions 2506. This allows for generation of a simplified expression for the partial derivative of the total energy E with respect to the weight associated with the j^{th} input of the i^{th} output node 2508. The weight adjustment based on the total error E is provided by expression 2510, in which r has a real value in the range [0-1] that represents a learning rate, aⱼ is the activation received through input j by node i, and Δᵢ is the product of parenthesized terms, which include aᵢ and yᵢ, in the first expression in expressions 2508 that multiplies aⱼ. FIG. 25B provides a derivation of the weight adjustment for the hidden-layer nodes above the output layer. It should be noted that the computational overhead for calculating the weights for each next highest layer of nodes increases geometrically, as indicated by the increasing number of subscripts for the Δ multipliers in the weight-adjustment expressions.

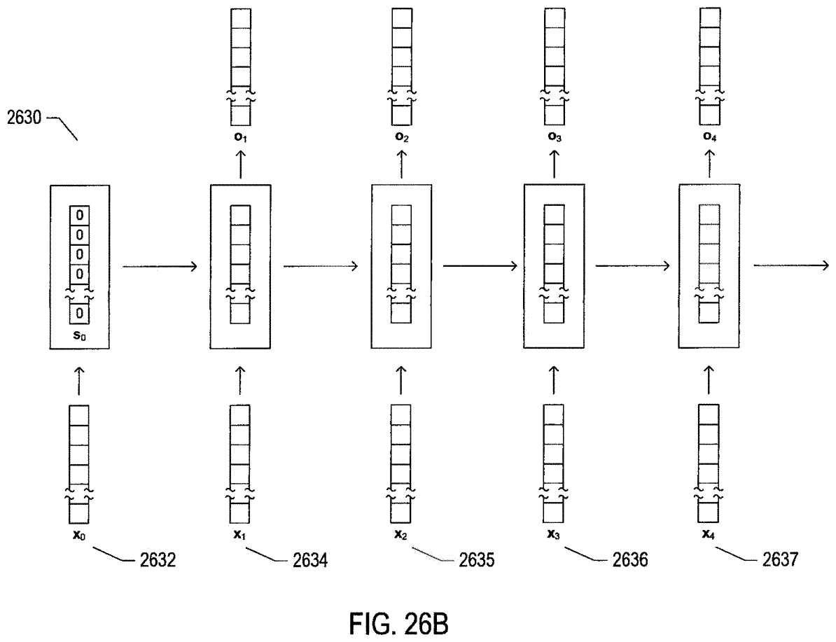

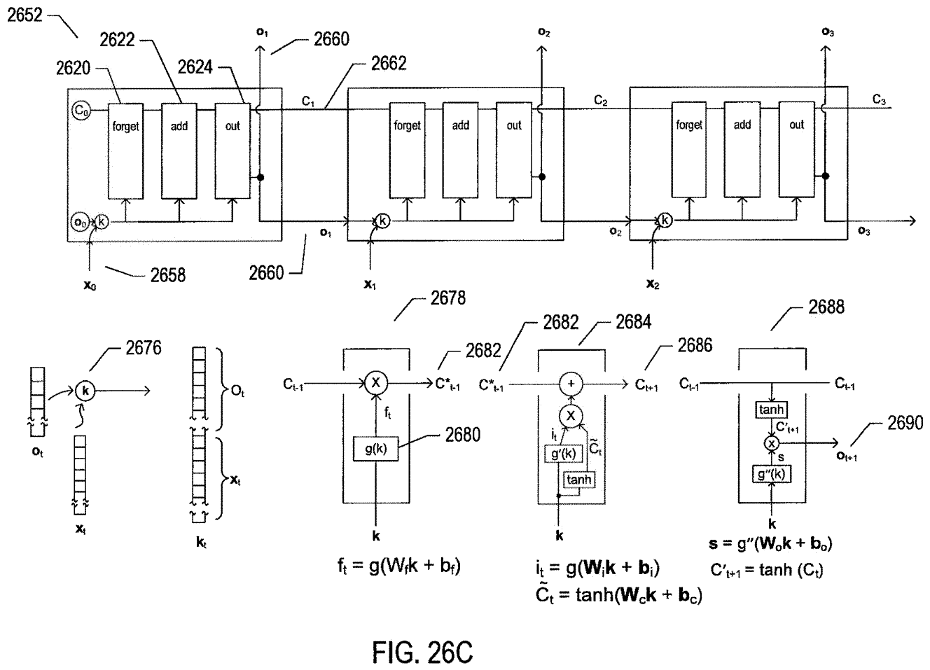

A second type of neural network, referred to as a “recurrent neural network,” is employed to generate sequences of output vectors from sequences of input vectors. These types of neural networks are often used for natural-language applications in which a sequence of words forming a sentence are sequentially processed to produce a translation of the sentence, as one example. FIGS. 26A-B illustrate various aspects of recurrent neural networks. Inset 2602 in FIG. 26A shows a representation of a set of nodes within a recurrent neural network. The set of nodes includes nodes that are implemented similarly to those discussed above with respect to the feed-forward neural network 2604, but additionally include an internal state 2606. In other words, the nodes of a recurrent neural network include a memory component. The set of recurrent-neural-network nodes, at a particular time point in a sequence of time points, receives an input vector x 2608 and produces an output vector 2610. The process of receiving an input vector and producing an output vector is shown in the horizontal set of recurrent-neural-network-nodes diagrams interleaved with large arrows 2612 in FIG. 26A. In a first step 2614, the input vector x at time t is input to the set of recurrent-neural-network nodes which include an internal state generated at time t−1. In a second step 2616, the input vector is multiplied by a set of weights U and the current state vector is multiplied by a set of weights W to produce two vector products which are added together to generate the state vector for time t. This operation is illustrated as a vector function ƒ₁ 2618 in the lower portion of FIG. 26A. In a next step 2620, the current state vector is multiplied by a set of weights V to produce the output vector for time t 2622, a process illustrated as a vector function ƒ₂ 2624 in FIG. 26A. Finally, the recurrent-neural-network nodes are ready for input of a next input vector at time t+1, in step 2626.

FIG. 26B illustrates processing by the set of recurrent-neural-network nodes of a series of input vectors to produce a series of output vectors. At a first time t₀ 2630, a first input vector x₀ 2632 is input to the set of recurrent-neural-network nodes. At each successive time point 2634-2637, a next input vector is input to the set of recurrent-neural-network nodes and an output vector is generated by the set of recurrent-neural-network nodes. In many cases, only a subset of the output vectors are used. Back propagation of the error or loss during training of a recurrent neural network is similar to back propagation for a feed-forward neural network, except that the total error or loss needs to be back-propagated through time in addition to through the nodes of the recurrent neural network. This can be accomplished by unrolling the recurrent neural network to generate a sequence of component neural networks and by then back-propagating the error or loss through this sequence of component neural networks from the most recent time to the most distant time period.

Finally, for completeness, FIG. 26C illustrates a type of recurrent-neural-network node referred to as a long-short-term-memory (“LSTM”) node. In FIG. 26C, a LSTM node 2652 is shown at three successive points in time 2654-2656. State vectors and output vectors appear to be passed between different nodes, but these horizontal connections instead illustrate the fact that the output vector and state vector are stored within the LSTM node at one point in time for use at the next point in time. At each time point, the LSTM node receives an input vector 2658 and outputs an output vector 2660. In addition, the LSTM node outputs a current state 2662 forward in time. The LSTM node includes a forget module 2670, an add module 2672, and an out module 2674. Operations of these modules are shown in the lower portion of FIG. 26C. First, the output vector produced at the previous time point and the input vector received at a current time point are concatenated to produce a vector k 2676. The forget module 2678 computes a set of multipliers 2680 that are used to element-by-element multiply the state from time t−1 in order to produce an altered state 2682. This allows the forget module to delete or diminish certain elements of the state vector. The add module 2134 employs an activation function to generate a new state 2686 from the altered state 2682. Finally, the out module 2688 applies an activation function to generate an output vector 2140 based on the new state and the vector k. An LSTM node, unlike the recurrent-neural-network node illustrated in FIG. 26A, can selectively alter the internal state to reinforce certain components of the state and deemphasize or forget other components of the state in a manner reminiscent of human short-term memory. As one example, when processing a paragraph of text, the LSTM node may reinforce certain components of the state vector in response to receiving new input related to previous input but may diminish components of the state vector when the new input is unrelated to the previous input, which allows the LSTM to adjust its context to emphasize inputs close in time and to slowly diminish the effects of inputs that are not reinforced by subsequent inputs. Here again, back propagation of a total error or loss is employed to adjust the various weights used by the LSTM, but the back propagation is significantly more complicated than that for the simpler recurrent neural-network nodes discussed with reference to FIG. 26A.

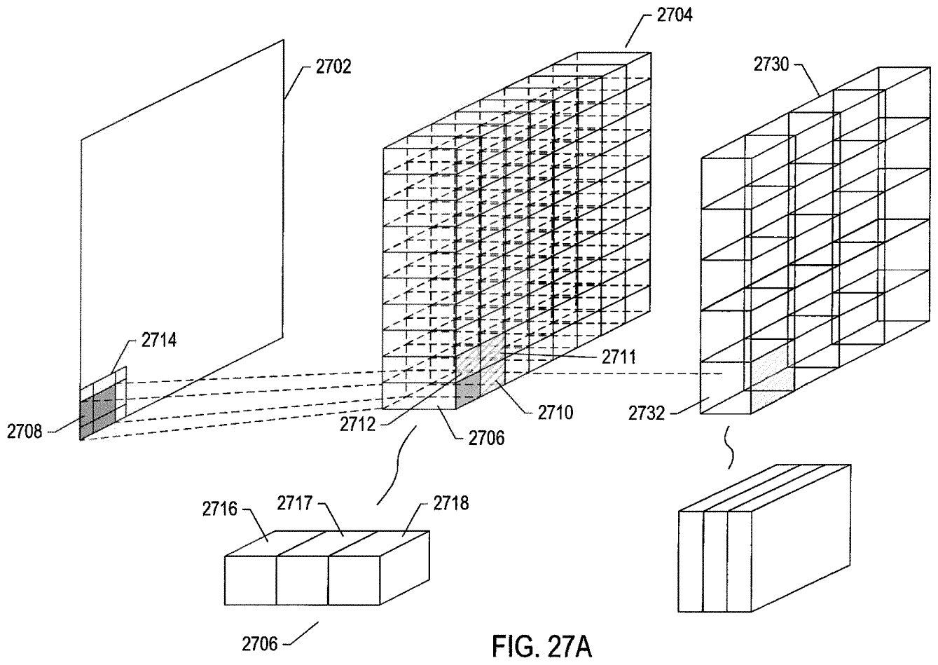

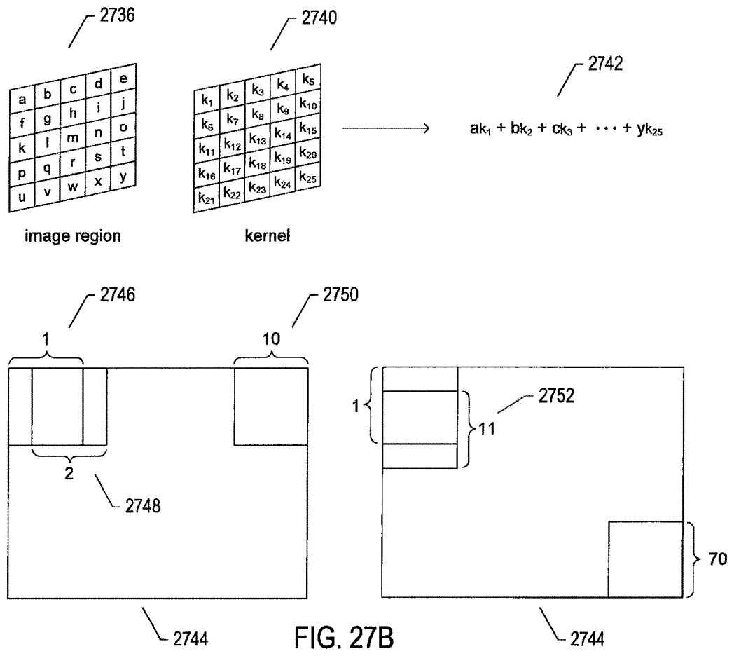

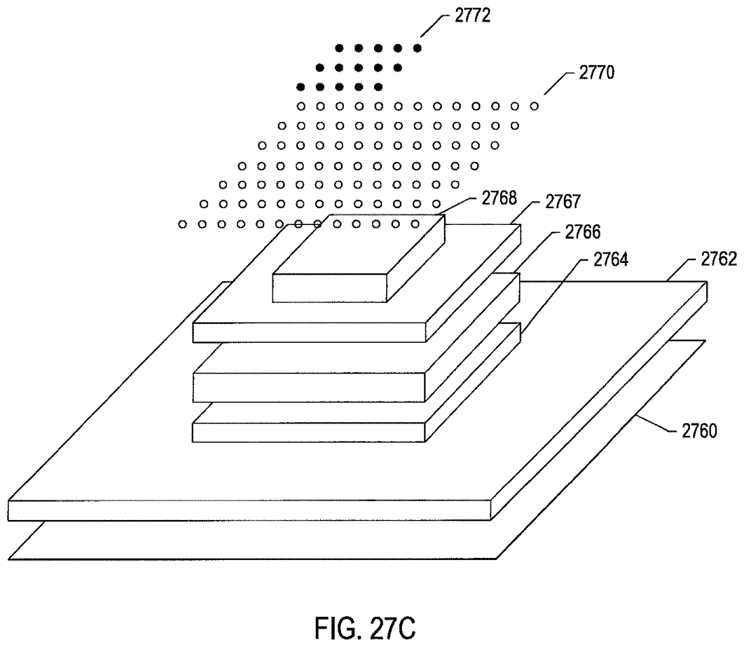

FIGS. 27A-C illustrate a convolutional neural network. Convolutional neural networks are currently used for image processing, voice recognition, and many other types of machine-learning tasks for which traditional neural networks are impractical. In FIG. 27A, a digitally encoded screen-capture image 2702 represents the input data for a convolutional neural network. A first level of convolutional-neural-network nodes 2704 each process a small subregion of the image. The subregions processed by adjacent nodes overlap. For example, the corner node 2706 processes the shaded subregion 2708 of the input image. The set of four nodes 2706 and 2710-2712 together process a larger subregion 2714 of the input image. Each node may include multiple subnodes. For example, as shown in FIG. 27A, node 2706 includes 3 subnodes 2716-2718. The subnodes within a node all process the same region of the input image, but each subnode may differently process that region to produce different output values. Each type of subnode in each node in the initial layer of nodes 2704 uses a common kernel or filter for subregion processing, as discussed further below. The values in the kernel or filter are the parameters, or weights, that are adjusted during training. However, since all the nodes in the initial layer use the same three subnode kernels or filters, the initial node layer is associated with only a comparatively small number of adjustable parameters. Furthermore, the processing associated with each kernel or filter is more or less translationally invariant, so that a particular feature recognized by a particular type of subnode kernel is recognized anywhere within the input image that the feature occurs. This type of organization mimics the organization of biological image-processing systems. A second layer of nodes 2730 may operate as aggregators, each producing an output value that represents the output of some function of the corresponding output values of multiple nodes in the first node layer 2704. For example, second-layer node 2732 receives, as input, the output from four first-layer nodes 2706 and 2710-2712 and produces an aggregate output. As with the first-level nodes, the second-level nodes also contain subnodes, with each second-level subnode producing an aggregate output value from outputs of multiple corresponding first-level subnodes.

FIG. 27B illustrates the kernel-based or filter-based processing carried out by a convolutional neural network node. A small subregion of the input image 2736 is shown aligned with a kernel or filter 2740 of a subnode of a first-layer node that processes the image subregion. Each pixel or cell in the image subregion 2736 is associated with a pixel value. Each corresponding cell in the kernel is associated with a kernel value, or weight. The processing operation essentially amounts to computation of a dot product 2742 of the image subregion and the kernel, when both are viewed as vectors. As discussed with reference to FIG. 27A, the nodes of the first level process different, overlapping subregions of the input image, with these overlapping subregions essentially tiling the input image. For example, given an input image represented by rectangles 2744, a first node processes a first subregion 2746, a second node may process the overlapping, right-shifted subregion 2748, and successive nodes may process successively right-shifted subregions in the image up through a tenth subregion 2750. Then, a next down-shifted set of subregions, beginning with an eleventh subregion 2752, may be processed by a next row of nodes.

FIG. 27C illustrates the many possible layers within the convolutional neural network. The convolutional neural network may include an initial set of input nodes 2760, a first convolutional node layer 2762, such as the first layer of nodes 2704 shown in FIG. 27A, and aggregation layer 2764, in which each node processes the outputs for multiple nodes in the convolutional node layer 2762, and additional types of layers 2766-2768 that include additional convolutional, aggregation, and other types of layers. Eventually, the subnodes in a final intermediate layer 2768 are expanded into a node layer 2770 that forms the basis of a traditional, fully connected neural-network portion with multiple node levels of decreasing size that terminate with an output-node level 2772.

FIGS. 28A-B illustrate neural-network training as an example of machine-learning-based-subsystem training. FIG. 28A illustrates the construction and training of a neural network using a complete and accurate training dataset. The training dataset is shown as a table of input-vector/label pairs 2802, in which each row represents an input-vector/label pair. The control-flow diagram 2804 illustrates construction and training of a neural network using the training dataset. In step 2806, basic parameters for the neural network are received, such as the number of layers, number of nodes in each layer, node interconnections, and activation functions. In step 2808, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 2810, training data represented by table 2802 is received. Then, in the while-loop of steps 2812-2816, portions of the training data are iteratively input to the neural network, in step 2813, the loss or error is computed, in step 2814, and the computed loss or error is back-propagated through the neural network step 2815 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 28B illustrates one method of training a neural network using an incomplete training dataset. Table 2820 represents the incomplete training dataset. For certain of the input-vector/label pairs, the label is represented by a “?” symbol, such as in the input-vector/label pair 2822. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 2824 illustrates alterations in the while-loop of steps 2812-2816 in FIG. 28A that might be employed to train the neural network using the incomplete training dataset. In step 2825, a next portion of the training dataset is evaluated to determine the status of the labels in the next portion of the training data. When all of the labels are present and credible, as determined in step 2826, the next portion of the training dataset is input to the neural network, in step 2827, as in FIG. 28A. However, when certain labels are missing or lack credibility, as determined in step 2826, the input-vector/label pairs that include those labels are removed or altered to include better estimates of the label values, in step 2828. When there is reasonable training data remaining in the training-data portion following step 2828, as determined in step 2829, the remaining reasonable data is input to the neural network in step 2827. The remaining steps in the while-loop are equivalent to those in the control-flow diagram shown in FIG. 28A. Thus, in this approach, either suspect data is removed, or better labels are estimated, based on various criteria, for substitution for the suspect labels.

### Currently Disclosed Methods and System that Continuously Optimize Sampling Rates for Metric Data

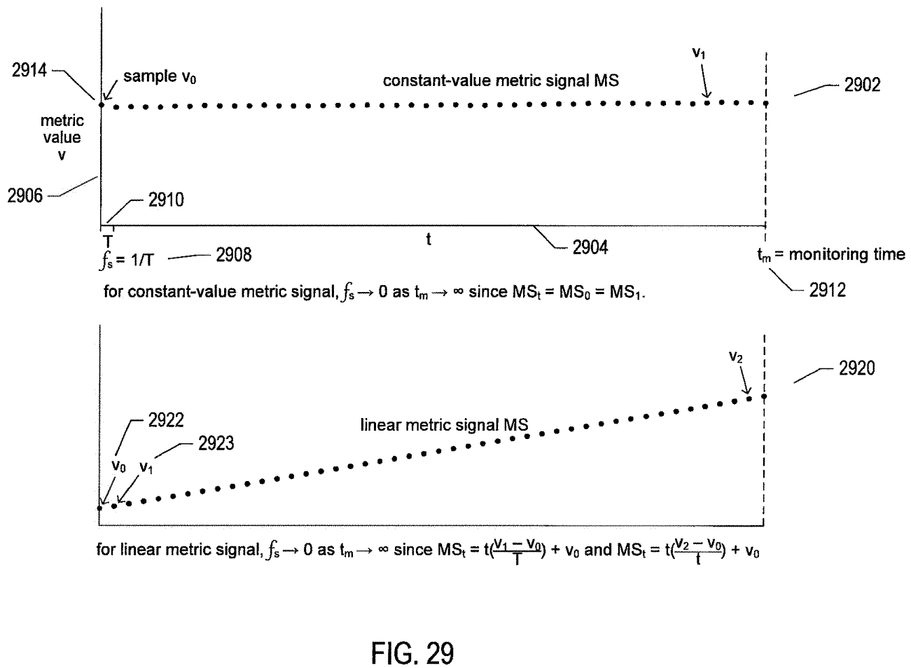

FIG. 29 illustrates several examples of fully predictable metric-data sequences or streams. Plot 2902 shows a constant-value metric-data sequence or stream consisting of an ordered sequence of data points, each associated with a metric value and a timestamp, with the horizontal axis 2906 corresponding to time and the vertical axis 2906 corresponding to the metric value. The metric data is sampled at a sampling rate ƒₛ equal to 172908, where T is the time interval 2910 between successive data points. Plot 2902 shows the sample data points over a total monitoring time of tₘ 2912. Because the metric-data sequence is constant valued, only a single sample of the metric-data sequence 2914 is needed to fully characterize the metric-data sequence and to accurately reconstruct it. Therefore, as the length, in time units, of the monitoring time interval increases, the sampling rate needed to fully preserve the information content of the metric-data sequence decreases towards 0. Similarly, as shown in plot 2920, for a metric-data sequence that linearly increases over time, only two sample points 2922-2923 are needed, since all other data-point values can be computed from the expression for the inclined line segment corresponding to the metric-data-sequence that is fully determined from two sample points. Here again, the sampling rate needed to fully preserve the information content of the metric-data sequence decreases towards 0 as the length, in time units, of the monitoring time interval increases. Thus, when the time dependence of the values of a metric-data sequence is known beforehand, only a few samples of the metric-data sequence are needed to fully characterize the metric-data sequence.

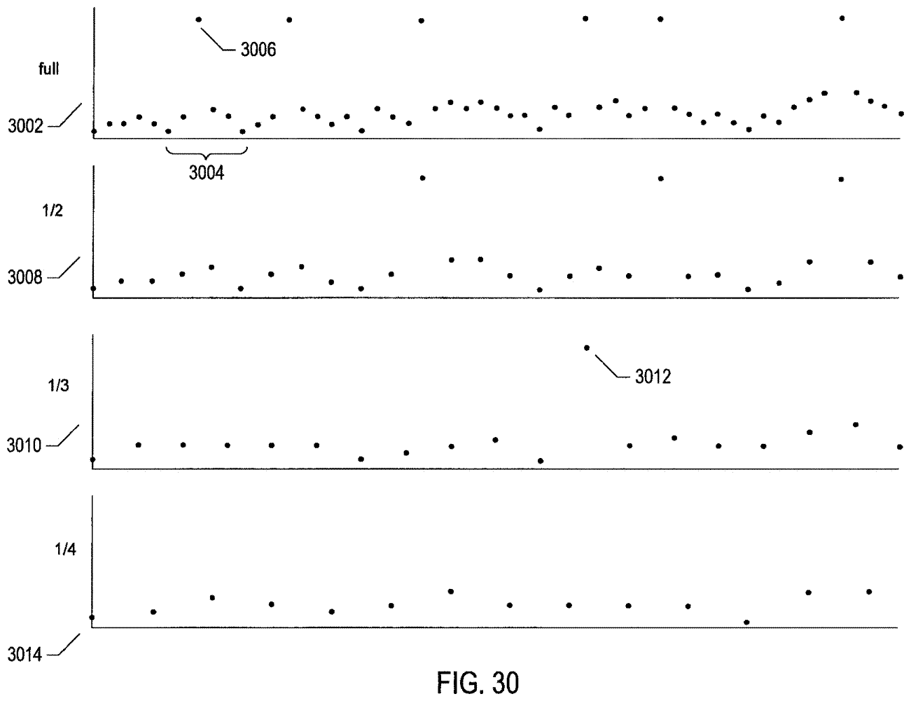

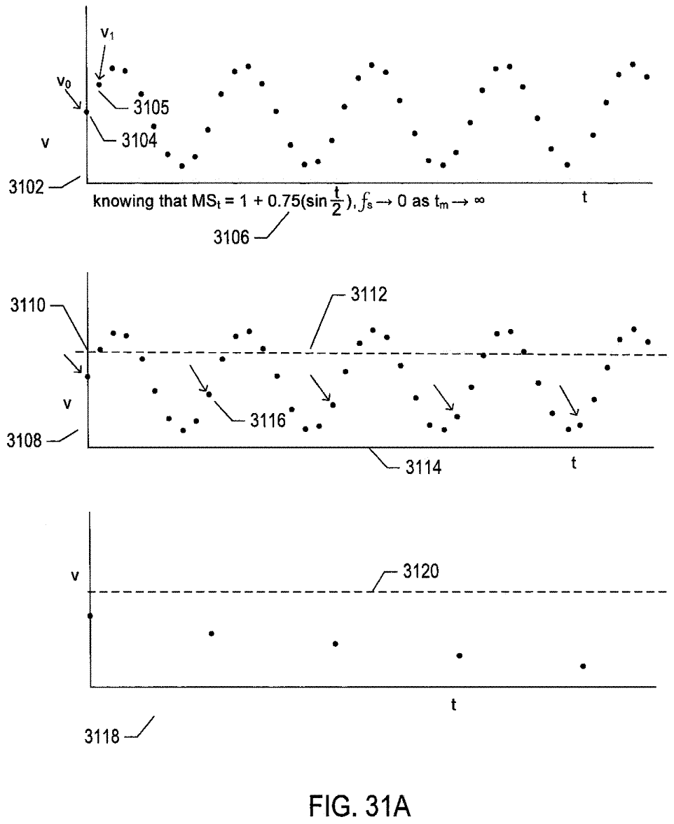

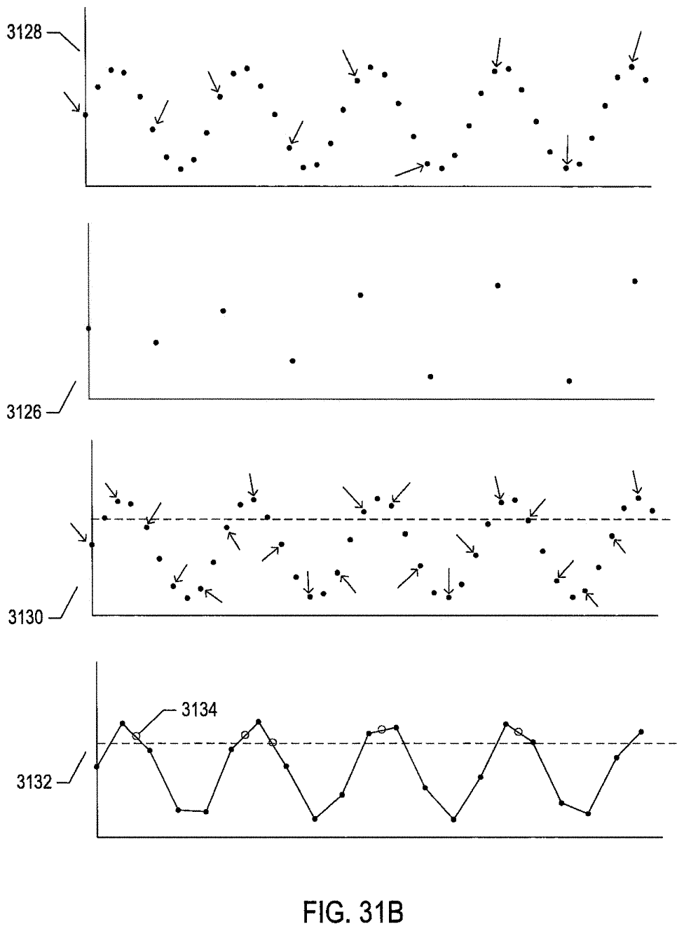

FIG. 30 illustrates the effect of different sampling rates on the information content of a sampled metric-data sequence. All of the plots shown in FIG. 30 and in FIGS. 31A-B, which follow, use the same plotting conventions as used in FIG. 29, discussed above. Plot 3002 shows the data points of an unpredictable metric-data sequence sampled at a relatively high frequency. In general, the data points have values that appear to oscillate, in time, such as the data points in the time interval 3004, which form a single oscillation period. However, the oscillation time periods have different lengths, in time units, and, at unpredictable points in time, various outlier data points, such as data point 3006, are observed. Plot 3008 shows a sampling of the data points of the metric-data sequence plotted in plot 3002 at a sampling rate equal to ½ the sampling rate used to generate plot 3002. While there are 6 outlier data points in plot 3002, there are only 3 outlier data points in plot 3008. Plot 3010 shows a sampling of the data points of the metric-data sequence plotted in plot 3002 at a sampling rate equal to ⅓ the sampling rate used to generate plot 3002. In this case, only one outlier data point 3012 is observed. Plot 3014 shows a sampling of the data points of the metric-data sequence plotted in plot 3002 at a sampling rate equal to 114 the sampling rate used to generate plot 3002. In this case, no outlier data points are observed. Suppose that an outlier-per-time metric is derived from the metric-data sequence from which the plots shown in FIG. 30 are generated, with the time interval of the plots corresponding to the unit of time for the outlier-per-time metric. In this case, the outlier-per-time metric decreases from 6 to 0 as the sampling rate decreases from the original sampling rate used to generate plot 3002 to a final sampling rate equal to ¼ of the original sampling rate. Were the temporal distribution of outlier data points known, in advance, then, of course, no sampling would be necessary. But since that distribution is not known in advance, in order to generate the derived outlier-per-time metric, some threshold sampling rate would be needed to generate a reliable indication of the presence of outliers from which an estimated outlier-occurrence frequency could be computed. In the example shown in FIG. 30, a sampling rate of ¼ of the original sampling rate is clearly insufficient. A sampling rate of ⅓ of the original sampling rate is also clearly insufficient, since an estimation generated by multiplying the number of observed sampling rates by the inverse of the sampling rate,

$$\frac{3}{1} \cdot 1 = 3 ,$$

is significantly below the outlier-occurrence frequency observed in plot 3002. By contrast, a sampling rate of ½ of the original sampling is sufficient, since an estimation generated by multiplying the number of observed sampling rates by the inverse of the sampling rate,

$$\frac{2}{1} \cdot 3 = 6 ,$$

is equal to the outlier-occurrence frequency observed in plot 3002.

FIGS. 31A-B illustrate sampling-rate information loss for fully predictable metric-data sequences. A sinusoidal metric-data sequence is shown in plot 3102. This metric-data sequence could be fully characterized using just two sample points 3104-3105 and knowledge of the form of expression 3106, and like the metric-data sequences plotted in FIG. 29, the sampling rate needed for fully characterizing the metric-data sequence decreases towards 0 as the monitoring time increases. As shown in plot 3108, a derived outlier-frequency metric might be computed by counting the number of data points above a threshold metric value 3110, plotted as a dashed line 3112 parallel to the horizontal axis 3114. For the original sampling of the metric-dated sequence, plotted in plot 3108, slightly more than 1:4 of the metric data points are outliers. However, consider a sampling rate of ⅛ of the original sampling rate, as indicated by the data points associated with arrows, such as data point 3116, and plotted in plot 3118. In this case, the metric-data sequence appears to be a smoothly decreasing sequence and none of the data points are above the outlier threshold 3120. Clearly, a sampling rate of ⅛ of the original sampling rate would be insufficient to estimate a value for the outlier-frequency metric. In FIG. 31B, a sampling rate of ⅕ of the original sampling rate for the metric-data sequence shown in plot 3102 of FIG. 31A is plotted in plot 3126, with the original metric-data sequence and indications of the sample points shown in plot 3128. In this case, the sample points appear to describe an increasingly large oscillation of metric values over time. Were the pattern in plot 3126 to continue, eventually ½ of the data points would be outliers. Plot 3130 again shows the metric-data sequence at the original sampling rate with indications of the data points selected by a sampling rate of ½ of the original sampling rate, which are plotted in plot 3132. In this case, the sampling rate of ½ of the original sampling rate appears to be sufficient to provide a reasonable estimation of the actual outlier frequency. A crude estimation can be obtained by connecting the plotted data points of the straight-line segments, and then estimating the metric value for arbitrary sample times using the curve produced by connecting the plotted data points. In plot 3132, circles, such as circle 3134, indicate the estimated positions of the unsampled original data points. The number of outliers in plot 3130 is 15 while the number of outliers estimated from the ½ sampling rate plotted in plot 3132 is 12. Thus, even in the case of a completely predictable function of metric values with time, when the metric-data sequence is not known to be predictable, different sampling rates may provide very different pictures of the dependence of the metric value on time and can be associated with dramatic information loss.

For actual metric-data streams generated within distributed computer systems and processed by the methods and systems disclosed in this document, the relationship between sampling rate and information loss may be far more complex, but the basic principles illustrated in FIGS. 29-31B are generally observed. Certain of the metric-data streams may be either constant or sufficiently predictable that the sampling rate is of little concern. For many other metric-data streams, with complex, unpredictable dependencies between metric value and time, decreasing the sampling frequency below a metric-data-stream-dependent threshold value can result in a sufficiently large information loss to prevent a reasonable estimation of characteristics of the dependency of metric values with time.

As discussed above, in a preceding subsection of this document, systems that collect, store, and analyze metric data need to use various methods for compressing the amount of metric data that is accumulated, over time, for many reasons. There may be a practical maximum sampling rate for each metric-data stream above which the performance of a distributed computer system would be too severely impacted by increasing the sampling rate. These impacts arise from the required mass-storage capacities needed to store the metric data, required network bandwidths for transferring metric data from the components in which it is generated to the collection, storage, and analysis components, the processing bandwidth needed for controlling transmission and storage of the metric data as well as for eventually processing the metric data during downstream analysis, and the rate at which the metric data is generated. However, were the metric-data collection, storage, and analysis system to uniformly sample metric-data streams at the maximum practical rate, far greater data-transmission, data-storage, and data-processing overheads would be incurred than actually necessary for distributed computer system and distributed-computer-system component monitoring. A very effective, improved method for compressing the amount of collected metric data is to continuously optimize the sampling rates for the many different metric-data streams in order to sample each metric-data stream at a minimum rate, or frequency, that preserves sufficient information contained within the metric-data streams needed for downstream analysis. By continuously optimizing the sampling rates, a very effective, early-stage compression of the volume of collected metric data is obtained, and this compression compounds the compression rates achieved in later stages of the metric-dated collection and storage process, discussed above in the preceding subsection of this document, to produce an improved, more efficient metric-data collection, storage, and analysis system.

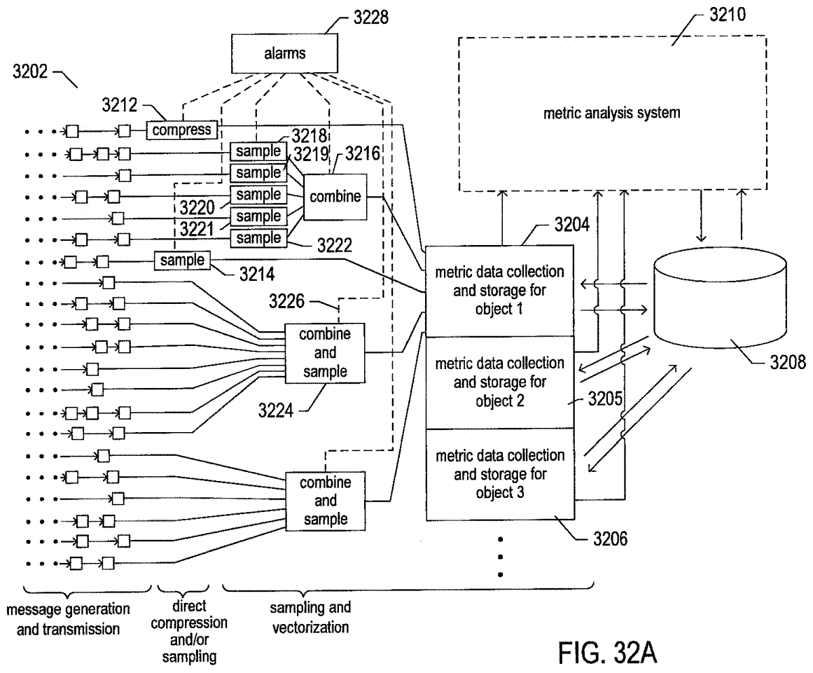

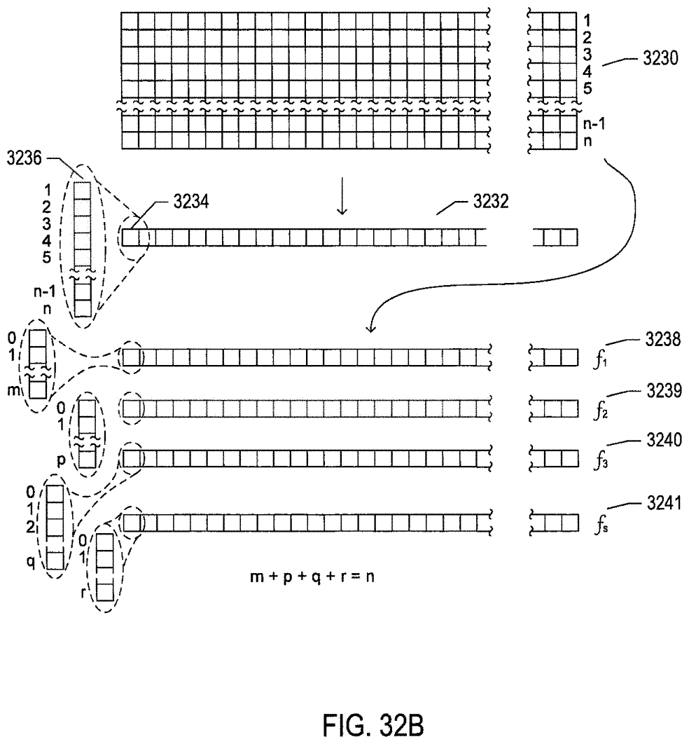

FIGS. 32A-B illustrate the sampling-rate optimization components included in one implementation of a metric-data collection, storage, and analysis system. FIG. 32A can be compared with FIG. 13, discussed above in a preceding subsection of this document. As in FIG. 13, the left-hand column 3202 of FIG. 32A shows multiple different metric-data streams input to a metric-data collection, storage, and analysis system. However, in FIG. 32A, the metric-data streams are input to various different simple-compression, simple-sampling, and metric-data-stream sampling/aggregation components, which output sampled and/or aggregated metric-data streams to metric-data collection-and-storage components 3204-3206 responsible for storing metric data in data-storage components 3208 and preparing metric data for downstream analysis by a metric-data-analysis system 3210. Each metric-data collection-and-storage component is responsible for collecting and storing metric data from multiple metric-data streams related to a particular component or set of components of the distributed computer system. As one example, a metric-data collection-and-storage component may aggregate, collect, and store metric data for a particular distributed application or for a particular server cluster. The metric-data-stream sampling/aggregation components may be hierarchically organized so that, for example, a first level of metric-data-stream sampling/aggregation components may each receive multiple individual, sample and aggregate the multiple individual streams to produce a sampled, multidimensional output metric-data stream that is input to one or more higher-level metric-data-stream sampling/aggregation components that each samples and aggregates multiple multidimensional metric data streams to produce a higher dimensional output metric data stream. The metric-data collection-and-storage components 3204-3206 are, in the illustrated implementation, the top-level metric-data-stream sampling/aggregation components of the hierarchy. Any of many different sampling layers consisting of many different types and organizations of metric-data-stream sampling/aggregation components and different numbers of hierarchical levels can be constructed to create a sampling/aggregation layer within a metric-data collection, storage, and analysis system.

For certain types of metric-data streams, simple direct compression 3212 can be carried out to generate a corresponding low-frequency stream of derived-metric data. As one example, if a derived metric reports the number of outlier occurrences within a relatively long monitoring interval, a simple direct compression component may accumulate the number of outliers over the monitoring interval and output a single metric-data message for each monitoring interval. A simple sampling component 3214 may sample an individual metric-data stream and output sampled metric-data stream to a higher level sampling/aggregation component. Another type of sampling/aggregation component 3216 may receive sampled metric-data streams from multiple simple sampling components 3218-3222 with coordinated sampling rates and output a corresponding multidimensional metric-data stream. Yet another type of sampling/aggregation component 3224 may receive multiple individual metric-data streams, combine them to produce a multidimensional metric-data stream, and then sample the multidimensional metric-data stream. Other types of sampling/aggregation components are possible. In certain cases, sampling rates are determined locally by sampling/aggregation components, in other cases sampling rates are fed back from higher-level components to sampling/aggregation components, and in yet other cases, sampling rates may be determined both from local information and from external sampling-rate information by sampling/aggregation components. In the illustrated implementation, as indicated by dashed alarm-signal paths such as alarm-signal path 3226, sampling/aggregation components may provide immediate alarm-based notifications for particular metric values received in metric-data streams, to provide immediate notification via an alarm component 3228 to the metric analysis system 3210. The phrase “sampling/aggregation component” is used to refer to even those sampling components that receive only a single metric-data stream and therefore do not aggregate multiple input-metric-data streams into a sampled, output metric-data stream, since these simple sampling components share most of their architectural features and logic with sampling/aggregation components that do aggregate multiple input-metric-data streams into a sampled, output metric-data stream.

FIG. 32B emphasizes the fact that a multidimensional metric-data stream can be viewed in different ways. An n-dimensional metric-data stream 3230 can be considered to be a vector valued metric-data stream 3232 in which each element, such as element 3234, is a vector 3236 of dimension n. Alternatively, the n-dimensional metric-data stream 3230 can be considered to be a number of lower-dimensional vector-valued metric-data streams 3238-3241, or features, with the sum of the dimensions of the lower-dimensional vector-valued metric-data streams equal to n. In certain cases, a feature may be 1-dimensional. In the following discussion, the dimension of input and output metric-data streams is generally not specified, with the understanding that a metric-data stream can be either 1-dimensional or multidimensional.

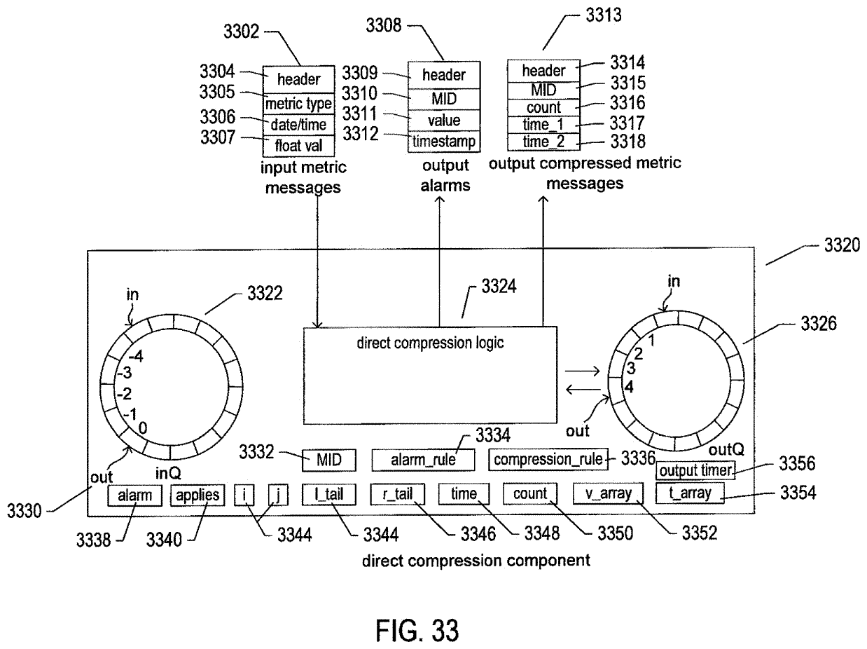

FIG. 33 provides an example implementation of a direct compression component, such as direct compression component 3212 in FIG. 32A. In this example, input metric-data messages 3302 include a header 3304, an indication of a metric type 3305, a timestamp 3306, and a numeric value 3307. Output alarm messages 3308 include a header 3309, a metric identifier 3310, a numeric value 3311, and a timestamp 3312. Output compressed metric messages 3313 include a header 3314, a metric identifier 3315, a count 3316, and to timestamps 3317-3318. In alternative implementations, multiple metric data points may be contained in single messages, metric-data points may be received in unpacketized data streams, and many other types of metric-data transmission methods may be used for transmitting metric data to and from the direct compression component. The direct compression component 3320 includes a circular input queue inQ 3322, compression logic 3324, and a second circular queue outQ 3326. During steady-state operation, the next input metric-data message to be processed 3328 has logical index 0 and is referenced by a pointer out 3330. A number of subsequently received metric-data messages are positioned in inQ entries with logical indexes −1, −2, −5 and a number of previously received metric-data messages are positioned in outQ entries with logical indexes 1, 2, 3, and 4. This allows processing the next metric-data message to be processed in the context of a number of previously received metric-data messages and a number of subsequently received metric-data messages or, in other words, in a temporal neighborhood. This provides for detecting a wide range of different types of metric-data-sequence events, including peaks, valleys, and particular types of subsequences, in addition to simpler events, such as the occurrence of outlying values above or below threshold values. Finally, the direct compression component contains a number of variables and data arrays: (1) MID 3332, the metric identifier associated with the direct compression component; (2) alarm_rule 3334, a rule that, when applied to the currently processed metric-data message and its temporal neighborhood, returns a Boolean value TRUE when an alarm condition is present; (3) compression_rule 3336, a rule that, when applied to the currently processed metric-data message and its temporal neighborhood, returns a Boolean value TRUE when an event counted by the direct compression component is present; (4) alarm 3338, a Boolean variable indicating that an alarm condition has been detected; (5) applies 3340, a Boolean variable indicating that a countable event has been detected; (6) i and j 3342, loop variables; (7) l_tail 3344, the size of the portion of the temporal neighborhood including subsequently received data-metric messages; (8) r_tail 3346, the size of the portion of the temporal neighborhood including previously received data-metric messages; (9) time 3348, a local variables storing the current system time; (10) count 3350, a local variables storing the count of countable events detected during a current monitoring interval; (11) v_array 3352, an array of metric-data values extracted from either the inQ or from both the inQ and outQ; (12) t_array 3354, an array of timestamps extracted from either the inQ or from both the inQ and outQ; and (13) output-timer 3356, a timer that controls output of compressed metric-data messages.

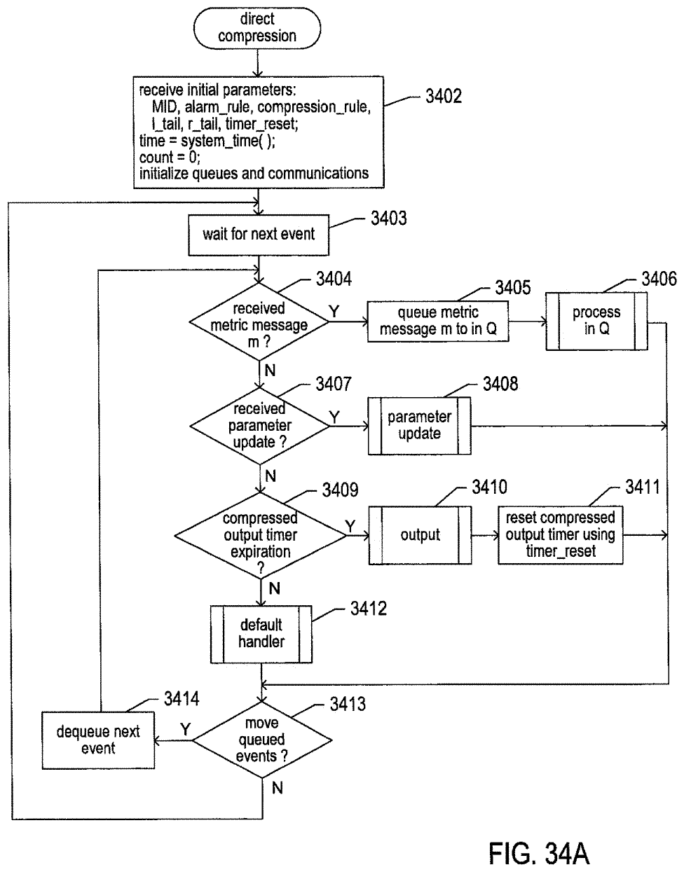

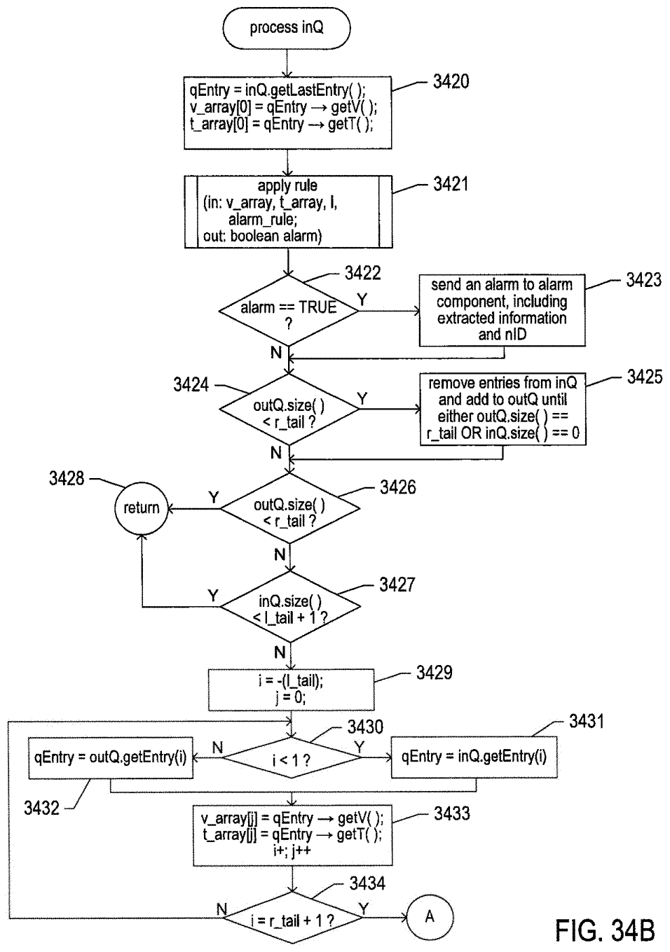

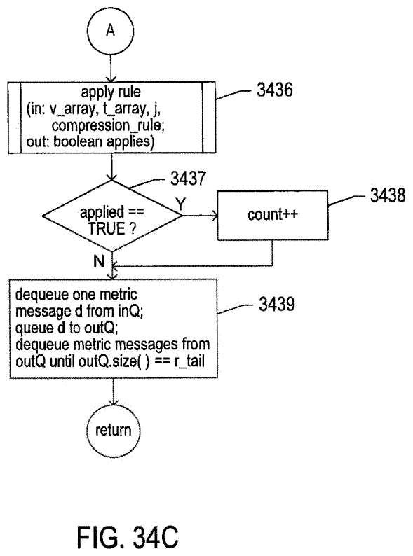

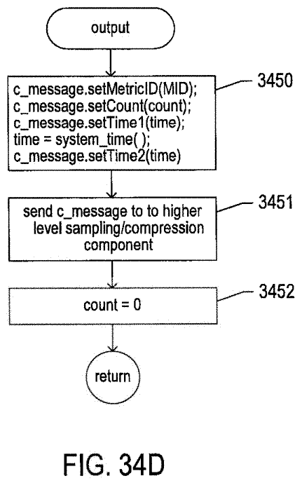

FIGS. 34A-D provide control-flow diagrams that illustrate implementation of the direct-compression logic (3324 in FIG. 33). In step 3402, the routine “direct compression” receives initial values for certain of the variables/parameters (3332-3354 in FIG. 33) used to implement the direct-compression logic. The variable time is set to the current system time and the variable count is set to 0. In addition, inQ and outQ are initialized, along with communications connections. In step 3403, the routine “direct compression” waits for a next event to occur. When the next occurring event is reception of a metric-data message m, as determined in step 3404, the message m is queued to inQ, in step 3405, followed by a call to a routine “process inQ,” in step 3406. When the next event is reception of a parameter-update message, in step 3407, a routine “parameter update” is called in step 3408 to update the local parameter/variables. Parameter updates may be received from higher-level sampling/aggregation components and/or the metric-data analysis system (3210 in FIG. 32A), which may adjust the parameters of the direct-comparison logic based on higher-level considerations. When the next occurring event is expiration of the output-timer, as detected in step 3409, a routine “output” is called in step 3410 and then, in step 3411, the output-timer is reset. A default handler is called in step 3412 to handle any rare or unexpected events. When there are more events queued for handling, as determined in step 3413, a next event is dequeued, in step 3414, and control returns to step 3404 for processing of the dequeued event. Otherwise, control returns to step 3403, where the routine “direct compression” waits for the occurrence of a next event.

FIGS. 34B-C provide control-flow diagrams for the routine “process inQ,” called in step 3406 of FIG. 34A. In step 3420, the routine “process inQ” retrieves the metric value and timestamp of the least recently received metric-data message from inQ and places them in the first elements of the v_array and t_array local variables. Then, in step 3421, the routine “process inQ” calls a routine “apply rule” to apply an alarm rule to the metric value and timestamp of the currently processed metric-data message. When, as determined in step 3422, the alarm rule, when applied to the currently processed metric-data message, returns a value TRUE, the routine “process inQ” generates and transmits an alarm message to the alarm (3228 in FIG. 32A) in step 3423. Thus, it is possible to short circuit metric-data processing in the case of detection of certain metric-data values in the input metric-data stream. When the size of outQ is less than the value stored in local variable r_tail, as determined in step 3424, the routine “process inQ” removes entries from inQ and queues the removed entries to outQ until either there are r_tail entries in outQ or until inQ is empty, in step 3425. When the number of entries in outQ is less than r_tail, as determined in step 3426, or the number of entries in inQ is less than l_tail+1, as determined in step 3427, the routine “process inQ” returns, in step 3428, since there is not a sufficient number of queued entries for a complete temporal neighborhood for the currently processed metric-data message. Otherwise, when a steady-state metric-data-processing state has been reached, the metric values and timestamps of the currently processed metric-data message and the previous and subsequent messages in the temporal neighborhood are extracted from outQ and inQ, in the loop of steps 3429-3434, into the local arrays v_array and t_grray. Then, turning to FIG. 34C, the routine “process inQ” calls the routine “apply rule,” in step 3436, to apply the compression rule to the currently processed metric data and temporal neighborhood to determine whether or not the currently processed metric data represents a countable event. When the compression rule does apply to the currently processed metric data and temporal neighborhood, as determined in step 3437, local variable count is incremented, in step 3438. Finally, in step 3439, the currently processed metric-data message is moved from inQ to outQ and metric-data messages are dequeued from outQ until the size of outQ is equal to r_tail.

FIG. 34D provides a control-flow diagram for the routine “output,” called in step 3410 of FIG. 34A. In step 3450, the routine “output” prepares a compressed-metric-data message c message to report the number of countable events detected during the current monitoring interval, in step 3451. Then, in step 3452, the routine “output” sets local variable count to 0.

The direct-compression component described above with reference to FIGS. 33-34D illustrates the fact that, for certain types of metric-data streams, the sampling rate can be effectively reduced to a single sample per monitoring interval. The generic implementation of the direct-compression component, described above, allows for direct detection of countable events, such as the occurrence of outliers or the occurrence of outlying subsequences of data points, and reporting of these counts at a low sampling rate of one output compressed-data-metric message for monitoring interval. The direct-compression component thus represents an entire class of low-frequency compression/sampling components that serve to compress the amount of stored metric data without incurring undesired information loss. This represents an extreme type of sampling-rate-based compression for predictable or relatively static metric-data sequences such as those discussed above with reference to FIGS. 29 and 31-A-B.

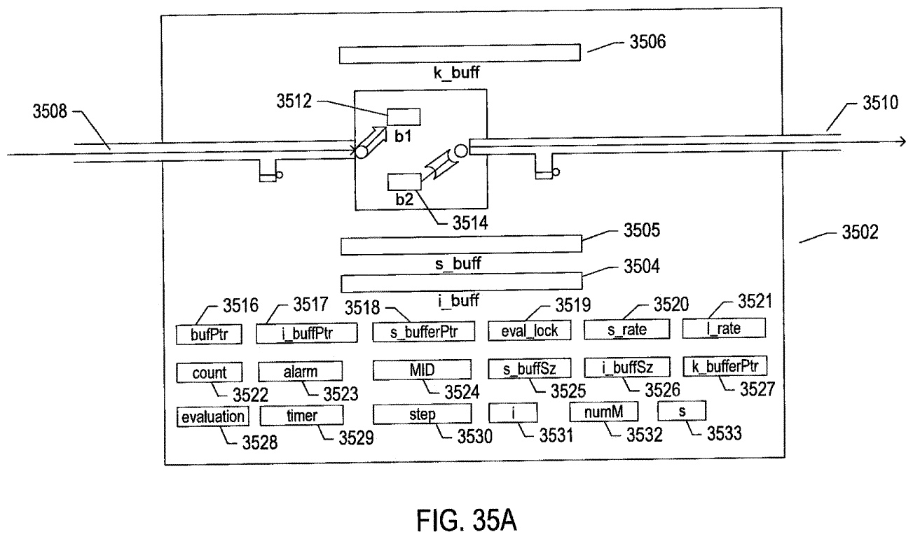

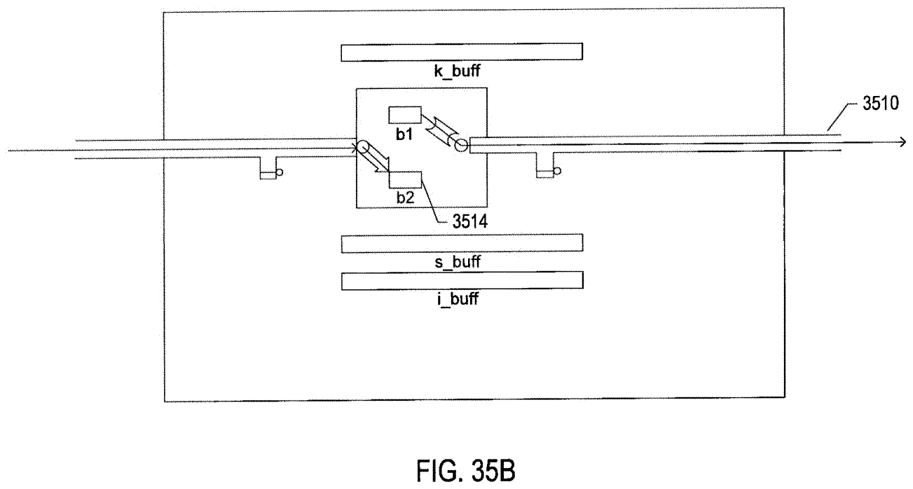

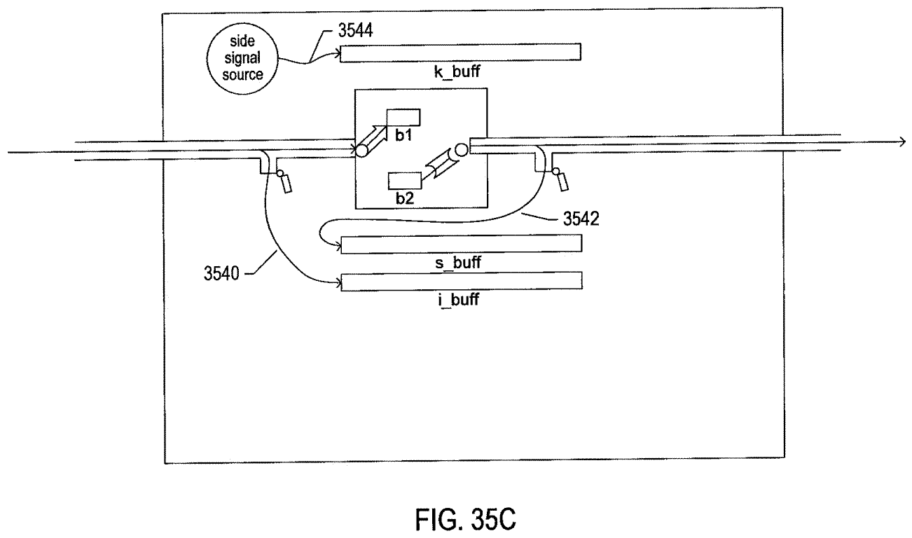

FIGS. 35A-C illustrate components of a generalized implementation of a sampling/aggregation component, such as sampling/aggregation components 3214, 3216, and 3224 shown in FIG. 32A. The sampling/aggregation component 3502 includes three metric-data buffers: (1) i_buff 3504, which stores a metric-data stream collected at the maximum practical sampling rate inherent in the generation and transmission of metric data by a component within a distributed computer system; (2) s_buff 3505, which stores a sampled metric-data stream; and (3) k_buff 3506, which stores a side signal. The sampling/aggregation component receives an input metric-data stream 3508 and outputs a sampled metric-data stream 3510. The metric data may be received in metric-data messages and output in messages, and may also output alarm messages, as discussed with reference to items 3302, 3308, and 3313 in FIG. 33, but may also employ other types of metric-data transmission methods and signals in alternative implementations, as also discussed above with reference to FIG. 33. While a next metric-data message to be processed is input to a first metric-data-message buffer b1 3512, the most recently processed metric-data message to be included in the sampled metric-data output is transferred from a second metric-data-message buffer b2 3514 to the sampled metric-data output stream 3510. The sampling/aggregation component 3502 includes various variables/parameters: (I) bufPtr 3516, a pointer to one of the two metric-data message buffers b1 and b2; (2) i_buffPtr 3517, an index/pointer for the next free entry in i_buff; (3) s_buffPtr 3518, an index/pointer for the next free entry in s_buff, (4) eval_lock 3519, a synchronization lock; (5) s_rate 3520, a current sampling rate; (6) l_rate 3521, the currently estimated optimal sampling rate; (7) count 3522, a local variable storing the count of received metric-data messages: (8) alarm 3523, a local Boolean variable indicating an alarm condition; (9) MID 3524, a metric identifier: (10) s_buffSz 3525, a local variable indicating the number of entries in s_buff (11) i_buffSz 3526, a local variable indicating the number of entries in i_buff; (12) k_buffPtr 3527, an index/pointer for the next free entry in k_buff; (13) evaluation 3528, a Boolean variable indicating whether or not sample-rate monitoring is in progress; (14) timer 3529, a timer that controls the start of sampling-rate monitoring intervals; (15) step 3530, a variable that accumulates indicated sampling-rate changes; (16) i 3531, a loop variable; (17) numM 3532, the number of specific sampling-rate-evaluation routines called to evaluate the current sampling rate; and (18) s 3533, a sampling-rate-change indication returned by a sampling-rate-evaluation routine.

FIG. 35B shows how the metric-data messages are alternatively input to buffers b1 and b2 while metric-data messages are alternatively output from buffers b2 and b1, respectively. While, in FIG. 35A, the next metric-data message to be processed is input to buffer b1 and the next metric-data message to be output is output from buffer b2, the following metric-data message to be processed is input to buffer b2, in FIG. 35B, while the most recently processed metric-data message is output from buffer b1 to the output metric-data stream 3510. The pointer bufPtr alternates between pointing to buffer b1 and buffer b2 in order to implement the alternating functions of buffers b1 and b2, as discussed below.

FIG. 35C illustrates collection and storage of metric-data messages during sampling-rate-monitoring intervals. In order to determine a next estimate for a change to the sampling rate in order to continuously track an optimal sampling rate, the sampling/aggregation component, during a next sampling-rate-monitoring interval, collects and stores metric-data messages from the input metric-data stream in i_buff as indicated by curved arrow 3540, collects and stores metric-data messages from the output metric-data stream in s_buff, asas indicated by curved arrow 3542, and collects side-signal information in k_buff, as indicated by curved arrow 3544. At the end of the sampling-rate-monitoring interval, collection and storage of metric-data messages in i_buff and s_buff, and storage of side-signal information in k_buff, is discontinued and the stored metric-data messages and, in certain cases, side-signal information are used to compute a change to the current sampling rate.

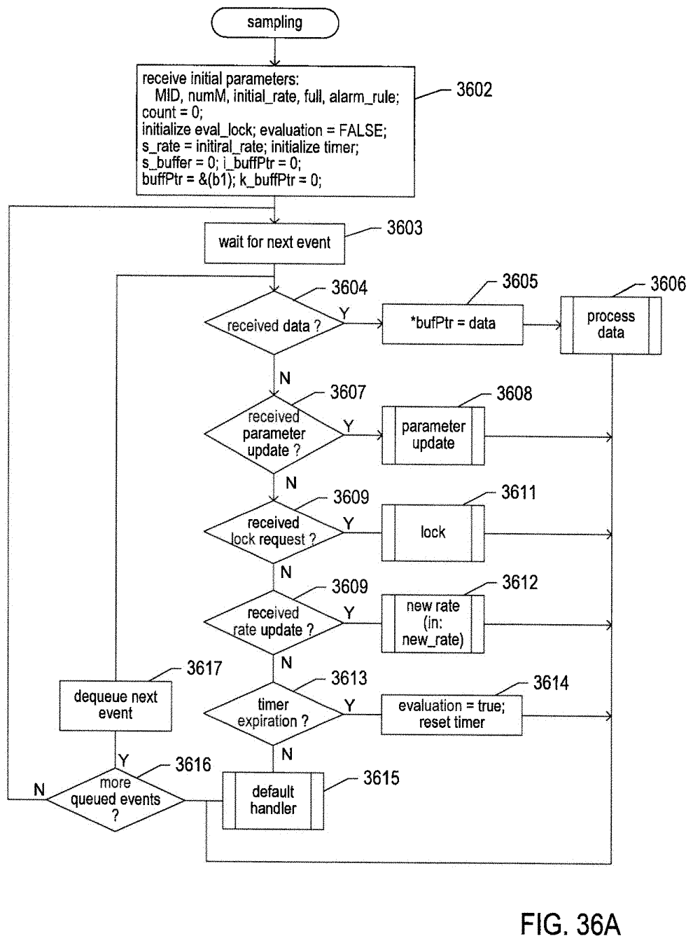

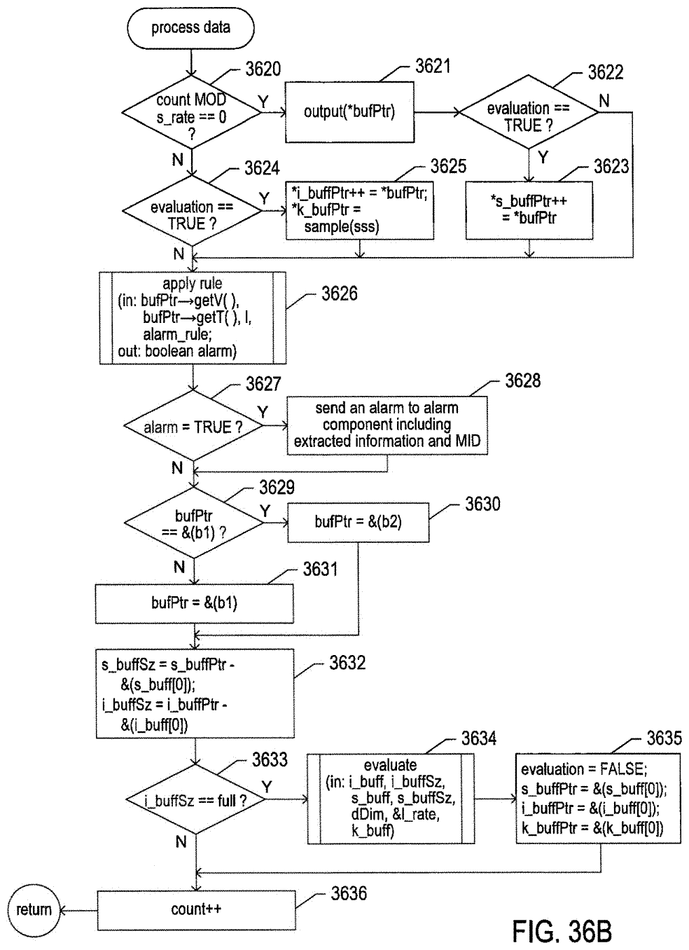

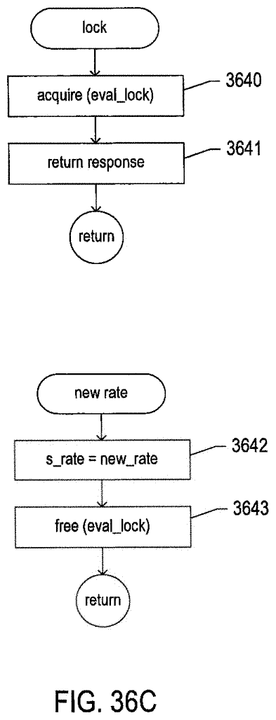

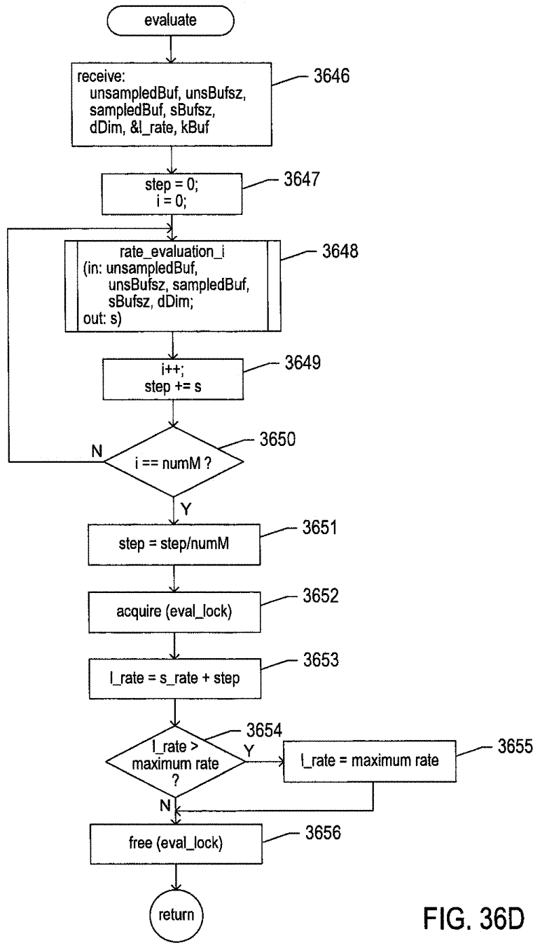

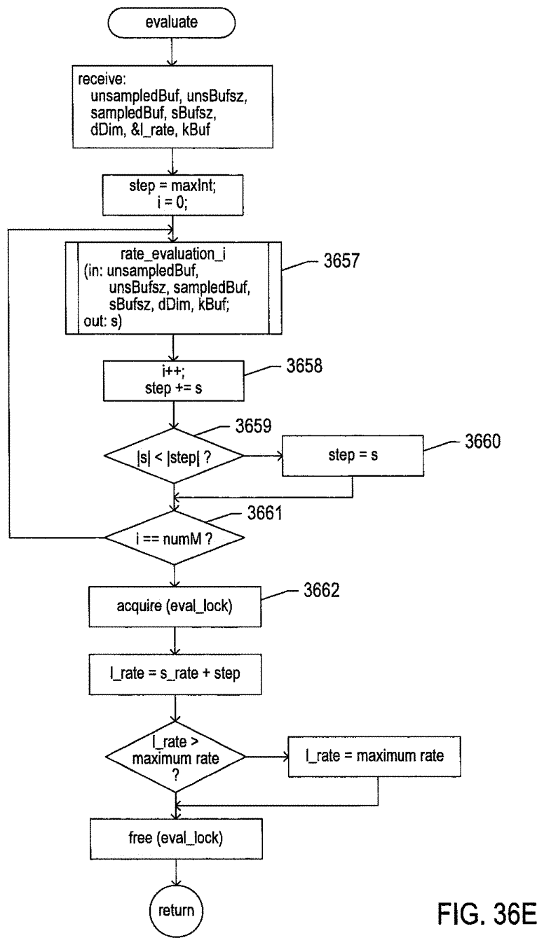

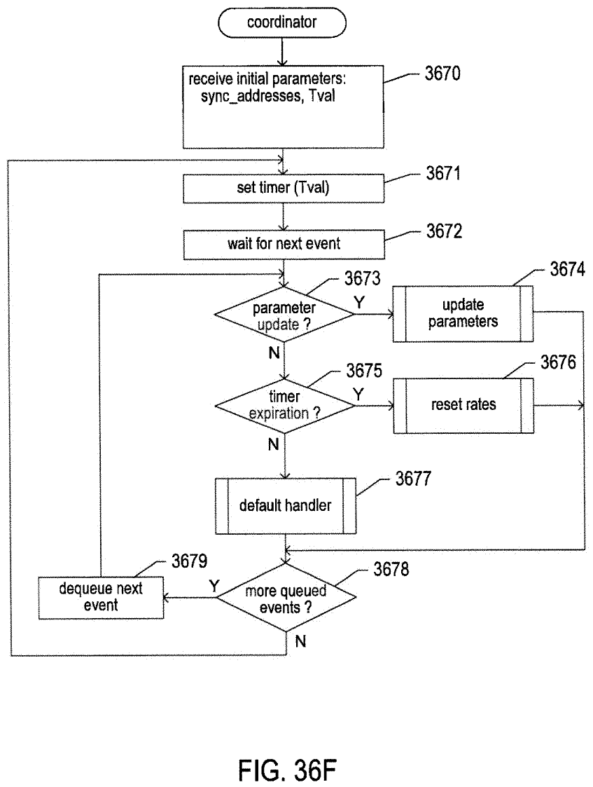

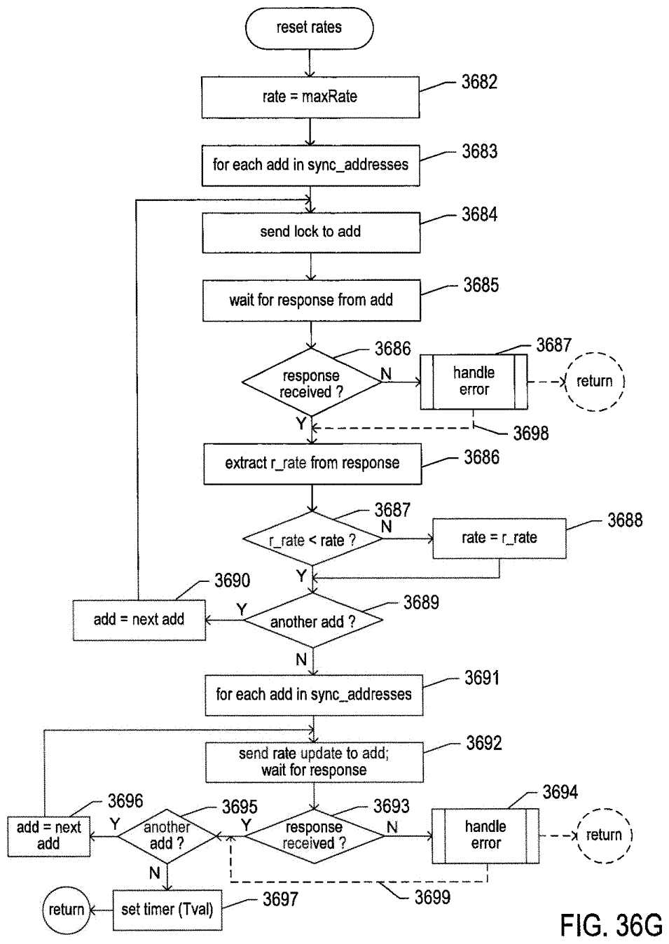

FIGS. 36A-G provide control-flow diagrams that illustrate implementation of the generalized sampling/aggregation component discussed above with reference to FIGS. 35A-C. FIG. 36A provides a control-flow diagram for a routine “sampling,” the highest logic level in the sampling/aggregation-component implementation. In step 3602, the routine “sampling” receives initial values for certain of the variables/parameters (3516-3427 in FIG. 35A) and sets other of the variables/parameters to initial values. In step 3603, the routine “sampling” waits for the occurrence of a next event. When the next event is reception of metric data from the input metric-data stream, as determined in step 3604, the routine “sampling” stores the received metric-data message in one of the two buffers b1 and b2 referenced by bufPtr, in step 3605, and then calls the routine “process data,” in step 3606. Otherwise, when the next event is reception of a parameter update, as indicated in step 3607, the routine “parameter update” is called, in step 3608, to update any of various variables/parameters. Parameter values may be changed by higher-level components of a metric-data collection, storage, and analysis system that includes a sampling layer containing the sampling/aggregation component. When the next received event is a lock request, as determined in step 3609, a routine “lock” is called in step 3610. Locking is used, as discussed below, to synchronize updates to the sampling rate used by multiple sampling/aggregation components with coordinated sampling rates. When the next event is reception of a rate-update message or indication, as determined in step 3611, a routine “new rate” is called in step 3612. When the next occurring event is a timer expiration, as determined in step 3613, the local variable evaluation is set to TRUE, in step 3614, and the timer is reset. A default handler 3615 handles any unexpected or rare events. When, following handling of the most recently handled event, there are more events queued for processing, as detected in step 3616, a next event is dequeued in step 3617 and control returns to step 3604 for handling of the next event. Otherwise, control returns to step 3603.

FIG. 36B provides a control-flow diagram for the routine “process data,” called in step 3606 of FIG. 36A. When count modulo s_rate is 0, as determined in step 3620, the most recently received metric-data message is output to the output metric-data stream in step 3621 and, when the variable evaluation contains the value TRUE, as determined in step 3622, the most recently received metric-data message is stored in s_buff; in step 3623. The value stored in s_rate thus controls the sampling rate, with increasing values corresponding to lower-frequency sampling. When the variable evaluation is TRUE, as determined in step 3624, the most recently received metric-data message is stored in i_buff and a side-signal value is stored in k_buff, when a side-signal value is available and needed, in step 3625. The side signal is, in certain implementations, a performance-indication value generated by a distributed-computer-system component, which may be derived from various collected metric data, from data values provided by the component through various interfaces, such as application interfaces, operating-system interfaces, and hypervisor interfaces. The side signal is used only for certain types of sample-rate evaluations. In step 3626, the routine “process data” calls the routine “apply rule” to determine whether or not an alarm condition is indicated by the contents of the most recently received metric-data message. If an alarm condition is indicated, as determined in step 3627, an alarm message is sent to the alarm component, in step 3628. In steps 3629-3631, the contents of bufPtr is switched to point to the other of buffers b1 and b2. In step 3632, the number of entries in s_buff and i_buff are computed and stored in variables s_buffSz and i_buffSz. When i_buff is full, as determined in step 3633, the routine “process data” calls the routine “evaluate,” in step 3634, to evaluate the current sampling rate and to suggest a sampling-rate change, in certain cases, to track an optimal sampling rate. Following the evaluation, the variable evaluation is set to FALSE and the various buffer pointers are reset, in step 3635. In step 3636, the variable count is incremented, after which the routine “process data” returns. Sampling-rate monitoring is carried out asynchronously with respect to sampling of the input metric-data stream to produce the output sampled metric-data stream. The call to the routine “evaluate,” in step 3634 is therefore asynchronous, and does not interfere with processing of input metric-data messages.

FIG. 36C provides a control-flow diagrams for the routines “lock,” called in step 3610 of FIG. 36A, and “new rate,” called in step 3612 of FIG. 36A. In step 3640, the routine “lock” acquires the lock oval lock and then, in step 3641, returns a response to a coordinator, discussed below. In step 3642, the routine “new rate” sets the sampling rate stored in the variable s_rate to a new rate received in a rate-update message and then, in step 3643, frees the lock eval_lock. The lock is used to prevent updates to local variable I—rfate during a sampling-rate change coordinated among multiple sampling/aggregation components.

FIG. 36D provides a control-flow diagram for the routine “evaluate,” called in step 3634 of FIG. 36B. In step 3646, the routine “evaluate” receives pointers or references to the buffers containing unsampled metric-data messages, sampled-metric data messages, and the side signal, indications of the number of entries in the buffers, an indication of the dimensionality of the metric-data messages or data points, and a reference to the local variable I rate. In step 3647, the routine “evaluate” sets local variables step and i to 0. Then, in a loop of steps 3648-3650, the routine “evaluate” successively calls numM different rate-evaluation routines, in step 3648, each of which returns an indication s of a change to the sampling rate. These indications are accumulated in the local variable step. In step 3651, the number of accumulated indications in local variable step is divided by the number of rate-evaluation routines called in the loop of steps 3648-3652 to determine an average indicated rate change. In step 3652, the routine “evaluate” acquires the lock eval_lock, and updates the variable l_rate, in step 3653, to contain a new estimated sampling rate. If l_rate is greater than the maximum practical sampling rate, as determined in step 3653, l_rate is set to the maximum rate in step 3654. In step 36544, the routine “evaluate” frees eval_lock. Use of eval_lock prevents update of l_rate during a coordinated sampling-rate change among a group of sampling/aggregation components. FIG. 36A provides a control-flow diagram for an alternate version of the routine “evaluate.” FIG. 36E is similar to FIG. 36D, except that, rather than averaging the sampling-rate changes produced by one or more rate-evaluation routines, the alternative routine “evaluate” chooses the smallest sampling-rate-change indication, in the loop of steps 3656-3660. There are many different alternative approaches to combining the suggested sampling-rate changes from different sampling-rate-evaluation routines in order to produce a cumulative sampling-rate change.

FIGS. 36F-G provide control-flow diagrams for a routine “coordinator” which illustrates implementation of a coordinator function in a higher-level sampling/aggregation component for coordinating sampling rates of lower-level sampling/aggregation components that provide input metric-data messages or data points to the higher-level sampling/aggregation component. In step 3670, the routine “coordinator” receives initial parameters that include network addresses or shared-memory pointers for communicating with the lower-level sampling/aggregation components and a timer interval Tval. In step 3671, the routine “coordinator” sets a timer to Tval. Then, in step 3672, the routine “coordinator” waits for the occurrence of a next event. When the next event is a parameter-update event, as determined in step 3673 the routine “update parameters” is called, in step 3674, to update the parameters used by the routine “coordinator.” Otherwise, when the event is a timer expiration, as determined in step 3675, a routine “reset rates” is called, in step 3676. A default handler 3677 is called to handle any rare or unexpected events. When there are more queued events to handle, as determined in step 3678, a next event is dequeued in step 3679 and control returns to step 3673. Otherwise, control returns to step 3671.

FIG. 36G provides a control-flow diagram for the routine “reset rates” called in step 3676 of FIG. 36F. In step 3682, the routine “reset rates” sets the local variable rate to a maximum sampling rate. In the for-loop of steps 3683-3690 the routine “reset rates” sends a lock message or indication to each of the lower-level sampling/aggregation components, waits for a response, and extracts a current estimated optimal rate r_rate from the response. When the extracted estimated optimal rate is less than the contents of the local variable rate, as determined in step 3687, the value stored in the local variable rate is set to the extracted estimated optimal rate r_rate, in step 3688. Then, in the for-loop of steps 3691-3696, the routine “reset rates” sends rate-update messages or indications, containing the rate stored in the local variable rate, to each of the lower-level sampling/aggregation components. Following completion of the for-loop of steps 3691-3696, the tinier is reset to timer value Tval, in step 3697, followed by a return of the routine “reset rates.” In both the for-loop of steps 3683-3690 and 3691-3696, a failure to receive a response from a lower-level sampling/aggregation component results in a call to an error handler, in steps 3687 and 3694, to handle the response failure. Error handling may involve repeating sending of a lock or rate-update message or may involve other error-handling procedures. In certain cases, when an error is successfully handled, the routine “reset rates” continues to execute, as indicated by dashed arrows 3698 and 3699. In other cases, the routine “reset rates” returns.

The above discussed generalized implementation of a sampling/aggregation component provides for coordinated sampling-rate adjustment. However, in various specific sampling/aggregation components, coordinated sampling-rate adjustment is not needed. In these specific implementations, the sampling rate is directly updated, in step 3652 of FIG. 36D and in step 3661 in FIG. 36E. No locking is needed, so the lock acquisition and lock freeing steps 3652 and 3655 in FIG. 36D and similar steps in FIG. 36E are not needed. Similarly, no lock-request handling and no rate-update-message handling are needed. Instead, for sampling/aggregation components that do not use coordinated locking, the components adjust their sampling rates directly. Of course, this can also be alternatively achieved by including a sampling/aggregation component that does not need coordinated sampling-rate adjustment into a group of one sampling/aggregation component coordinated by a coordinator.

The hierarchically organized sampling-and-aggregation components of a metric-data collection, storage, and analysis system, discussed above with reference to FIGS. 32A-36G, provide a flexible architecture for automated metric-data sampling that continuously optimizes the sampling rates for individual metric-data streams and aggregated metric-data streams. A wide variety of different implementations of the generalized sampling/aggregation components, discussed above, are possible. Sampling-rate evaluation and optimization are carried out asynchronously with respect to ongoing metric-data sampling and aggregation, and local sampling-rate evaluation is carried out asynchronously with respect to global sampling-rate optimization. This provides a basis for using many different types of sampling-rate evaluation methods embodied in many different sampling-rate evaluation routines. Various combinations of the different methods can be applied, in different implementations, to automatically optimize metric-data sampling rates. In the following discussion, numerous different sampling-rate evaluation methods are discussed as different implementations of the rate-evaluation routines called in step 3648 of FIG. 36D and step 3655 in FIG. 36E.

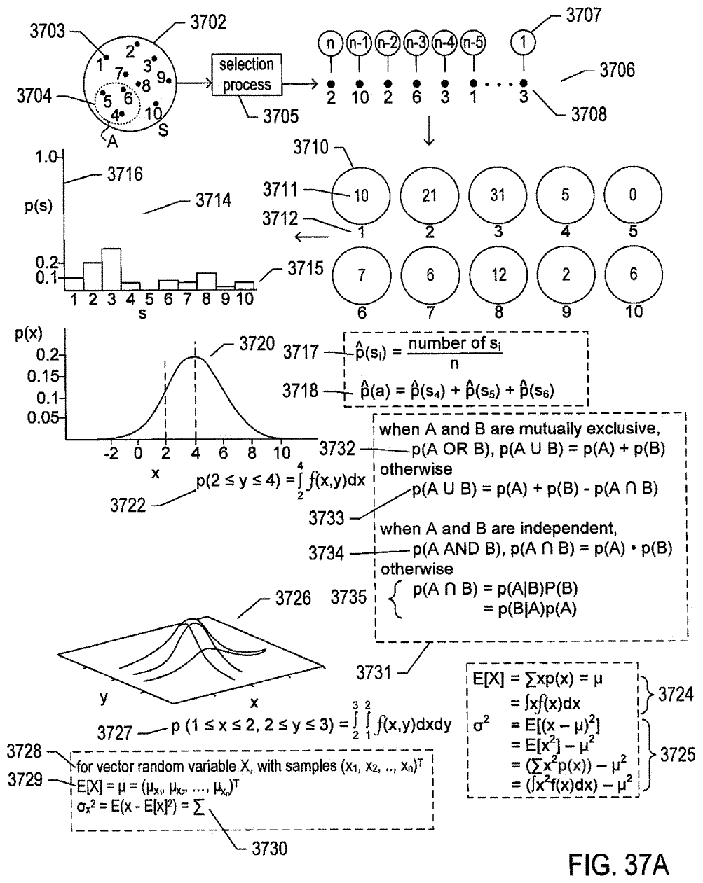

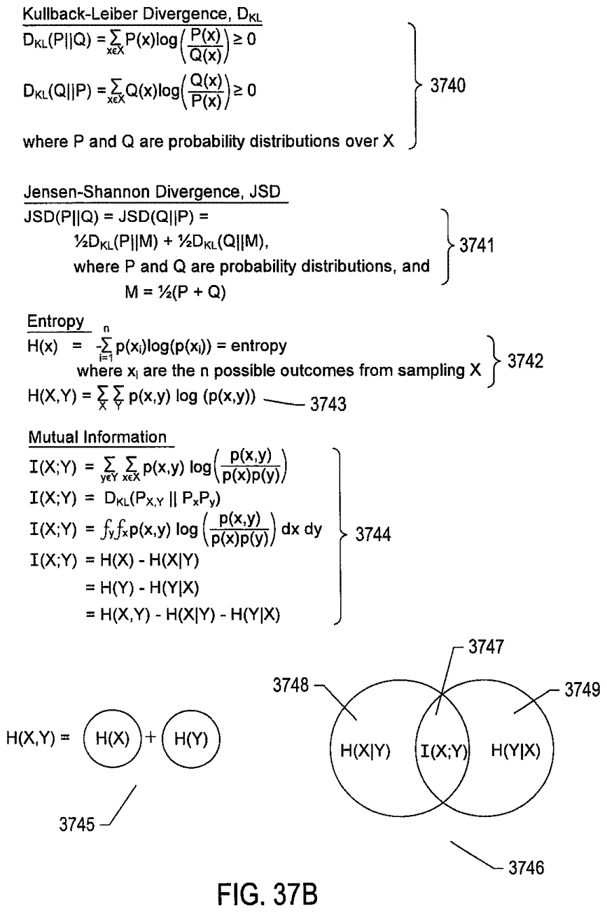

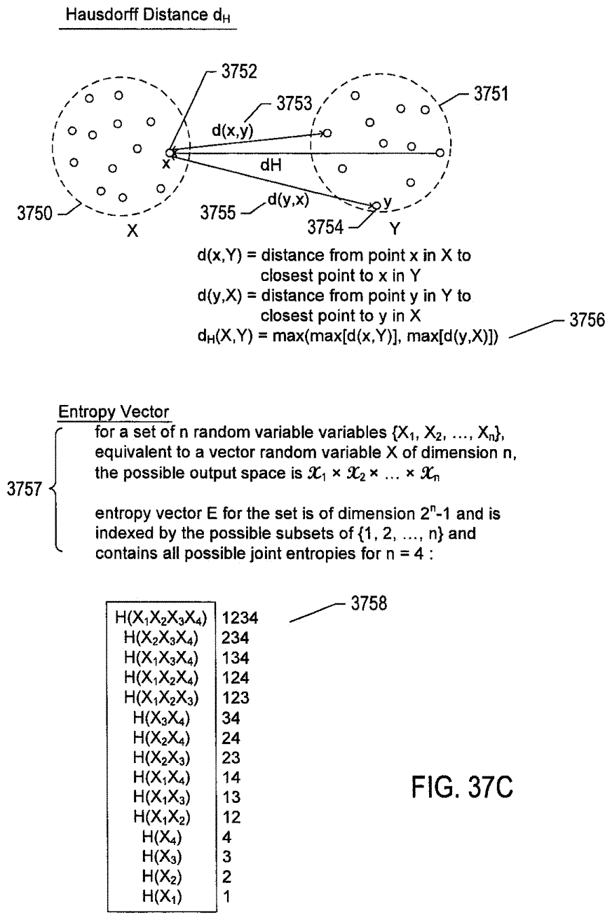

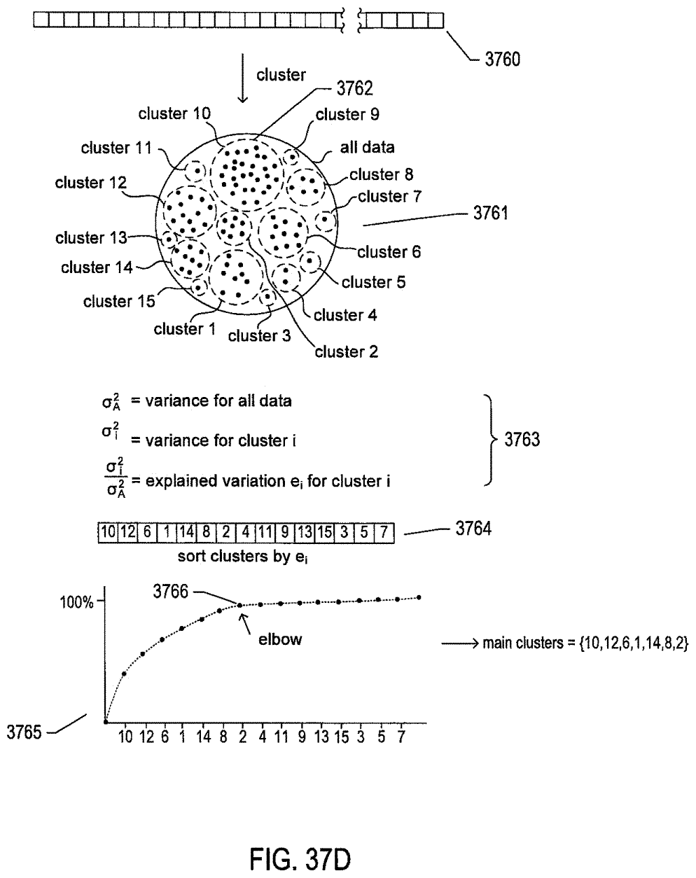

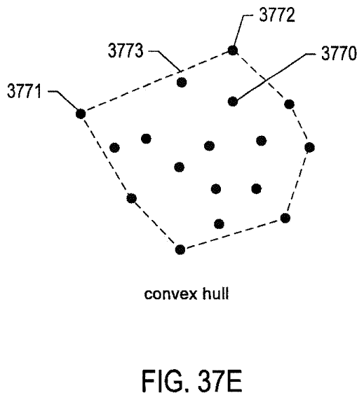

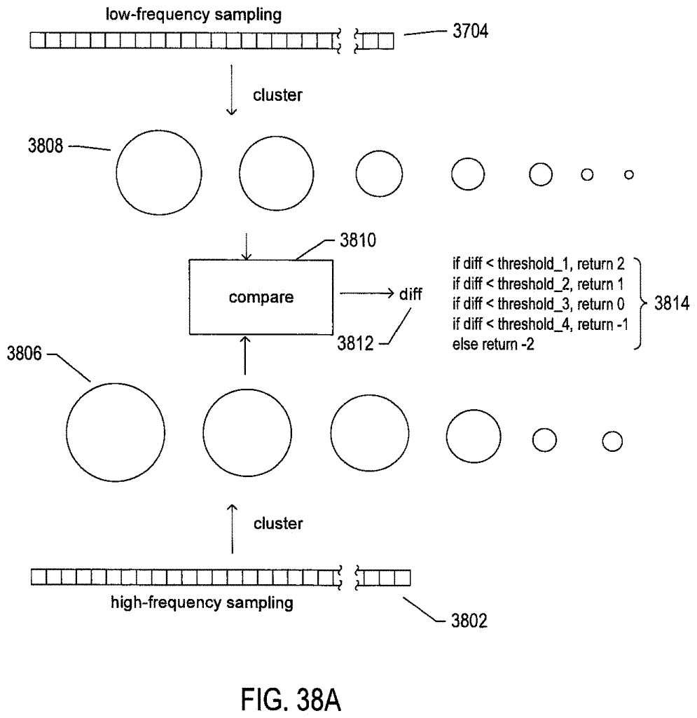

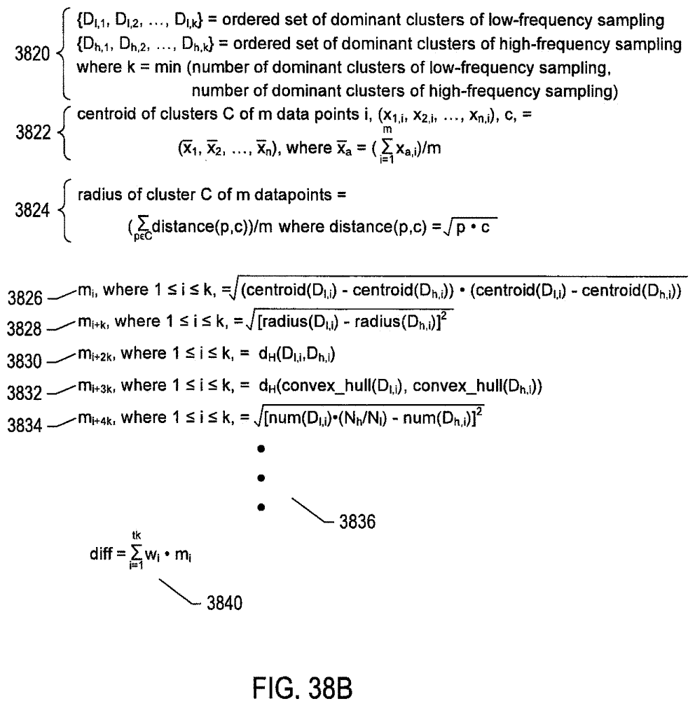

FIGS. 37A-E illustrate numerous statistical and data-analysis methods and processes that are used in various different sampling-rate evaluation routines that are subsequently discussed, below, with reference to FIGS. 38A-43. FIG. 37A illustrates numerous statistical concepts. The basic concept involves probability and random variables. Consider a set of non-decomposable events, or samples, within a sample space 3702. Each element of the sample space, such as element 3703, represent some type of observable outcome from an experimenter process. Higher-level events, such as event A 3704, may represent the occurrence of any of multiple different lower-level non-decomposable events. A random selection process 3705 generates a sequence of samples 3706, with replacement, from the sample space 3702. The circled numbers, such as circled number 1 3707, represents the numeric sequence identifier for each sample and the numerically labeled sample points, such as sample point 3708, represent the particular non-decomposable event returned by the random sampling process. A random variable represents random selection of samples from a sample space according to a particular probability distribution. The sequence of samples generated by the random selection process can be alternatively represented by the number of samples in a generated or selected sample sequence corresponding to each non-decomposable event. For example, disk 3710 represents the fact that the sequence of samples 3706 includes 10 occurrences 3711 of the first non-decomposable event 3712 in the sample space. The alternative representation of the sequence of randomly selected sample points can, in turn, be viewed as a histogram 3714 in which the different types of non-decomposable sample points are plotted with respect to a horizontal axis 3715 and the probability of occurrence of each type of non-decomposable sample point is plotted with respect to the vertical axis 3760. As shown in expression 3717, the estimated probability of occurrence of a particular type of non-decomposable sample point, or event, is the ratio of the number of occurrences of the particular type of sample point divided by the total number of samples n generated by the random selection process.

Histogram 3714 is an example of a discrete probability distribution or probability-mass function. The height of each column in the histogram, hᵢ, has a value between 0 and 1 and the sum of the heights of the columns in the histogram is 1.0. The estimated probability of a higher-level event composed of multiple non-decomposable samples is computed as the sum of the probabilities of the multiple non-decomposable samples, as indicated by expression 3718. A probability density function, an example of which is shown as plot 3720 in FIG. 37A, is a continuous curve. The area under the curve is 1.0 and the probability of a randomly selected sample from the distribution is found, by integration, as the area under the curve between endpoints of a range of sample values 3722. The 1-dimensional probability-density function shown in plot 3720 is characterized by a mean value μ, which is the expected value for the random variable X that selects values from the continuous sample space according to the distribution, as indicated by expressions 3724, and further characterized by a variance σ², as indicated by expressions 3725, which is the expected value of a squared deviation of samples generated by X from the mean μ. Probability density functions can be multivariate, and based on two or more random variables. Plot 3726 shows a 2-dimensional multivariate probability distribution in which the probabilities of occurrences of 2-dimensional sample points is computed, by integration, of volumes under particular portions of the probability-density-function surface, as indicated by expression 3727. Multivariate probability distributions can be thought of as distributions of vector-value random variables, as indicated by expression 3728, and are characterized by a vector of mean values, as indicated by expression 3729, and by a covariance matrix 3730. There are a number of different probability rules, or expressions, that are frequently encountered in the derivations of various statistical methods and data-analysis methods, examples of which are shown in dashed box 3731. These include the probability of the occurrence of either of two events A and B when the two events are mutually exclusive, shown in expression 3732, or when the two events are not mutually exclusive, shown in expression 3733, and the probability of the occurrence of both of two events A and B when the two events are independent, shown in expression 3734, and when the two events are not independent, shown in expressions 3735.

FIG. 37B provides expressions and illustrations for several different statistical methods and concepts. The Kullback-Leibler divergence, D_{KL}, defined by expressions 3740, provides a numerical measure of the difference between two probability distributions. It is often referred to as the “relative entropy” of the first of the two probability distributions with respect to the second of the two probability distributions. The Kullback-Leibler divergence is not symmetrical with respect to the two compared probability distributions. In other words, in general, D_{KL} (P∥Q) does not equal D_{KL}(Q∥P). When two compared probability distributions P and Q are identical, D_{KL}(P∥Q) and D_{KL}(Q∥P) are both 0. As two compared distributions different more from one another, the numerical difference computed by D_{KL} increases.

The Jensen-Shannon divergence, JSD, is a symmetrical divergence related to the Kullback-Leibler divergence. The JSD is defined by expressions 3741. Like the Kullback-Leibler divergence, the JSD has a value of 0 for two identical compared probability distributions and the value of the JSD measure increases as the two compared probability distributions more greatly differ from one another.

The entropy of a probability distribution is related to the degree of unexpectedness associated with sampling a random variable distributed according to the probability distribution. For example, consider sampling a random variable that describes flipping a fair coin and observing either a heads or a tails result for each coin flip. An entropy of 1.0 is associated with a fair-coin probability distribution, which is (H=0.5, T=0.5), where H represents heads and T represents tails. By contrast, sampling a random variable that describes flipping a completely biased coin, which always produces either heads or tails, is 0.0. The entropy for a single probability distribution is provided by expressions 3742 and the joint entropy for two probability distributions corresponding to two random variables X and Y is given by expression 3743. The mutual information for two probability distributions X and Y is alternatively expressed according to the different expressions 3744. One way of looking at the mutual information between random variables X and Y, I(X;I), is that when the two random variables are independent from one another, the mutual information I(X;Y) and I(Y,X) are 0 but, when the two random variables are dependent on one another, the mutual information represents a decrease in the number of bits needed to encode X knowing Y or a decrease in the number of bits needed to encode Y knowing X. This is illustrated by Venn diagrams 3745 and 3746 in FIG. 37B. The joint entropy for two independent random variables X and Y is the sum of the entropies for each random variable, as shown by Venn diagram 3745. However, when the random variables are not independent, as shown in Venn diagram 3746, the mutual information for the two random variables 3747 is equal to the joint entropy for the two independent random variables minus the conditional entropies for the two random variables 3748 and 3749.

FIG. 37C illustrates the Hausdorf distance and the concept of the entropy vector. The Hausdorf distance, d_{H}, is a measure of the distance between two sets X 3750 and Y 3751. The distance between an element x 3752 of set X and set Y, d(x,Y) 3753, is the distance between element x and the closest element of set Y to element x. Similarly, the distance between an element y 3754 of set Y and set X, d(y,X) 3755, is the distance between element v and the closest element of set X to element y. The Hausdorf distance, d_{H} (X,Y), is the maximum of the maximum d(x,Y) and the maximum d(y, X) for the two sets X and Y 3756.

The concept of an entropy vector is illustrated in the lower portion of FIG. 37C. An entropy vector, as discussed in the text and expressions 3757, can be generated for a set of n scalar-valued random variables or, equivalently, for a single vector-valued random variable of dimension n. The entropy vector has dimension 2ⁿ−1, and the elements of the attribute vector are indexed by subsets of {1, 2, . . . , n}. Each element of the entropy vector contains the joint entropy for the corresponding subset of scalar-valued random variables or the joint entropy for the corresponding projection of the vector-valued random variable onto a lower-dimensional vector space corresponding to the index. FIG. 37C shows an example entropy vector 3758 for n=4.

FIG. 37D illustrates cluster selection by the elbow method. The data points of an input vector-valued metric-data sequence, or time series 3760, are clustered, using K-means clustering or another clustering method, to produce a set of data-point clusters 3761. Each cluster is shown surrounded by a dashed circle, such as dashed circle 3762 surrounding cluster 10, in the example of FIG. 37D. As indicated by expressions 3763, an explained-variation parameter eᵢ is computed for each cluster as the ratio of the variance computed for the data points in the cluster to the variance computed for all of the data points. The clusters are then sorted by their eᵢ values, in descending order, to produce the sorted array of clusters 2764, The sorted data points are then plotted, in plot 2765, with respect to a cumulative e value computed as the sum of the eᵢ values for the data point and any preceding data points in the sorted array of data points. The dominant or main clusters are then selected as the clusters within the initial, more steeply ascending part of the plotted data points up to data point 2766, at a position referred to as the “elbow” of a curve obtained by connecting the plotted data points with straight-line segments.

Finally, FIG. 37E illustrates a convex hull. A convex hull is a minimal convex subset of data points in a set of data points that enclose the data points of the set. In FIG. 37E, a set of data points, such as data point 3770, is fully enclosed by the data points connected by dashed line segments, such as data points 3771 and 3772 connected by dashed line segment 3773. Were the data points stationary pegs orthogonal to a surface, then the convex set could be obtained by expanding a rubber band around all of the pegs and then relaxing the expanded rubber band until it is held in a fixed position by the outermost pegs. In the example shown in FIG. 37E, the rubber band will follow the dashed line segments when held in a fixed position by the outermost pegs comprising the convex hull.

FIGS. 38A-B illustrate a first type of metric-data sampling-rate evaluation method that can be incorporated in a sampling-rate-evaluation routine. The sampling-rate-evaluation routine based on this method receives a metric-data sequence, or time series, sampled at a maximum practical sampling rate 3802 and a metric-data sequence, or time series, sampled at a current sampling rate 3804. A clustering method, such as K-means clustering, is used to cluster each of the received time series into data point clusters 3806 and 3808. The clusters are then input to a comparison routine 3810 which produces a difference metric value diff 3812. Then, in a set of conditional statements 3814, the difference metric value diff is used to determine a sampling-rate-change indication. In this and subsequently discussed sampling-rate-evaluation routines, the sampling-rate-change indications are selected from a set {−2, −1, 0, 1, 2}, with negative values indicating that the sampling rate needs to be increased, the value 0 indicating that the sampling rate is currently optimal, and positive values indicating that the sampling rate needs to be decreased. Of course, there are many other possible ways of generating sampling-rate-change indications and the range of adjustments may vary with different implementations. In the current implementation, the changes in sampling rate are relatively conservative, so that the sampling-rate adjustments do not overshoot an optimal sampling rate and result in large, oscillating sampling-rate variations. In alternative implementations, more complex sampling-rate adjustments may be made, including non-integral adjustments combined with metric-value estimation.

FIG. 38B illustrates metrics computed by the comparison routine (3810 in FIG. 38A) to generate the difference metric value diff. The clustered data points for the two different received metric-data sequences are processed, by the above-discussed elbow method, to generate an ordered set of dominant clusters for each received metric-data sequence 3820. The two ordered sets of dominant clusters both include k elements, where k is the minimum number of dominant clusters generated, by the elbow method, for both received metric-data sequences. The centroid of a cluster of data points can be computed as a vector of the same dimension as the data points having, as each element, the mean of the corresponding elements of the data points, as indicated by expressions 3822 in FIG. 38B. The radius of a cluster of data points, as shown by expressions 3824, can be computed as the average distance of each data point in the cluster to the centroid of the cluster. A first set of metrics includes the distances between the centroids of corresponding clusters in the two sets of clusters generated from the two received metric-data sequences, as indicated by expression 3826, where is a dot-product operator. A second set of metrics includes the positive differences between the radii of the corresponding clusters in the two sets of clusters generated from the two received metric-data sequences, as indicated by expression 2828. A third set of metrics includes the Hausdorf distances between the corresponding clusters in the two sets of clusters generated from the two received metric-data sequences, as indicated by expression 2830. A fourth set of metrics includes the Hausdorf distances between the convex hulls of the corresponding clusters in the two sets of clusters generated from the two received metric-data sequences, as indicated by expression 2832. A fifth set of metrics includes the differences in the number of data points in the corresponding clusters in the two sets of clusters generated from the two received metric-data sequences, as indicated by expression 2834, where a scaling multiplier Nₕ/Nₗ is used to adjust the number of data points in the cluster of data points from the low-frequency-sampled metric-data sequence. Ellipsis 2836 indicates that there are many different additional types of metrics that can be generated by comparing the sets of dominant clusters generated from the two received metric-data sequences. The difference metric value diff, in one implementation, is computed as a linear combination of weighted metric values 2040. In general, for any particular implementation, most of the weights are 0, since, in general, only a relatively small subset of the possible cluster-comparing metrics are used in any particular implementation.

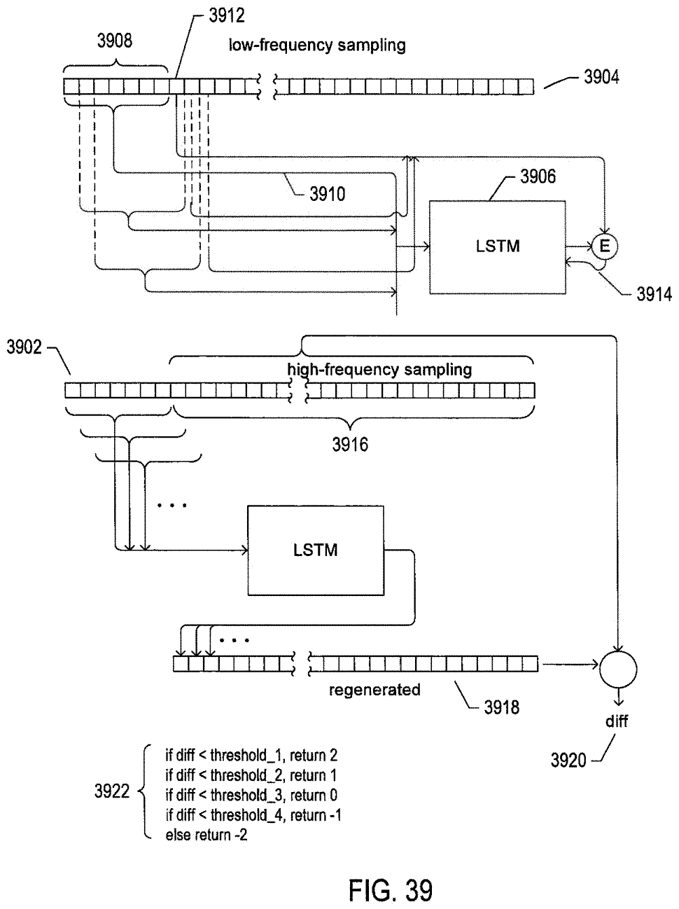

FIG. 39 illustrates a second type of metric-data sampling-rate evaluation method that can be encompassed in a sampling-rate-evaluation routine. The second type of sampling-rate-evaluation routine receives a metric-data sequence sampled at a maximum practical sampling rate 3902 and a metric-data sequence sampled at a current sampling rate 3904. The metric-data sequence sampled at the current sampling rate is used to train a long-short-term-memory (“LSTM”) neural network 3906 to predict the next data point in a sequence following a fixed-length subsequence. Thus, in a first training step, an initial subsequence 3908 is input 3910 to the LSTM, which then outputs a prediction of the data point following the subsequence 3912. The predicted data point is used along with the actual data point 3912 to generate a loss 3914 that is back propagated into the LSTM. Alternatively, batched-loss training can be used for training. Following training of the LSTM, the trained LSTM is then used to iteratively predict successive data points of a portion 3916 of the metric-data sequence sampled at the maximum practical sampling rate to produce a regenerated subsequence 3918 of the metric-data sequence sampled at the maximum practical sampling rate. The regenerated subsequence is then compared to the latter portion of the received metric-data sequence sampled at the maximum practical sampling rate by a sequence-difference method to produce a difference metric diff 3920. In one implementation, the sequence-difference method generates smooth curves corresponding to the metric-data sequences and then computes an average difference between the two smooth curves at a series of points along the horizontal axis of a plot of the smooth curves. Other types of timeseries-comparison methods may be alternatively used. The difference metric is then used in a set of conditional statements 3922 to generate a sampling-rate-change indication.

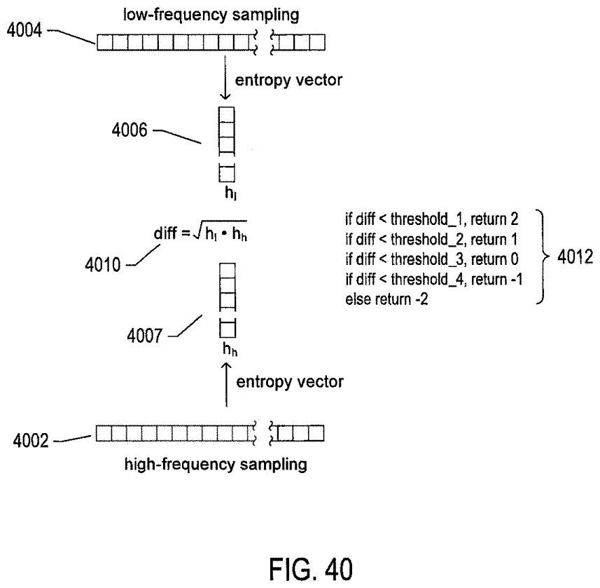

FIG. 40 illustrates a third type of metric-data sampling-rate evaluation method that can be encompassed in a sampling-rate-evaluation routine. The third type of sampling-rate-evaluation routine receives a vector-valued metric-data sequence sampled at a maximum practical sampling rate 4002 and the same vector-value metric-data sequence sampled at a current sampling rate 4004. An entropy vector is then generated from each received metric-data sequence 4006 and 4007. A difference metric 4010 is computed as the square root of the dot product of the two entropy vectors and then is used in the series of conditional statements 4012 to generate a sampling-rate-change indication. The difference metric reflects a potential loss of information in the metric-data sequence generated by sampling at the current sampling rate.

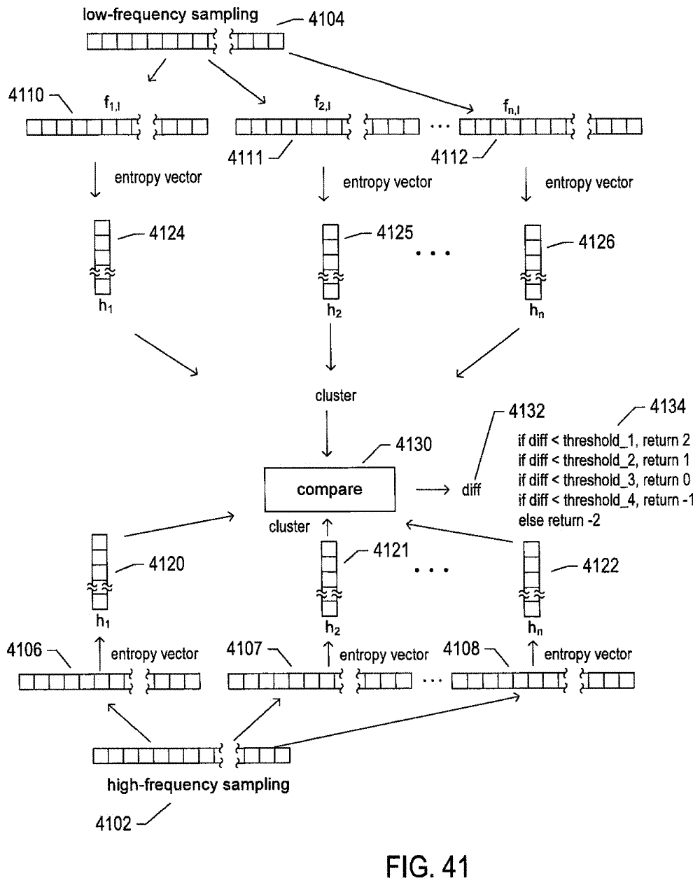

FIG. 41 illustrates a fourth type of metric-data sampling-rate evaluation method that can be encompassed in a rate-evaluation routine. The fourth type of sampling-rate-evaluation routine receives a vector-valued metric-data sequence sampled at a maximum practical sampling rate 4102 and the same vector-value metric-data sequence sampled at a current sampling rate 4104, Each of the received vector-valued metric-data sequences are then decomposed into different vector-valued feature metric-data sequences 4106-4108 and 4110-4112. An entropy vector is generated from each of the feature metric-data sequences 4120-4122 and 4124-4126. The entropy vectors generated from each of the received vector-value metric-data sequences are then clustered, by a clustering technique such as the K-means clustering technique. The clusters are compared by a cluster-comparison routine 4130, such as the cluster-comparison routine 3810 in FIG. 38A, to produce a difference metric 4132 which is then used in a set of conditional statements 4134 to generate a sampling-rate-change indication.

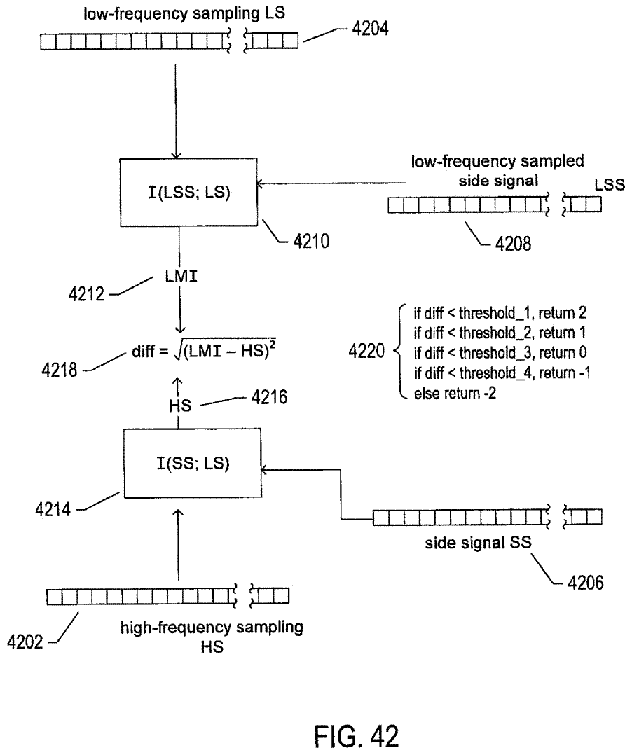

FIG. 42 illustrates a fifth type of metric-data sampling-rate evaluation method that can be encompassed in a rate-evaluation routine. The fifth type of sampling-rate-evaluation routine receives a vector-valued metric-data sequence sampled at a maximum practical sampling rate 4202 and the same vector-value metric-data sequence sampled at a current sampling rate 4204. In addition, the fifth type of sampling-rate-evaluation routine receives both a high-frequency-sampled side signal (“SS”) 4206 (3506 in FIG. 35A) and a lower-frequency-sampled side signal (“LSS”) 4208. The mutual information for the LSS and received metric-data sequence sampled at the current sampling rate is computed 4210 to produce the mutual information value LMI 4212 and the mutual information for the SS and received metric-data sequence sampled at that the maximum practical sampling rate is computed 4214 to generate the mutual information value HS 4216. A difference metric 4218 is computed as the square root of the squared difference between the LMI and HS and is then used in a set of conditional statements 4222 to generate a sampling-rate-change indication.

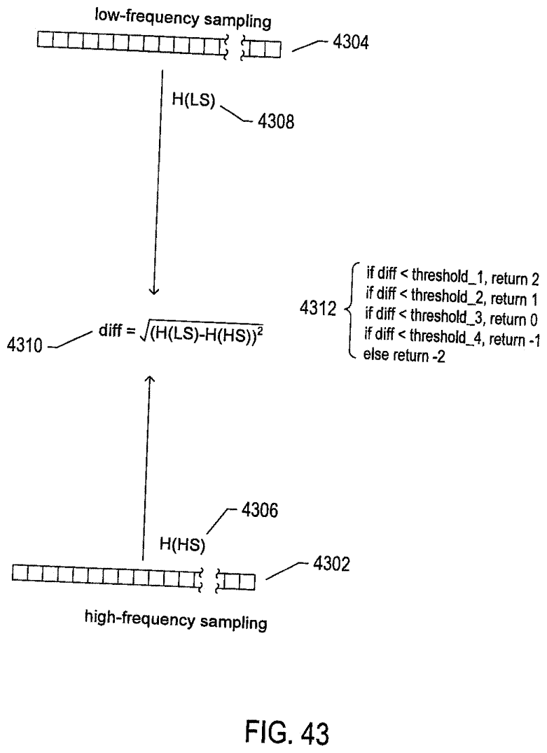

FIG. 43 illustrates a sixth type of metric-data sampling-rate evaluation method that can be incorporated in a rate-evaluation routine. The sixth type of sampling-rate-evaluation routine receives a vector-valued metric-data sequence sampled at a maximum practical sampling rate (“HS”) 4302 and the same vector-value metric-data sequence sampled at a current sampling rate (“LS”) 4304. Then, the entropies for HS and LS 4306 and 4308 are computed and the square root of the squared difference between the two computed entropies is used as a difference metric 4310 in a set of conditional statements 4312 to produce a sampling-rate-change indication.

The present invention has been described in terms of particular embodiments, it is not intended that the invention be limited to these embodiments. Modifications within the spirit of the invention will be apparent to those skilled in the art. For example, any of many different implementation and design parameters, including choice of operating system, virtualization layer, hardware platform, programming language, modular organization, control structures, data structures, and other such design and implementation parameters can be varied to generate a variety of alternative implementations of the currently disclosed methods and systems. For example, as discussed above, there are many different possible metrics that can be computed and used in the various different sampling-rate-evaluation routines to generate a sampling-rate-change indication. Many different additional clustering methods, timeseries-generation models, and sampling-rate-evaluation methods that compare the information content of time series produced by different sampling rates can be used to implement the currently disclosed methods and systems.

1. An improved metric-data collection-and-storage system within a distributed computer system, the improved metric-data collection-and-storage system comprising:
one or more processors;
one or more memories;
one or more data-storage devices;
one or more virtual machines instantiated by computer instructions stored in one or more of the one or more memories and executed by one or more of the one or more processors that together collect and store metric data by
receiving multiple sequences of metric data,
sampling the multiple sequences of metric data and automatically adjusting one or more sampling rates to minimize stored metric-data while retaining metric-data-sequence information content needed for subsequent metric-data analysis,
storing the sampled metric data by data-storage devices, and
retrieving the stored sampled metric data for subsequent analysis.

2. The improved metric-data collection-and-storage system of claim 1
wherein the multiple sequences of metric data each comprises a sequence of encoded metric-data data points, each metric-data data point representable as a timestamp/value pair; and
wherein the value of a timestamp/value pair is one of a scalar value and a vector value.

3. The improved metric-data collection-and-storage system of claim 2
wherein each sampling aggregation component of a sampling layer of the metric-data collection-and-storage system maintains a current sampling rate;
wherein each sampling/aggregation component of the sampling layer receives one or more sequences of metric data, samples the one or more sequences of metric data at the current sampling rate, and outputs a sampled sequence of metric data; and
wherein each sampling/aggregation component of the sampling layer monitors the current sampling rate by comparing metric-data-sequence information content of a first stored, sampled, sequence of metric data to a second, stored sequence of metric data corresponding to the one or more input sequences of metric data to determine adjustments to the current sampling rate to minimize stored metric-data while retaining metric-data-sequence information content needed for subsequent metric-data analysis.

4. The improved metric-data collection-and-storage system of claim 3 wherein a coordinator within a higher-level sampling/aggregation component of the sampling layer coordinates sampling-rate adjustments of multiple lower-level sampling/aggregation components by:
periodically collecting determined sampling-rate adjustments from the multiple lower-level sampling/aggregation components;
determining a new sampling rate for the multiple lower-level sampling/aggregation components using the collected determined sampling-rate adjustments; and
directing each of the multiple lower-level sampling/aggregation components to subsequently employ the new sampling rate.

5. The improved metric-data collection-and-storage system of claim 3
wherein metric-data-sequence information content includes a number of data-point clusters and sizes of the data-point clusters identified in the first, stored, sampled sequence of metric data by a clustering method selected from clustering methods that include K-means clustering and includes number of data-point clusters and sizes of the data-point clusters identified in the second, stored sequence of metric data by the clustering method.

6. The improved metric-data collection-and-storage system of claim 5 further comprising:
identifying, by a sampling/aggregation component of the sampling layer, a number of data-point clusters and sizes of the data-point clusters contained in the first, stored, sampled sequence of metric data;
identifying, by the sampling/aggregation component, a number of data-point clusters and sizes of the data-point clusters contained in the second, stored sequence of metric data;
determining, by the sampling/aggregation component, one or more metric values based on the numbers and sizes of the data-point clusters identified in the first, stored, sampled sequence of metric data and the second, stored sequence of metric data;
determining, by the sampling/aggregation component, an adjustment to the current sampling rate of the sampling/aggregation component using the determined metric values; and
when sampling-rate adjustment is coordinated with one or more external sampling/aggregation components, adjusting, by the sampling/aggregation component, the current sample rate according to the determined adjustment and adjustments determined h the one or more external sampling/aggregation components; and
when sampling-rate adjustment is not coordinated with other external sampling/aggregation components, adjusting, by the sampling/aggregation component, the current sample rate according to the determined adjustment.

7. The improved metric-data collection-and-storage system of claim 3
wherein the metric-data-sequence information content includes information content within subsequences of the first, stored, sample sequence of metric data that predicts the metric-data value of a next data point following the subsequence and includes information content within subsequences of the second, stored sequence of metric data that predicts the metric-data value of a next data point following the subsequence.

8. The improved metric-data collection-and-storage system of claim 7 further comprising:
training, by a sampling/aggregation component of the sampling layer, a neural network to predict a next data point following each of multiple subsequences within the first, stored, sampled sequence of metric data;
determining, by the sampling/aggregation component using the trained neural network, a predicted portion of second, stored sequence of metric data;
determining, by the sampling/aggregation component, a difference between the predicted portion of the second, stored sequence of metric data and a same portion of the second, stored sequence of metric data;
determining, by the sampling/aggregation component, one or more metric values based on the determined difference;
determining, by the samplings/aggregation component, an adjustment to the current sampling rate of the sampling/aggregation component using the determined metric values; and
when sampling-rate adjustment is coordinated with one or more external sampling/aggregation components, adjusting, by the sampling/aggregation component, the current sample rate according to the determined adjustment and adjustments determined by the one or more external sampling/aggregation components; and
when sampling-rate adjustment is not coordinated with other external sampling/aggregation components, adjusting, by the sampling/aggregation component, the current sample rate according to the determined adjustment.

9. The improved metric-data collection-and-storage system of claim 3
wherein the metric-data-sequence information content includes entropy values contained in an entropy vector generated from the first, stored, sampled metric-data-sequence and entropy values contained in an entropy vector generated from the second, stored metric-data-sequence.

10. The improved metric-data collection-and-storage system of claim 9 further comprising:
generating, by the sampling/aggregation component, a first entropy vector from the first, stored, sampled sequence of metric data;
generating, by the sampling/aggregation component, a second entropy vector from the second, stored sequence of metric data;
determining, by the sampling/aggregation component, a difference between the first and second entropy vectors;
determining, by the sampling/aggregation component, an adjustment to the current sampling rate of the sampling/aggregation component using the determined difference; and
when sampling-rate adjustment is coordinated with one or more external sampling/aggregation components, adjusting, by the sampling/aggregation component, the current sample rate according to the determined adjustment and adjustments determined by the one or more external sampling/aggregation components; and
when sampling-rate adjustment is not coordinated with other external sampling/aggregation components, adjusting, by the sampling/aggregation component, the current sample rate according to the determined adjustment.

11. The improved metric-data collection-and-storage system of claim 3
wherein the metric-data-sequence information content includes entropy values contained in each of multiple entropy vectors generated from the first, stored, sampled metric-data sequence and entropy values contained in each of multiple entropy vectors generated from the second, stored metric-data sequence.

12. The improved metric-data collection-and-storage system of claim 11 further comprising:
generating, by a sampling aggregation component of the sampling layer, multiple entropy vectors from the first, stored, sampled metric-data sequence;
generating, by the sampling/aggregation component of the sampling layer, multiple entropy vectors from the second, stored metric-data sequence;
clustering, by the sampling aggregation component of the sampling layer, the multiple entropy vectors generated from the first, stored, sampled metric-data sequence;
clustering, by the sampling aggregation component of the sampling layer, the multiple entropy vectors generated from the second, stored metric-data sequence;
determining a difference by comparing the clusters of data points identified in the first, stored, sampled metric-data sequence to the clusters of data points identified in the second, stored metric-data sequence;
determining, by the sampling/aggregation component, an adjustment to the current sampling rate of the sampling/aggregation component using the determined difference;
when sampling-rate adjustment is coordinated with one or more external sampling/aggregation components, adjusting, by the sampling/aggregation component, the current sample rate according to the determined adjustment and adjustments determined by the one or more external sampling/aggregation components; and
when sampling-rate adjustment is not coordinated with other external sampling/aggregation components, adjusting, by the sampling/aggregation component, the current sample rate according to the determined adjustment.

13. The improved metric-data collection-and-storage system of claim 3
wherein the metric-data-sequence information content includes a computed mutual information for the first, stored, sampled metric-data sequence and a side signal and a computed mutual information for the second, stored metric-data sequence and the side signal.

14. The improved metric-data collection-and-storage system of claim 13 further comprising:
generating, by a sampling/aggregation component of the sampling layer, a first computed mutual information for the first, stored, sampled metric-data sequence and a side signal;
generating, by the sampling/aggregation component of the sampling layer, a second computed mutual information for the second, stored metric-data sequence and the side signal;
determining a difference between the first computed mutual information and the second computed mutual information;
determining, by the sampling/aggregation component, an adjustment to the current sampling rate of the sampling aggregation component using the determined difference;
when sampling-rate adjustment is coordinated with one or more external sampling/aggregation components, adjusting, by the sampling/aggregation component, the current sample rate according to the determined adjustment and adjustments determined by the one or more external sampling/aggregation components; and
when sampling-rate adjustment is not coordinated with other external sampling/aggregation components, adjusting, by the sampling/aggregation component, the current sample rate according to the determined adjustment.

15. The improved metric-data collection-and-storage system of claim 3
wherein the metric-data-sequence information content includes an entropy value computed for the first, stored, sampled metric-data sequence and an entropy value for the second, stored metric-data sequence.

16. The improved metric-data collection-and-storage system of claim 15 further comprising:
generating, by a sampling/aggregation component of the sampling layer, a first entropy value for the first, stored, sampled metric-data sequence;
generating, by the sampling/aggregation component of the sampling layer, a second entropy value for the second, stored metric-data sequence;
determining, by the sampling/aggregation component, a difference between the first and second entropy values;
determining, by the sampling/aggregation component, an adjustment to the current sampling rate of the sampling/aggregation component using the determined difference;
when sampling-rate adjustment is coordinated with one or more external sampling/aggregation components, adjusting, by the sampling/aggregation component, the current sample rate according to the determined adjustment and adjustments determined by the one or more external sampling/aggregation components; and
when sampling-rate adjustment is not coordinated with other external sampling/aggregation components, adjusting, by the sampling/aggregation component, the current sample rate according to the determined adjustment.

17. A method, incorporated in a metric-data collection-and-storage system having one or more processors, one or more memories, one or more data-storage devices, and one or more virtual machines instantiated by computer instructions stored in one or more of the one or more memories and executed by one or more of the one or more processors that together collect and store metric data, the method automatically adjusting rates at which metric data streams generated within a distributed computer system are sampled in order to minimize stored metric-data while retaining metric-data-sequence information content needed for subsequent metric-data analysis, the method comprising:
receiving multiple sequences of metric data by one or more sampling/aggregation components of a sampling layer of the metric-data collection-and-storage system;
maintaining, by each sampling/aggregation component of the sampling layer, a current sampling rate;
sampling, by each sampling/aggregation component of the sampling layer, the one or more received sequences of metric data at the current sampling rate;
outputting, by each sampling/aggregation component of the sampling layer, a sampled sequence of metric data; and
monitoring, by each sampling/aggregation component of the sampling layer, the current sampling rate, by comparing metric-data-sequence information content of a stored, sampled sequence of metric data to the metric-data-sequence information content of one or more stored, input sequences of metric data to determine adjustments to the current sampling rate.

18. The method of claim 17 wherein the metric-data-sequence information content includes one or more of:
a number of data-point clusters and sizes of the data-point clusters identified in the first, stored, sampled sequence of metric data by a clustering method selected from clustering methods that include K-means clustering and includes number of data-point clusters and sizes of the data-point clusters identified in the second, stored sequence of metric data by the clustering method;
information content within subsequences of the first, stored, sample sequence of metric data that predicts the metric-data value of a next data point following the subsequence and includes information content within subsequences of the second, stored sequence of metric data that predicts the metric-data value of a next data point following the subsequence;
entropy values contained in an entropy vector generated from the first, stored, sampled metric-data-sequence and entropy values contained in an entropy vector generated from the second, stored metric-data-sequence;
entropy values contained in each of multiple entropy vectors generated from the first, stored, sampled metric-data sequence and entropy values contained in each of multiple entropy vectors generated from the second, stored metric-data sequence;
a computed mutual information for the first, stored, sampled metric-data sequence and a side signal and a computed mutual information for the second, stored metric-data sequence and the side signal; and
an entropy value computed for the first, stored, sampled metric-data sequence and an entropy value for the second, stored metric-data sequence.

19. A physical data-storage device that stores a sequence of computer instructions that, when executed by one or more processors within one or more computer systems that each includes one or more processors, one or more memories, and one or more data-storage devices, control the one or more computer systems to adjust rates at which metric data streams generated within a distributed computer system are sampled in order to minimize stored metric-data while retaining metric-data-sequence information content needed for subsequent metric-data analysis by:
receiving multiple sequences of metric data by one or more sampling/aggregation components of a sampling layer of the metric-data collection-and-storage system;
maintaining, by each sampling/aggregation component of the sampling layer, a current sampling rate;
sampling, by each sampling/aggregation component of the sampling layer, the one or more received sequences of metric data at the current sampling rate;
outputting, by each sampling/aggregation component of the sampling layer, a sampled sequence of metric data; and
monitoring, by each sampling/aggregation component of the sampling layer, the current sampling rate, by comparing metric-data-sequence information content of a stored, sampled sequence of metric data to the metric-data-sequence information content of one or more stored, input sequences of metric data to determine adjustments to the current sampling rate.

20. The physical data-storage device of claim 19 wherein the metric-data-sequence information content includes one or more of:
a number of data-point clusters and sizes of the data-point clusters identified in the first, stored, sampled sequence of metric data by a clustering method selected from clustering methods that include K-means clustering and includes number of data-point clusters and sizes of the data-point clusters identified in the second, stored sequence of metric data by the clustering method;
information content within subsequences of the first, stored, sample sequence of metric data that predicts the metric-data value of a next data point following the subsequence and includes information content within subsequences of the second, stored sequence of metric data that predicts the metric-data value of a next data point following the subsequence;
entropy values contained in an entropy vector generated from the first, stored, sampled metric-data-sequence and entropy values contained in an entropy vector generated from the second, stored metric-data-sequence;
entropy values contained in each of multiple entropy vectors generated from the first, stored, sampled metric-data sequence and entropy values contained in each of multiple entropy vectors generated from the second, stored metric-data sequence;
a computed mutual information for the first, stored, sampled metric-data sequence and a side signal and a computed mutual information for the second, stored metric-data sequence and the side signal; and
an entropy value computed for the first, stored, sampled metric-data sequence and an entropy value for the second, stored metric-data sequence.
